(19) United States
(12) Patent Application Publication
(10) Pub. No.: US 2012/0280927 A1
(43) Pub. Date: Nov. 8, 2012

(54) SIMPLE TOUCH INTERFACE AND HDTP GRAMMARS FOR RAPID OPERATION OF PHYSICAL COMPUTER AIDED DESIGN (CAD) SYSTEMS

(76) Inventor: Lester F. Ludwig, Belomont, CA (US)

(21) Appl. No.: 13/464,946

(22) Filed: May 4, 2012

Related U.S. Application Data
(60) Provisional application No. 61/482,248, filed on May 4, 2011.

(51) Int. Cl. G06F 3/041

(52) U.S. Cl. 345/173

(57) ABSTRACT

A tactile grammar method for implementing a touch-based user interface for a Computer Aided Design software application is provided. A tactile array sensor responsive to touch of at least one finger of a human user provides tactile sensing information that is processed to produce a sequence of symbols and numerical values responsive to the touch of the finger. At least one symbol is associated with one or more gesteme, and each gesteme is comprised by at least one touch gesture. A sequence of symbols is recognized as a sequence of gestemes, which is in turn recognized as a sequence of touch gestures subject to a grammatical rule producing a meaning that corresponds to a command. The command is submitted to a Computer Aided Design software application which executes the command, wherein the grammatical rule provides the human user a framework for associating the meaning with the first and second gesture.

### CROSS-REFERENCE TO RELATED APPLICATIONS

### This Section to be Used at Utility Filing within 1 Year

Pursuant to 35 U.S.C. §119(e), this application claims benefit of priority from Provisional U.S. Patent application Ser. No. 61/482,248, filed May 4, 2011, the contents of which are incorporated by reference.

### COPYRIGHT & TRADEMARK NOTICES

A portion of the disclosure of this patent document may contain material, which is subject to copyright protection. Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### BACKGROUND OF THE INVENTION

The invention relates to user interfaces providing an additional number of simultaneously-adjustable interactively-controlled discrete (clicks, taps, discrete gestures) and pseudo-continuous (downward pressure, roll, pitch, yaw, multi-touch geometric measurements, continuous gestures, etc.) user-adjustable settings and parameters, and in particular to a curve-fitting approach to HDTP parameter extraction, and further how these can be used in applications.

By way of general introduction, touch screens implementing tactile sensor arrays have recently received tremendous attention with the addition multi-touch sensing, metaphors, and gestures. After an initial commercial appearance in the products of FingerWorks™, such advanced touch screen technologies have received great commercial success from their defining role in the iPhone™ and subsequent adaptations in PDAs and other types of cell phones and hand-held devices. Despite this popular notoriety and the many associated patent filings, tactile array sensors implemented as transparent touchscreens were taught in the 1999 filings of issued U.S. Pat. No. 6,570,078 and pending U.S. patent application Ser. No. 11/761,978.

Despite the many popular touch interfaces and gestures, there remains a wide range of additional control capabilities that can yet be provided by further enhanced user interface technologies. A number of enhanced touch user interface features, capabilities, and example applications are described in U.S. Pat. No. 6,570,078, U.S. Pat. No. 8,169,414, pending U.S. patent application Ser. Nos. 11/761,978, 12/418,605, 12/502,230, 12/541,948, and related pending U.S. patent applications. These patents and patent applications also address popular contemporary gesture and touch features. The enhanced user interface features taught in these patents and patent applications, together with popular contemporary gesture and touch features, can be rendered by the “High Definition Touch Pad” (HDTP) technology taught in those patents and patent applications. Implementations of the HTDP provide advanced multi-touch capabilities far more sophisticated that those popularized by FingerWorks™, Apple™, NYU, Microsoft™, Gesturetek™, and others.

The present invention addresses simple grammars for rapid operation of Computer Aided Design (CAD) or drawing software applications and systems, and in particular how these can be supported and at least partially implemented by an HDTP or other tactile or high-dimension user interface.

### SUMMARY OF THE INVENTION

For purposes of summarizing, certain aspects, advantages, and novel features are described herein. Not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

The present invention addresses simple grammars for rapid operation of Computer Aided Design (CAD) or drawing software applications and systems, and in particular how these can be supported and at least partially implemented by an HDTP or other tactile or high-dimension user interface.

In one aspect of the invention, a tactile grammar method for implementing a touch-based user interface for a Computer Aided Design software application is provided.

In an aspect of the invention, a tactile array sensor responsive to touch of at least one finger of a human user provides tactile sensing information that is processed to produce a sequence of symbols and numerical values responsive to the touch of the finger.

In another aspect of the invention, at least one symbol is associated with one or more gesteme, and each gesteme is comprised by at least one touch gesture.

In another aspect of the invention, a sequence of symbols is recognized as a sequence of gestemes, which is in turn recognized as a sequence of touch gestures subject to a grammatical rule producing a meaning that corresponds to a command.

In another aspect of the invention, this command is submitted to a Computer Aided Design software application which executes the command, wherein the grammatical rule provides the human user a framework for associating the meaning with the first and second gesture.

In another aspect of the invention, a method is provided for implementing a touch-based user interface for a Computer Aided Design software application, the method comprising:
Receiving tactile sensing information over time from a tactile array sensor, the tactile array sensor comprising a tactile sensor array, the tactile sensing information responsive to touch of at least one finger of a human user on the tactile array sensor, the touch comprising at least a position of contact of the finger on the tactile array sensor or at least one change in a previous position of contact of the finger on the tactile array sensor;
Processing the received tactile sensing information to produce a sequence of symbols and numerical values responsive to the touch of at least one finger of a human user;
Interpreting at least one symbol as corresponding to a first gesteme, the first gesteme comprised by at least a first touch gesture;
Interpreting at least another symbol as corresponding to a second gesteme, the second gesteme comprised by at least the first touch gesture;
Interpreting the first gesteme followed by the second gesteme as corresponding to first gesture;
Interpreting at least an additional symbol as corresponding to a third gesteme, the third gesteme comprised by at least a second touch gesture;
Interpreting at least a further symbol as corresponding to a fourth gesteme, the fourth gesteme comprised by at least the second touch gesture;
Interpreting the third gesteme followed by the fourth gesteme as corresponding to second gesture;
Applying a grammatical rule to the sequence of the first gesture and second gesture, the grammatical rule producing a meaning;
Interpreting the meaning as corresponding to a user interface command of a Computer Aided Design software application, and
Submitting the user interface command to the Computer Aided Design software application,
Wherein the Computer Aided Design software application executes the user interface command responsive a choice by the human user of the at least first, second, third, and fourth gestemes, and
Wherein the grammatical rule provides the human user a framework for associating the meaning with the at least the first and second gesture.

In another aspect of the invention, subsequent touch actions performed by the user produce additional symbols.

In another aspect of the invention, the additional symbols are interpreted as a sequence of additional gestemes, and the sequence of additional gestemes is associated with at least an additional gesture, wherein the additional gesture is subject to an additional grammatical rule producing an additional meaning that corresponds to an additional command, wherein the additional command executed by Computer Aided Design software application, and wherein the grammatical rule provides the human user a framework for associating the meaning with the first and second gesture.

In another aspect of the invention, the command corresponds to a selection event.

In another aspect of the invention, the command incorporates at least one calculated value, the calculated value obtained from processing the numerical values responsive to the touch of at least one finger of a human user.

In another aspect of the invention, the command corresponds to a data entry event.

In another aspect of the invention, the additional command corresponds to a data entry event.

In another aspect of the invention, the additional command corresponds to an undo event.

In another aspect of the invention, the tactile sensor array comprises an LED array.

In another aspect of the invention, the tactile sensor array comprises an OLED array, and the OLED array serves as a visual display for the Computer Aided Design software application.

In another aspect of the invention, an HDTP provides real-time control information to Computer Aided Design (CAD) or drawing software and systems.

In another aspect of the invention, an HDTP provides real-time control information to Computer Aided Design (CAD) or drawing software and systems through a USB interface via HID protocol.

In another aspect of the invention, an HDTP provides real-time control information to Computer Aided Design (CAD) or drawing software and systems through a HID USB interface abstraction.

### BRIEF DESCRIPTION OF THE DRAWINGS

The above and other aspects, features and advantages of the present invention will become more apparent upon consideration of the following description of preferred embodiments taken in conjunction with the accompanying drawing figures.

FIG. 1 depicts increasingly large numbers of traditional GUI elements required by increasingly complex applications.

FIG. 2a depicts the enumeration of GUI selections organized in a hierarchy and rendered in a spatial representation suitable for spatially-based interaction.

FIG. 2b depicts use of a pointing device such as a mouse, first used for selecting focus or context, and secondly directing pointing device output to GUI elements either in the drawing area or GUI “task selection” area.

FIG. 2c depicts a simplification of the arrangement of FIG. 2a, which also circumvents the needs for many aspects of FIG. 2b.

FIG. 3 depicts a mental goal of the user requiring an inherent collection of steps or tasks, which in turn can be rendered with additional steps required by a traditional GUI or alternatively, a more concise set of steps required as an efficient narrative interaction.

FIG. 4a shows a direct mapping between a 2D user interface and a 2D subtask.

FIG. 4b depicts the more complicated context switching arrangements required for mapping a 2D user interface to a higher dimensional subtask.

FIG. 5 depicts a sequence of interactions such as those depicted in FIG. 4a, wherein a context switch is required before each task, and the context selection determines a context mapping.

FIG. 6 depicts further detail of steps involved in the context mapping.

FIG. 7 depicts a context selection task fit into a 2D GUI context and used interactively by the user of the 2D GUI.

FIG. 8a depicts a context selection task fit into a gesture GUI context and used interactively by the user of the gesture GUI.

FIG. 8b depicts a context selection task fit into a high-dimensional GUI context and used interactively by the user of the high-dimensional GUI.

FIG. 8c depicts a context selection task fit into a gesture grammar GUI context and used interactively by the user of the gesture grammar GUI.

FIG. 8d depicts a context selection task fit into a high-dimensional gesture grammar GUI context and used interactively by the user of the high-dimensional gesture grammar GUI.

FIG. 9a depicts an adaptation of the arrangement of FIG. 3, wherein a grammar based gesture GUI provides an improved user interface.

FIG. 9b depicts an adaptation of the arrangement of FIG. 3, wherein a high-dimensional GUI provides an improved user interface.

FIG. 9c depicts an adaptation of the arrangement of FIG. 3, wherein a high-dimensional gesture grammar GUI provides an improved user interface.

FIG. 10 depicts an example (vertically sequenced) progression of increasingly-higher dimension touch user interfaces and an associated (vertically sequenced) progression of tactile grammar frameworks for each of the (vertically sequenced) progression of corresponding parameters, symbols and events. Each tactile grammar framework further permits adaptation to specific applications, leveraging application-specific metaphors. These can also include general-purpose metaphors and/or general-purpose linguistic constructs.

FIGS. 11a-11g depict a number of arrangements and embodiments employing the HDTP technology.

FIGS. 12a-12e and FIGS. 13a-13b depict various integrations of an HDTP into the back of a conventional computer mouse as taught in U.S. Pat. No. 7,557,797 and in pending U.S. patent application Ser. No. 12/619,678.

FIG. 14 illustrates the side view of a finger lightly touching the surface of a tactile sensor array.

FIG. 15a is a graphical representation of a tactile image produced by contact of a human finger on a tactile sensor array. FIG. 15b provides a graphical representation of a tactile image produced by contact with multiple human fingers on a tactile sensor array.

FIG. 16 depicts a signal flow in a HDTP implementation.

FIG. 17 depicts a pressure sensor array arrangement.

FIG. 18 depicts a popularly accepted view of a typical cell phone or PDA capacitive proximity sensor implementation.

FIG. 19 depicts an implementation of a multiplexed LED array acting as a reflective optical proximity sensing array.

FIGS. 20a-20c depict camera implementations for direct viewing of at least portions of the human hand, wherein the camera image array is employed as an HDTP tactile sensor array.

FIG. 21 depicts an embodiment of an arrangement comprising a video camera capturing the image of the contact of parts of the hand with a transparent or translucent surface.

FIGS. 22a-22b depict an implementation of an arrangement comprising a video camera capturing the image of a deformable material whose image varies according to applied pressure.

FIG. 23 depicts an implementation of an optical or acoustic diffraction or absorption arrangement that can be used for contact or pressure sensing of tactile contact.

FIG. 24 shows a finger image wherein rather than a smooth gradient in pressure or proximity values there is radical variation due to non-uniformities in offset and scaling terms among the sensors.

FIG. 25 shows a sensor-by-sensor compensation arrangement.

FIG. 26 (adapted from http://labs.moto.com/diy-touchscreen-analysis/) depicts the comparative performance of a group of contemporary handheld devices wherein straight lines were entered using the surface of the respective touchscreens.

FIGS. 27a-27f illustrate the six independently adjustable degrees of freedom of touch from a single finger that can be simultaneously measured by the HDTP technology.

FIG. 28 suggests general ways in which two or more of these independently adjustable degrees of freedom adjusted at once.

FIG. 29 demonstrates a few two-finger multi-touch postures or gestures from the many that can be readily recognized by HTDP technology.

FIG. 30 illustrates the pressure profiles for a number of example hand contacts with a pressure-sensor array.

FIG. 31 depicts one of a wide range of tactile sensor images that can be measured by using more of the human hand

FIGS. 32a-32c depict various approaches to the handling of compound posture data images.

FIG. 33 illustrates correcting tilt coordinates with knowledge of the measured yaw angle, compensating for the expected tilt range variation as a function of measured yaw angle, and matching the user experience of tilt with a selected metaphor interpretation.

FIG. 34a depicts an embodiment wherein the raw tilt measurement is used to make corrections to the geometric center measurement under at least conditions of varying the tilt of the finger. FIG. 34b depicts an embodiment for yaw angle compensation in systems and situations wherein the yaw measurement is sufficiently affected by tilting of the finger.

FIG. 35 shows an arrangement wherein raw measurements of the six quantities of FIGS. 27a-27f, together with multitouch parsing capabilities and shape recognition for distinguishing contact with various parts of the hand and the touchpad can be used to create a rich information flux of parameters, rates, and symbols.

FIG. 36 shows an approach for incorporating posture recognition, gesture recognition, state machines, and parsers to create an even richer human/machine tactile interface system capable of incorporating syntax and grammars.

FIGS. 37a-37d depict operations acting on various parameters, rates, and symbols to produce other parameters, rates, and symbols, including operations such as sample/hold, interpretation, context, etc.

FIG. 38 depicts a user interface input arrangement incorporating one or more HDTPs that provides user interface input event and quantity routing.

FIGS. 39a-39c depict methods for interfacing the HDTP with a browser.

FIG. 40a depicts a user-measurement training procedure wherein a user is prompted to touch the tactile sensor array in a number of different positions. FIG. 40b depicts additional postures for use in a measurement training procedure for embodiments or cases wherein a particular user does not provide sufficient variation in image shape the training. FIG. 40c depicts boundary-tracing trajectories for use in a measurement training procedure.

FIG. 41 depicts an example HDTP signal flow chain for an HDTP realization implementing multi-touch, shape and constellation (compound shape) recognition, and other features.

FIG. 42a depicts a side view of an example finger and illustrating the variations in the pitch angle. FIGS. 42b-42f depict example tactile image measurements (proximity sensing, pressure sensing, contact sensing, etc.) as a finger in contact with the touch sensor array is positioned at various pitch angles with respect to the surface of the sensor.

FIGS. 43a-43e depict the effect of increased downward pressure on the respective contact shapes of FIGS. 42b-42f.

FIG. 44a depicts a top view of an example finger and illustrating the variations in the roll angle. FIGS. 44b-44f depict example tactile image measurements (proximity sensing, pressure sensing, contact sensing, etc.) as a finger in contact with the touch sensor array is positioned at various roll angles with respect to the surface of the sensor.

FIG. 45 depicts an example causal chain of calculation.

FIG. 46 depicts a utilization of this causal chain as a sequence flow of calculation blocks, albeit not a dataflow representation.

FIG. 47 depicts an example implementation of calculations for the left-right (“x”), front-back (“y”), downward pressure (“p”), roll (“φ”), pitch (“θ”), and yaw (“ψ”) measurements from blob data.

FIG. 48 depicts example time-varying values of a parameters vector comprising left-right geometric center (“x”), forward-back geometric center (“y”), average downward pressure (“p”), clockwise-counterclockwise pivoting yaw angular rotation (“ψ”), tilting roll angular rotation (“φ”), and tilting pitch angular rotation (“θ”) parameters calculated in real time from sensor measurement data.

FIG. 49 depicts an example sequential classification of the parameter variations within the time-varying parameter vector according to an estimate of user intent, segmented decomposition, etc. Each such classification would deem a subset of parameters in the time-varying parameter vector as effectively unchanging while other parameters are deemed as changing.

FIG. 50 depicts an example symbol generation arrangement for generating a sequence of symbols from (corrected, refined, raw, adapted, renormalized, etc.)

FIG. 51 depicts a modification of the example arrangement of FIG. 50 wherein symbol can be generated only under the control of a clock or sampling command, clock signal, event signal, or other symbol generation command.

FIG. 52 depicts an example conditional test for a single parameter or rate value q in terms of a mathematical graph, separating the full range of q into three regions.

FIG. 53a depicts such a conditional test for a two values (parameter and/or rate) in terms of a mathematical graph, separating the full range of each of the two values into three regions.

FIG. 53b shows the plane defined by the full range of the three values is divided into 3×3=9 distinct regions.

FIG. 54a depicts such a conditional test for a two values (parameter and/or rate) in terms of a mathematical graph, separating the full range of each of the three values into three regions.

FIG. 54b shows the volume defined by the full range of the three values is divided into 3×3×3=27 distinct regions.

FIG. 55 depicts a representation of the tensions among maximizing the information rate of communication from the human to the machine, maximizing the cognitive ease in using the user interface arrangement, and maximizing the physical ease using the user interface arrangement

FIG. 56 depicts a representation of example relationships of traditional writing, gesture, and speech with time, space, direct marks, and indirect action.

FIG. 57 depicts an example representation of a predefined gesture comprised by a specific sequence of three other gestures.

FIG. 58 depicts an example representation of a predefined gesture comprised by a sequence of five recognized gestemes.

FIG. 59 depicts a representation of a layered and multiple-channel metaphor wherein the {x,y} location coordinates represent the location of a first point in a first geometric plane, and the {roll, pitch} angle coordinates are viewed as determining a second independently adjusted point on a second geometric plane.

FIG. 60 depicts a representation of some correspondences among gestures, gestemes, and the abstract linguistics concepts of morphemes, words, and sentences.

FIG. 61 and FIG. 62a through FIG. 62d depict representations of finer detail useful in employing additional aspects of traditional linguistics such as noun phrases, verb phrases, and clauses as is useful for grammatical structure, analysis, and semantic interpretation.

FIG. 63a through FIG. 63d and FIG. 64a through FIG. 64f depict representations of sequentially-layered execution of tactile gestures can be used to keep a context throughout a sequence of gestures.

FIG. 65 depicts a representation of an example syntactic and/or semantic hierarchy integrating the concepts developed thus far.

FIG. 66 depicts a representation of an example of two or more alternative gesture sequence expressions to convey the same meaning.

FIG. 67a depicts an example of a very simple grammar that can be used for rapid control of CAD or drawing software.

FIG. 67b depicts an example portion of a sequence wherein the arrangement of FIG. 67a and/or other variations can be repeated sequentially.

FIG. 67c depicts an example extension of the arrangement depicted in FIG. 67b wherein at least one particular symbol can be used as an “undo” or “re-try” operation.

FIG. 68 depicts how the aforedescribed simple grammar can be used to control a CAD or drawing program.

### DETAILED DESCRIPTION OF THE PREFERRED EMBODIMENTS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

In the following description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention.

Despite the many popular touch interfaces and gestures in contemporary information appliances and computers, there remains a wide range of additional control capabilities that can yet be provided by further enhanced user interface technologies. A number of enhanced touch user interface features are described in U.S. Pat. No. 6,570,078, U.S. Pat. No. 8,169,414, pending U.S. patent application Ser. Nos. 11/761,978, 12/418,605, 12/502,230, 12/541,948, and related pending U.S. patent applications. These patents and patent applications also address popular contemporary gesture and touch features. The enhanced user interface features taught in these patents and patent applications, together with popular contemporary gesture and touch features, can be rendered by the “High Definition Touch Pad” (HDTP) technology taught in those patents and patent applications.

The present invention addresses the use of high-dimensional input devices and user interface grammar constructions for rapid and improved operation of Computer Aided Design (CAD) and drawing software applications, and in particular how these can be supported and implemented by an HDTP or other tactile or high-dimension user interface.

In particular (as will be discussed), the user experience, productivity, and creative range in Computer Aided Design (CAD) and drawing software applications are greatly impeded by traditional mouse-based two-dimensional Graphical User Interface (GUI) technologies. Some of this results from only having two dimensions on interactive control. The two dimensions limitations imposed by the mouse-based user interface (or their touch or trackball equivalents) force a large amount of context-switching overhead on the user and limit the types of interactive experiences that can be provided. Additionally, the reliance on traditional graphic rendering of user interface selections (though the use of menus, dialog boxes, etc.) creates a heavy loading on the use of screen-space, hierarchical organizations, and user cognitive load. Further, these and other factors are not well matched to mental goals of the CAD application user, and require immense amounts of training and experience to simply navigate the user interface.

The discussion to follow will begin with a more detailed treatment of the topics mentioned above.

### Computer Aided Design (CAD) User Interface Technologies

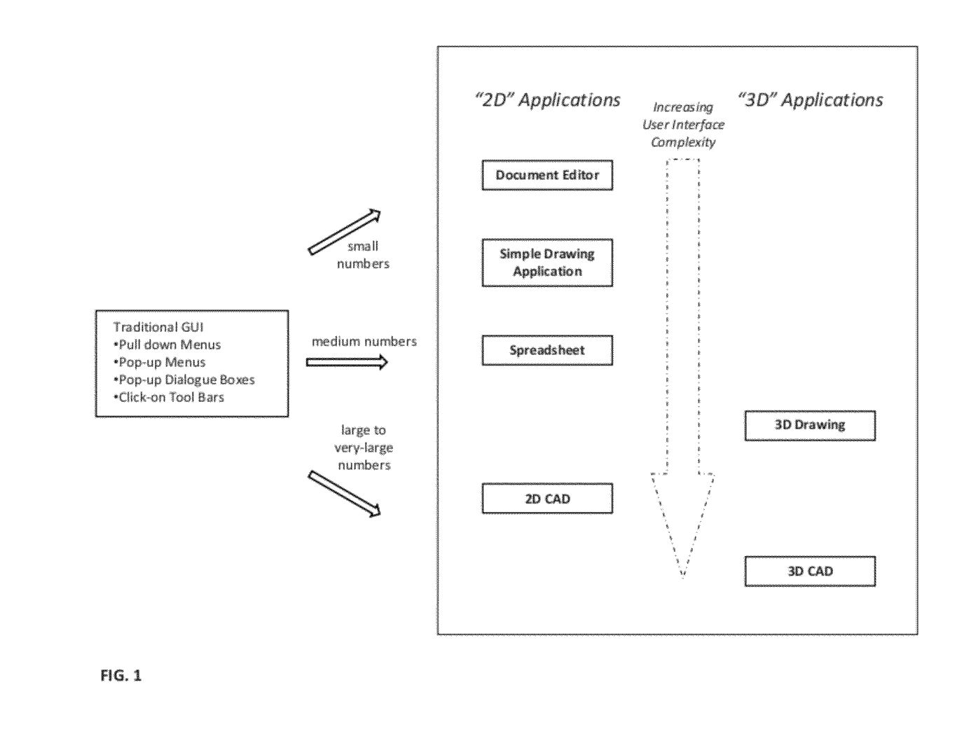

FIG. 1 depicts increasingly large numbers of traditional GUI elements required by increasingly complex applications. For simple applications, a traditional Graphical User Interface (“GUI”) employing a two-dimensional (“2D”) user input device such as a mouse, trackball, or conventional touchpad (also called a “pointing device” in user interface literature) is a good match. For moderate complexity applications, the effectiveness of the match can remain adequate but operation become more complex. For complex and very complex applications, and for those involving 3D dimensional aspects (such as CAD, data visualization, Earth-imaging—i.e., Google Earth™ and elevation-oriented GIS applications, realistic computer games, etc.), traditional GUIs provide a cumbersome user interface. Ironically, this has not been challenged much aside from a few alternatives (knob boxes in early 3D-CAD systems, Logitech™/3DConnexion™ Space Navigator™ “6D-mouse” joystick, one or two scroll-wheels on a mouse) and these have limited effectiveness. Use of mouse scroll-wheels rapidly causes hand/wrist, and arm fatigue so it cannot provide a good third (or fourth) dimensional input for frequent use. “6D-mouse” joystick products have spring return, and game controller joystick and knob/slider boxes have many limitations. Unfortunately, for complex and very complex applications, and for those involving 3D dimensional aspects (such as CAD, data visualization Earth-imaging—i.e., Google Earth™ and elevation-oriented Geographic Information System “GIS” applications, realistic interactive computer games, etc.), traditional GUIs employing a two-dimensional (“2D”) user input device such as a mouse, trackball, or conventional touchpad is the only readily provided widely-accepted option, and users of such complex and very complex applications suffer with poor user interface experiences that slow productivity and impede research and creative directions.

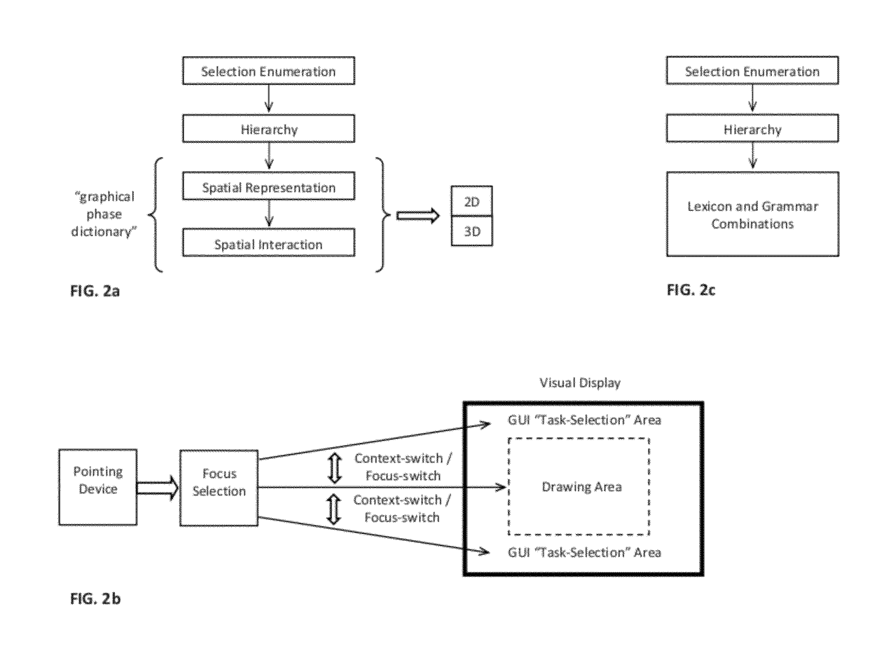

Traditional GUIs employing a two-dimensional (“2D”) user input device such as a mouse, trackball, or conventional touchpad employ GUI elements such as menus (pull-down, pop-up, side-hierarchy, etc.), dialog boxes, click-on tool bars, sliders, buttons, etc. Only a few of these are listed in the rightmost box of FIG. 1. Effectively these provide, one way, or another, a full enumeration of GUI selections organized in a hierarchy and rendered in a spatial representation suitable for spatially-based interaction. Typically the spatial representation suitable for spatially-based interaction is 2D, but some examples of 3D versions (for example, 3D desktops as provided in recent LINUX™ offerings) exist commercially. FIG. 2a depicts the enumeration of GUI selections organized in a hierarchy and rendered in a spatial representation suitable for spatially-based interaction (be it 2D or 3D). Because these effectively provide a full enumeration of GUI selections organized in a hierarchy and rendered in a spatial representation suitable for spatially-based interaction, that can be thought of as the equivalent of a “graphical phrase dictionary” for the application language control and command instructions.

FIG. 2b depicts use of a pointing device (such as a mouse, trackball, or conventional touchpad), first used for selecting focus or context, and secondly directing pointing device output to GUI elements either in the drawing area or GUI “task selection” area. In each area, the traditional GUI provides such a “graphical phrase dictionary” for the application language control and command instructions, sometimes directing in a drawing/viewing area, other times in a “task selection area.” For complex applications such as 2D and 3D CAD systems, the resulting arrangement is extremely cumbersome, requires extensive training and experience, and imposes considerable “cognitive load” on the user. Advance users employ keyboard shortcuts in place of many types GUI interactions, which is effectively a type of linguistic interaction. This linguistic interaction is largely if not entirely in the context and terms of the traditional GUI framework. In contrast, as will be demonstrated, the present invention provides a linguistic interaction but drawn from the interaction and mental goals rather than the legacy of cumbersome traditional GUI user interfaces.

### Opportunities for Use of Grammar in CAD User Interfaces

FIG. 2c depicts a simplification of the arrangement of FIG. 2a, which also circumvents the needs for many aspects of FIG. 2b.

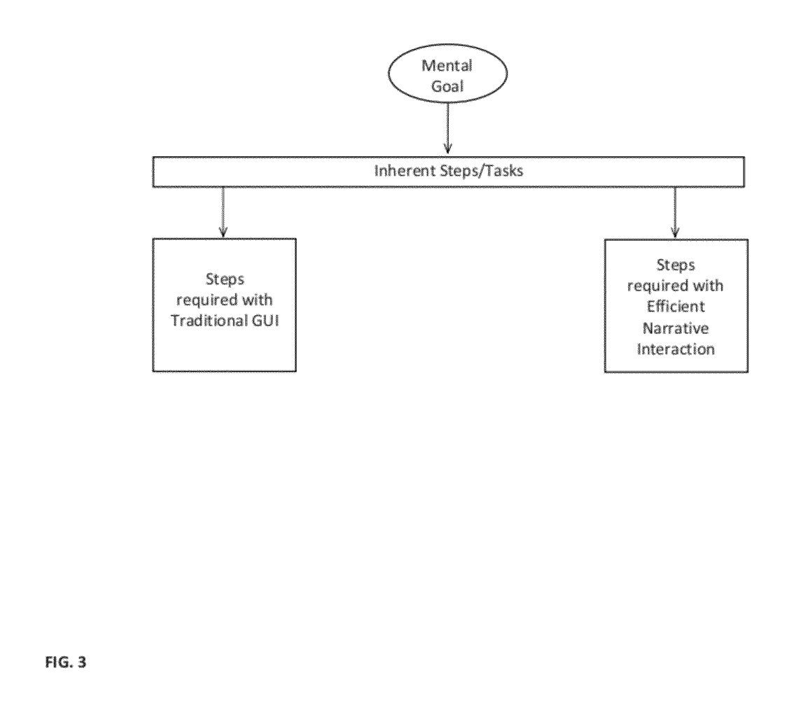

FIG. 3 depicts a mental goal of the user requiring an inherent collection of steps or tasks, which in turn can be rendered with additional steps required by a traditional GUI or alternatively, a more concise set of steps required as an efficient narrative interaction.

In most computer applications users are either giving commands or making inquiries (which can be viewed perhaps as a type of command). Examples include:
“Move-That-Here”;
“Copy-That-Here”;
“Delete-That”;
“Do this-To-That”/“Change-That-This way”;
“Create-That-Here”;
“What is-That?”
“What is (are) the value(s)-of-That?”
“Where is-That?”
“What is (are)-Objects having that value/value-range/attribute?”

Although Direct Manipulation and WIMP GUIs [1] perhaps reconstitute these somewhat in the mind of users as a sequence computer mouse operations guided by visual feedback, these commands or inquiries are in fact naturally represented as simple sentences.

Today's widely adopted gesture-based multi-touch user interfaces have added these new time- and labor-saving features:
Swipe through this 1-dimensional list to this extent;
Swipe through this 2-dimensional list at this angle to this extent;
Stretch this image size to this explicit spatial extent;
Pinch this image to this explicit spatial extent;
Rotate this image by this explicit visual angle;
How much of the capability and opportunities provided by touch interfaces do these approaches utilize and deliver?

More specifically, as mentioned in the introductory material, the HDTP approach to touch-based user interfaces provides the basis for:
(1) a dense, intermixed quantity-rich/symbol-rich/metaphor-rich information flux capable of significant human-machine information-transfer rates; and
(2) an unprecedented range of natural gestural metaphor support.
The latter (1) and its synergy with the former (2) is especially noteworthy, emphasized the quote [2] “Gestures are useful for computer interaction since they are the most primary and expressive form of human communication.”

The HDTP approach to touch-based user interfaces in fact provides for something far closer to spoken and written language. To explore this, begin with the consideration of some very simple extensions to the sentence representation of traditional Direct Manipulation and WIMP GUI commands and inquiries listed above into slightly longer sentences. Some examples might include:
“Do-This-To Objects having-This value/value-range/attribute”
“Apply-This-To Objects previously having-This value/value-range/attribute”
“Find-General objects having that value/value-range/attribute-Then-Move to-Here”
“Find-Graphical objects having that value/value-range/attribute-Then-Move to-Here-and-Rotate-This amount”
“Find-Physical objects having that value/value-range/attribute-Then-Move to-Here (2D or 3D vector)-and-3D-rotate-This amount (vector of angles)”
“Find-Physical objects having that value/value-range/attribute-Then-Move to-Here-In this way (speed, route, angle)”
“Find-Objects having that value/value-range/attribute-Then-Create-One of these-For each-Of-Those”

Such very simple extensions are in general exceedingly difficult to support using Direct Manipulation and WIMP GUIs, and force users to very inefficiently break down the desired result into a time-consuming and wrist-fatiguing set of simpler actions that can be handled by Direct Manipulation, WIMP GUIs, and today's widely adopted gesture-based multi-touch user interfaces.

Again consider the quote [2] “Gestures are useful for computer interaction since they are the most primary and expressive form of human communication.” What else is comparable? Speech and traditional writing of course are candidates. What is the raw material of there power once symbols (phonetic or orthographic) are formalized? Phrases, grammar, sentences, and higher-level context. The present invention addresses the use of these in CAD interfaces, as will be discussed.

Opportunities for Use of High-Dimension User Interfaces in CAD Systems

Attention is now directed to parallel and overlapping opportunities for Use of High-Dimension User Interfaces in CAD Systems.

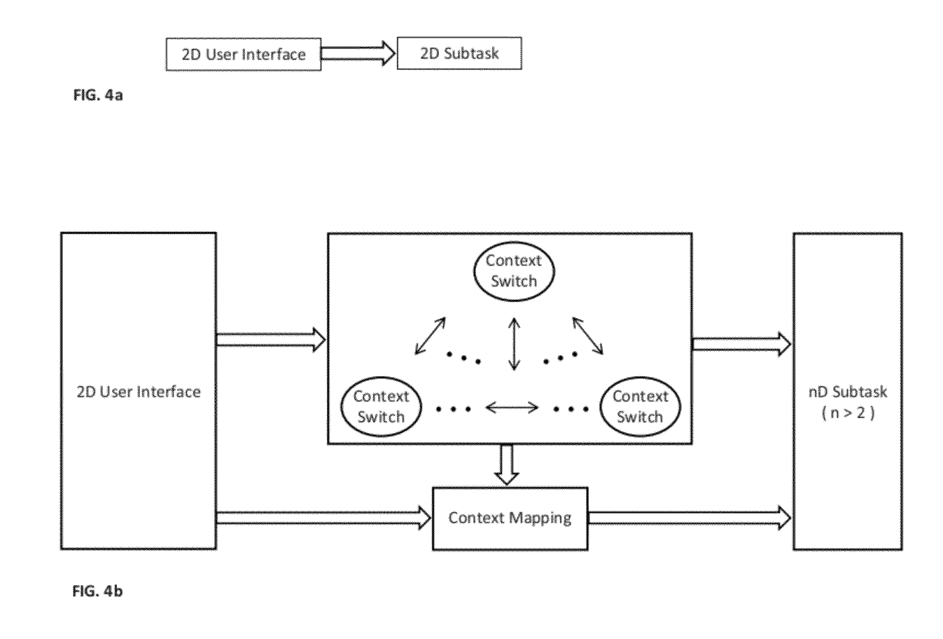

First to be considered is performing a subtask of two or more dimensions with a 2D user interface device (such as a mouse, trackball, or conventional touch pad). FIG. 4a shows a direct mapping between a 2D user interface and a 2D subtask, and this direct mapping is straightforward and can be easy for a user to use. The straightforward mapping results from mapping a two-dimensional control source to a two-dimensionally controlled object. The ease of use follows from scale, reliability, and stability of the input device, and also as a result of the quality of the user interface metaphor used:
An example of a mapping that is easy for a user to use (thanks to a good user interface metaphor) is the conventional positioning of a cursor or drawing point on a screen via a mouse with left or right mouse movement causing the cursor or drawing point to move left or right, respectively, on the display screen and with forward or backward causing the cursor or drawing point to move up or down, respectively, on the display screen.
An example of a mapping that is very difficult for a user to use (thanks to a poor user interface metaphor) is an exchange of the conventional positioning of a cursor or drawing point on a screen via a mouse with left or right mouse movement causing the cursor or drawing point to move up or down, respectively, on the display screen and with forward or backward causing the cursor or drawing point to move left or right, respectively, on the display screen.
   Next to be considered (in the form of an important aside here) is that the high-dimensional HDTP technology to be described provides a very rich multidimensional user interface metaphor environment. Accordingly, the HDTP technology to be described can facilitate a greatly improved ease of use simply from better providing better user interface metaphors that can be provided by a simple 2D user interface device (such as a mouse, trackball, or conventional touch pad).

If the subtask uses or inherently involves manipulation of more than two dimensions simultaneously, however, this simple correspondence breaks down considerably. In some situations clever approaches can be used to suppress the need for the higher dimensions (for example, the “Pivot” point feature used in manipulating the orientation or viewpoint of 3D drawings in AutoCAD™). More generally, one or two dimensions are selected at a time and output from the 2D user interface device (such as a mouse, trackball, or conventional touch pad) is directed to the selected dimensions of the higher-dimension subtask. This selection of dimensions significantly complicates the users interaction with subtask. As to this, FIG. 4b depicts the more complicated context switching arrangements required for mapping a 2D user interface to a higher dimensional subtask.

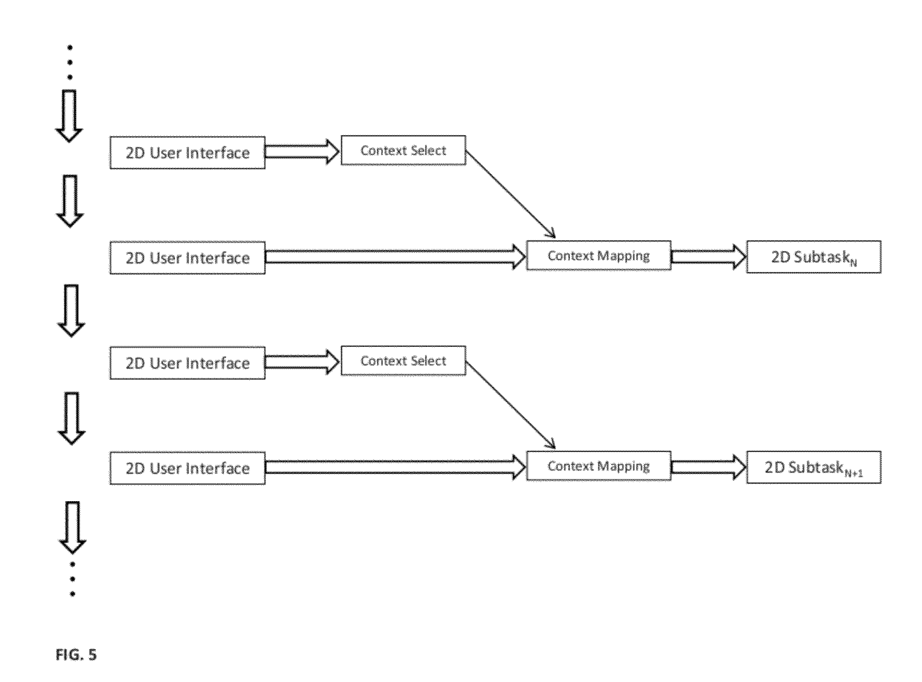

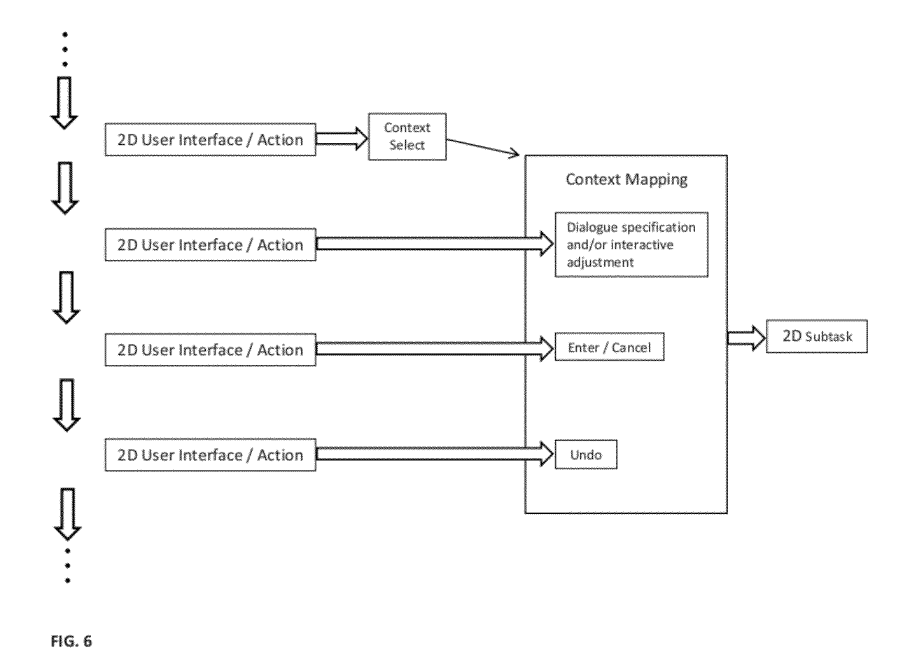

However, in general many subtasks are performed in sequence, and at least some sort of context switch is involved between each sequence step. For example, FIG. 5 depicts a sequence of interactions such as those depicted in FIG. 4a, wherein a context switch is required before each task, and the context selection determines a context mapping. Further, however, the context mapping step can internally comprise its own collection of additional internal steps, for example as depicted in FIG. 6, calling out examples of further detail involved in the context mapping as including dialog and/or interactive adjustment, enter operations, cancel operations, and undo operations.

Yet further, FIG. 5 and FIG. 6 depict the situation wherein the two-dimensional user interface is used to control a two-dimensional subtask; depictions of the situations in FIG. 5 and FIG. 6 become considerable more complex if the two-dimensional user interface is used to control a higher-dimensional subtask (as many or all of the steps shown in FIG. 5 and FIG. 6 would expand to include additional context-switch like that depicted in FIG. 4b. These compounding overhead operations would be eliminated if each higher-dimensional subtask could be controlled by a correspondingly-dimensioned user interface device employing a good user interface metaphor in the dimensional mapping. As will be seen, the HDTP provides excellent user interface metaphors in dimensional mapping, with extremely natural 3D and 6D arrangements that apply naturally to CAD and 3D-oriented user interface modalities. Further, the HDTP can provide up to 6D capabilities {x,y,z, roll, pitch, yaw} with a single finger, and easily 2-3 additional dimensions of control (beyond these six dimensions) for each additional finger on the same hand, permitting spectacular degrees of advanced interactive control.

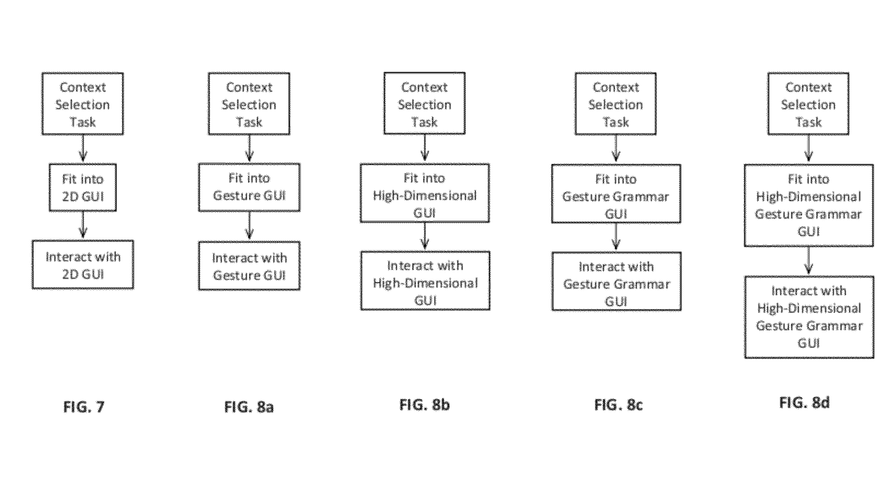

As a point of comparison, FIG. 7 depicts a context selection task fit into a 2D GUI context and used interactively by the user of the 2D GUI. Evolving the arrangement of FIG. 7 to emerging gesture-based touch and video-camera-based user interfaces, FIG. 8a depicts a context selection task fit into a gesture GUI context and used interactively by the user of the gesture GUI. Evolving the arrangement of FIG. 7 to higher dimensional GUIs, including those taught in the present application, FIG. 8b depicts a context selection task fit into a high-dimensional GUI context and used interactively by the user of the high-dimensional GUI. Evolving the arrangement of FIG. 7 to include gesture grammars taught in the present application, FIG. 8c depicts a context selection task fit into a gesture grammar GUI context and used interactively by the user of the gesture grammar GUI.

The present invention provides for either or both of high-dimensionality in the user interface and for a linguistic “grammar-based” approach to the user interface for CAD systems. When both high-dimensionality in the user interface and for a linguistic “grammar-based” approach are used simultaneously, a number of powerful and advantageous synergies arise that benefit the user experience, user efficiency, user effectiveness, user productivity, and user creative exploration and development. Regarding these in relation to context switching, FIG. 8d depicts a context selection task fit into a high-dimensional gesture grammar GUI context and used interactively by the user of the high-dimensional gesture grammar GUI.

Opportunities for Combined Use of High-Dimension User Interfaces, Gestures, and Grammars in CAD Systems

Again, the present invention provides for either or both of high-dimensionality in the user interface and for a linguistic “grammar-based” approach to the user interface for CAD systems. When both high-dimensionality in the user interface and for a linguistic “grammar-based” approach are used simultaneously, a number of powerful and advantageous synergies arise that benefit the user experience, user efficiency, user effectiveness, user productivity, and user creative exploration and development. The approach described can also be used with or adapted to other comparably complex or high-dimensionality applications, (for example data visualization, realistic interactive computer games, advanced GIS systems, etc.).

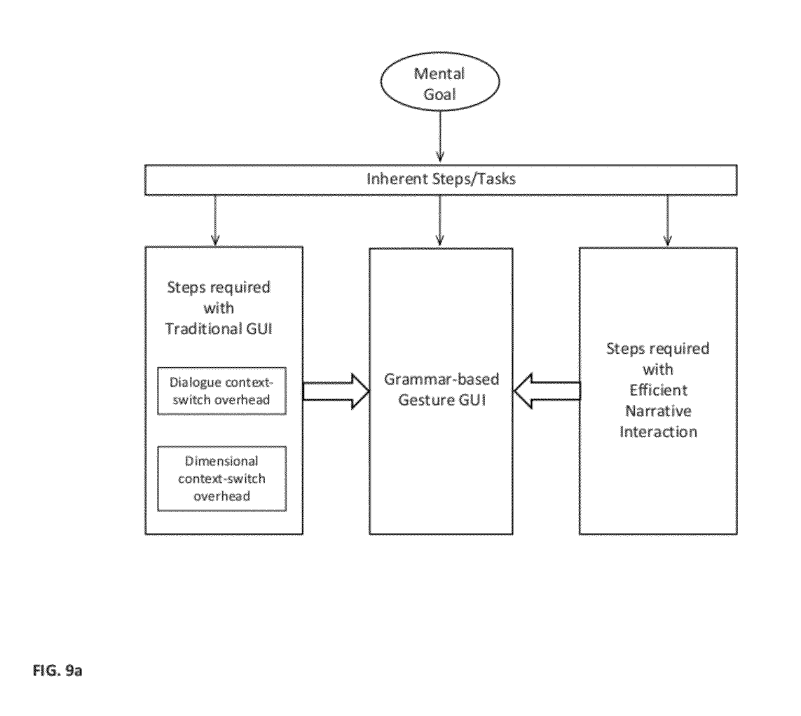

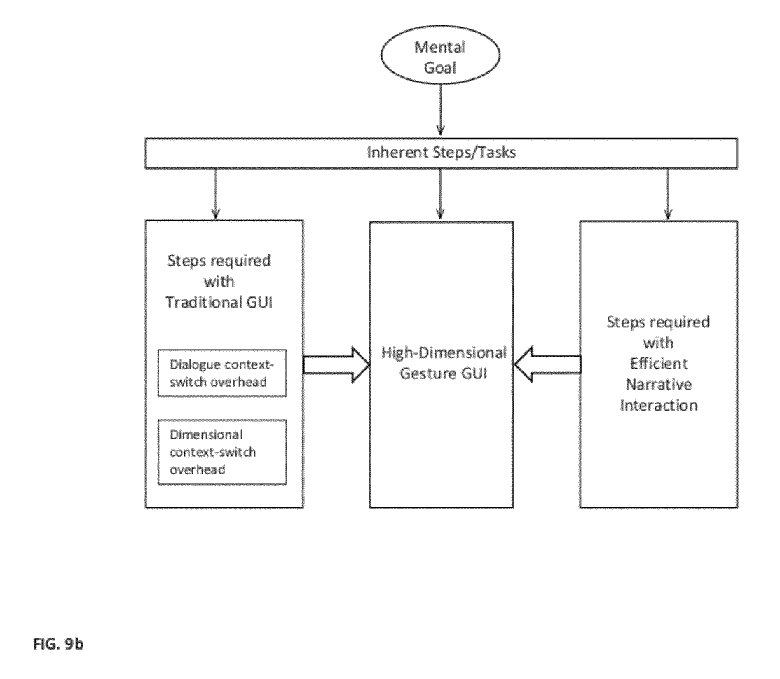

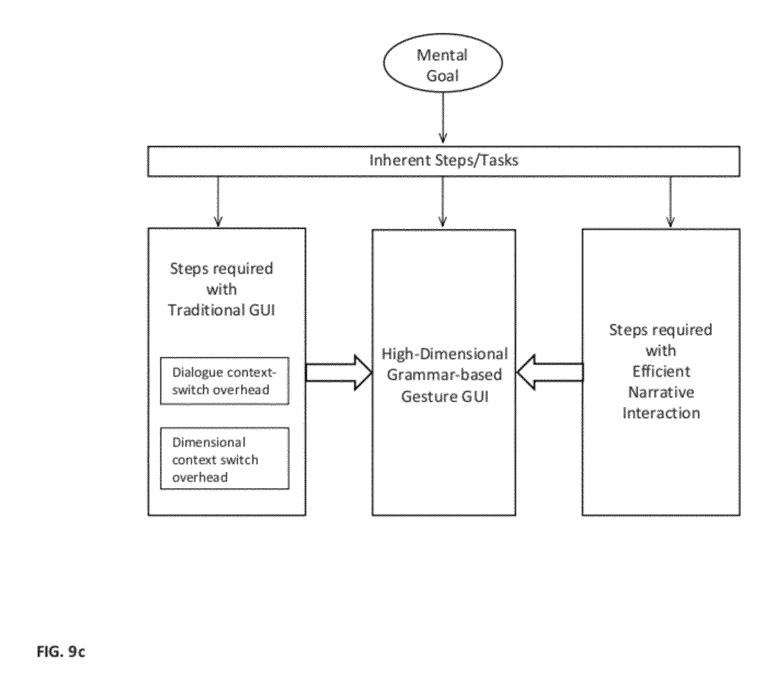

FIG. 9a depicts an adaptation of the arrangement of FIG. 3, wherein a grammar based gesture GUI provides an improved user interface.

FIG. 9b depicts an adaptation of the arrangement of FIG. 3, wherein a high-dimensional GUI provides an improved user interface.

FIG. 9c depicts an adaptation of the arrangement of FIG. 3, wherein a high-dimensional gesture grammar GUI provides an improved user interface.

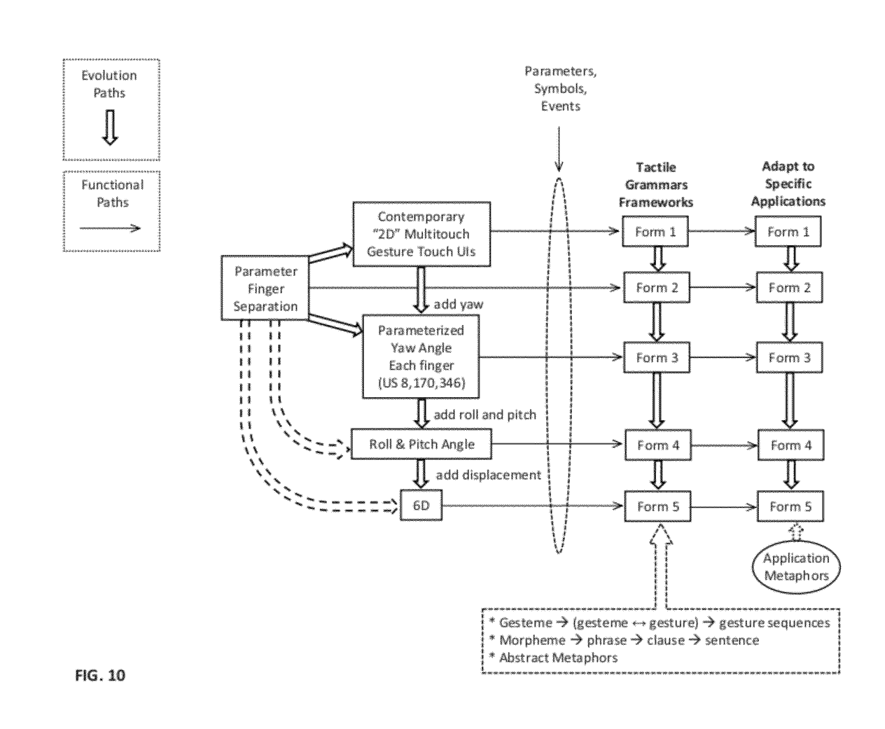

FIG. 10 depicts an example (vertically sequenced) progression of increasingly-higher dimension touch user interfaces and an associated (vertically sequenced) progression of tactile grammar frameworks for each of the (vertically sequenced) progression of corresponding parameters, symbols and events. Each tactile grammar framework further permits adaptation to specific applications, leveraging application-specific metaphors. These can also include general-purpose metaphors and/or general-purpose linguistic constructs.

### Overview of HDTP User Interface Technology

Before providing further detail specific to the present invention, some example embodiments and features of HDTP technology is provided. With the exception of a few minor variations and examples, the material presented in this overview section is draw from U.S. Pat. Nos. 6,570,078, 8,169,414, and 8,170,346, pending U.S. patent application Ser. Nos. 11/761,978, 12/418,605, 12/502,230, 12/541,948, 13/026,248, and related pending U.S. patent applications and is accordingly attributed to the associated inventors.

### Embodiments Employing a Touchpad and Touchscreen Form of a HDTP

FIGS. 11a-11g (adapted from U.S. patent application Ser. No. 12/418,605) and 2a-2e (adapted from U.S. Pat. No. 7,557,797) depict a number of arrangements and embodiments employing the HDTP technology. FIG. 11a illustrates an HDTP as a peripheral that can be used with a desktop computer (shown) or laptop) not shown). FIG. 11b depicts an HDTP integrated into a laptop in place of the traditional touchpad pointing device. In FIGS. 11a-11b the HDTP tactile sensor can be a stand-alone component or can be integrated over a display so as to form a touchscreen. FIG. 11c depicts an HDTP integrated into a desktop computer display so as to form a touchscreen. FIG. 11d shows the HDTP integrated into a laptop computer display so as to form a touchscreen.

FIG. 11e depicts an HDTP integrated into a cell phone, smartphone, PDA, or other hand-held consumer device. FIG. 11f shows an HDTP integrated into a test instrument, portable service-tracking device, portable service-entry device, field instrument, or other hand-held industrial device. In FIGS. 11e-11f the HDTP tactile sensor can be a stand-alone component or can be integrated over a display so as to form a touchscreen.

FIG. 11g depicts an HDTP touchscreen configuration as can be used in a tablet computer, wall-mount computer monitor, digital television, video conferencing screen, kiosk, etc.

In at least the arrangements of FIGS. 11a, 11c, 11d, and 11g, or other sufficiently large tactile sensor implementation of the HDTP, more than one hand can be used an individually recognized as such.

Embodiments incorporating the HDTP into a Traditional or Contemporary Generation Mouse

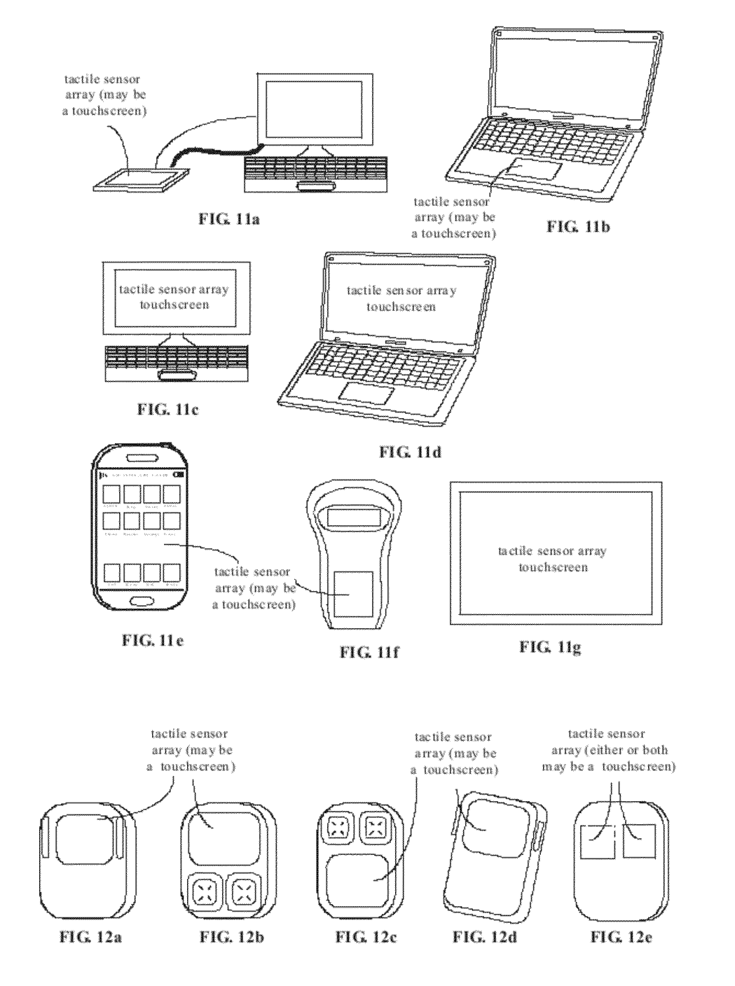

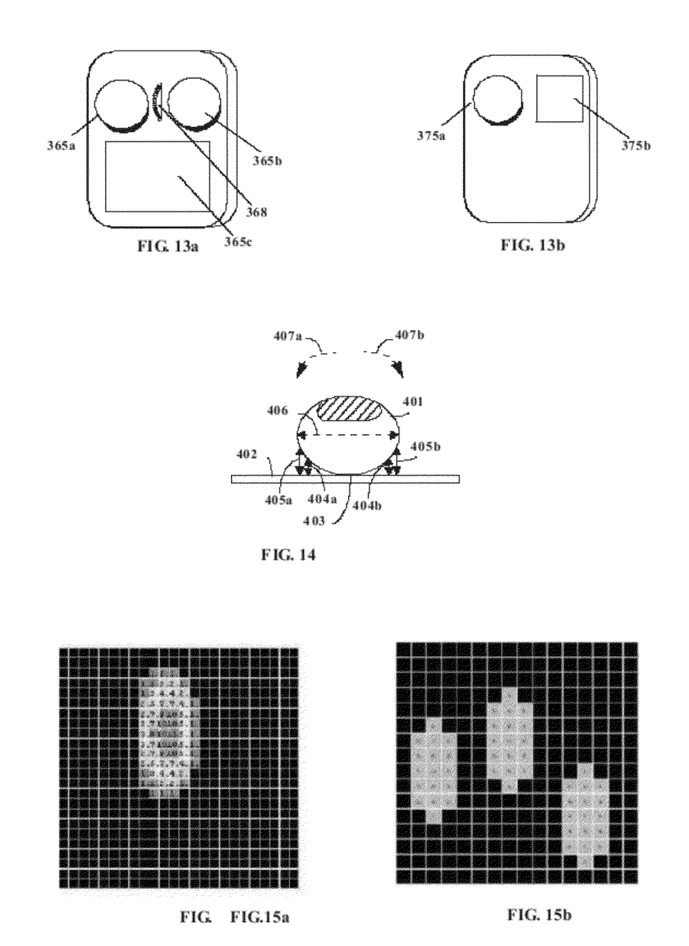

FIGS. 12a-12e and FIGS. 13a-13b (adapted from U.S. Pat. No. 7,557,797) depict various integrations of an HDTP into the back of a conventional computer mouse. Any of these arrangements can employ a connecting cable, or the device can be wireless.

In the integrations depicted in FIGS. 12a-12d the HDTP tactile sensor can be a stand-alone component or can be integrated over a display so as to form a touchscreen. Such configurations have very recently become popularized by the product release of Apple “Magic Mouse™” although such combinations of a mouse with a tactile sensor array on its back responsive to multitouch and gestures were taught earlier in pending U.S. patent application Ser. No. 12/619,678 (priority date Feb. 12, 2004) entitled “User Interface Mouse with Touchpad Responsive to Gestures and Multi-Touch.”

In another embodiment taught in the specification of issued U.S. Pat. No. 7,557,797 and associated pending continuation applications more than two touchpads can be included in the advance mouse embodiment, for example as suggested in the arrangement of FIG. 12e. As with the arrangements of FIGS. 12a-12d, one or more of the plurality of HDTP tactile sensors or exposed sensor areas of arrangements such as that of FIG. 12e can be integrated over a display so as to form a touchscreen. Other advance mouse arrangements include the integrated trackball/touchpad/mouse combinations of FIGS. 13a-13b taught in U.S. Pat. No. 7,557,797.

### Overview of HDTP User Interface Technology

The information in this section provides an overview of HDTP user interface technology as described in U.S. Pat. Nos. 6,570,078, 169,414, and 8,170,346, pending U.S. patent application Ser. Nos. 11/761,978, 12/418,605, 12/502,230, 12/541,948, and related pending U.S. patent applications.

In an embodiment, a touchpad used as a pointing and data entry device can comprise an array of sensors. The array of sensors is used to create a tactile image of a type associated with the type of sensor and method of contact by the human hand.

In one embodiment, the individual sensors in the sensor array are pressure sensors and a direct pressure-sensing tactile image is generated by the sensor array.

In another embodiment, the individual sensors in the sensor array are proximity sensors and a direct proximity tactile image is generated by the sensor array. Since the contacting surfaces of the finger or hand tissue contacting a surface typically increasingly deforms as pressure is applied, the sensor array comprised of proximity sensors also provides an indirect pressure-sensing tactile image.

In another embodiment, the individual sensors in the sensor array can be optical sensors. In one variation of this, an optical image is generated and an indirect proximity tactile image is generated by the sensor array. In another variation, the optical image can be observed through a transparent or translucent rigid material and, as the contacting surfaces of the finger or hand tissue contacting a surface typically increasingly deforms as pressure is applied, the optical sensor array also provides an indirect pressure-sensing tactile image.

In some embodiments, the array of sensors can be transparent or translucent and can be provided with an underlying visual display element such as an alphanumeric, graphics, or image display. The underlying visual display can comprise, for example, an LED array display, a backlit LCD, etc. Such an underlying display can be used to render geometric boundaries or labels for soft-key functionality implemented with the tactile sensor array, to display status information, etc. Tactile array sensors implemented as transparent touchscreens are taught in the 1999 filings of issued U.S. Pat. No. 6,570,078 and pending U.S. patent application Ser. No. 11/761,978. Alternatively, as taught in the combination of pending U.S. patent application Ser. Nos. 12/418,605, 13/180,345, and 61/506,634, a display comprising an LED array (for example, OLED displays) can be adapted to serve as a combined display and tactile sensor array with various substantial implementation advantages that are highly relevant to consumer electronic devices, including mobile devices such as tablet computers, smartphones, touchscreen display monitors, and laptop computers.

In an embodiment, the touchpad or touchscreen can comprise a tactile sensor array obtains or provides individual measurements in every enabled cell in the sensor array that provides these as numerical values. The numerical values can be communicated in a numerical data array, as a sequential data stream, or in other ways. When regarded as a numerical data array with row and column ordering that can be associated with the geometric layout of the individual cells of the sensor array, the numerical data array can be regarded as representing a tactile image. The only tactile sensor array requirement to obtain the full functionality of the HDTP is that the tactile sensor array produce a multi-level gradient measurement image as a finger, part of hand, or other pliable object varies is proximity in the immediate area of the sensor surface.

Such a tactile sensor array should not be confused with the “null/contact” touchpad which, in normal operation, acts as a pair of orthogonally responsive potentiometers. These “null/contact” touchpads do not produce pressure images, proximity images, or other image data but rather, in normal operation, two voltages linearly corresponding to the location of a left-right edge and forward-back edge of a single area of contact. Such “null/contact” touchpads, which are universally found in existing laptop computers, are discussed and differentiated from tactile sensor arrays in issued U.S. Pat. No. 6,570,078 and pending U.S. patent application Ser. No. 11/761,978. Before leaving this topic, it is pointed out that these the “null/contact” touchpads nonetheless can be inexpensively adapted with simple analog electronics to provide at least primitive multi-touch capabilities as taught in issued U.S. Pat. No. 6,570,078 and pending U.S. patent application Ser. No. 11/761,978 (pre-grant publication U.S. 2007/0229477 and therein, paragraphs [0022]-[0029], for example).

More specifically, FIG. 14 (adapted from U.S. patent application Ser. No. 12/418,605) illustrates the side view of a finger 401 lightly touching the surface 402 of a tactile sensor array. In this example, the finger 401 contacts the tactile sensor surface in a relatively small area 403. In this situation, on either side the finger curves away from the region of contact 403, where the non-contacting yet proximate portions of the finger grow increasingly far 404a, 405a, 404b, 405b from the surface of the sensor 402. These variations in physical proximity of portions of the finger with respect to the sensor surface should cause each sensor element in the tactile proximity sensor array to provide a corresponding proximity measurement varying responsively to the proximity, separation distance, etc. The tactile proximity sensor array advantageously comprises enough spatial resolution to provide a plurality of sensors within the area occupied by the finger (for example, the area comprising width 406). In this case, as the finger is pressed down, the region of contact 403 grows as the more and more of the pliable surface of the finger conforms to the tactile sensor array surface 402, and the distances 404a, 405a, 404b, 405b contract. If the finger is tilted, for example by rolling in the user viewpoint counterclockwise (which in the depicted end-of-finger viewpoint clockwise 407a) the separation distances on one side of the finger 404a, 405a will contract while the separation distances on one side of the finger 404b, 405b will lengthen. Similarly if the finger is tilted, for example by rolling in the user viewpoint clockwise (which in the depicted end-of-finger viewpoint counterclockwise 407b) the separation distances on the side of the finger 404b, 405b will contract while the separation distances on the side of the finger 404a, 405a will lengthen.

In many various embodiments, the tactile sensor array can be connected to interface hardware that sends numerical data responsive to tactile information captured by the tactile sensor array to a processor. In various embodiments, this processor will process the data captured by the tactile sensor array and transform it various ways, for example into a collection of simplified data, or into a sequence of tactile image “frames” (this sequence akin to a video stream), or into highly refined information responsive to the position and movement of one or more fingers and other parts of the hand.

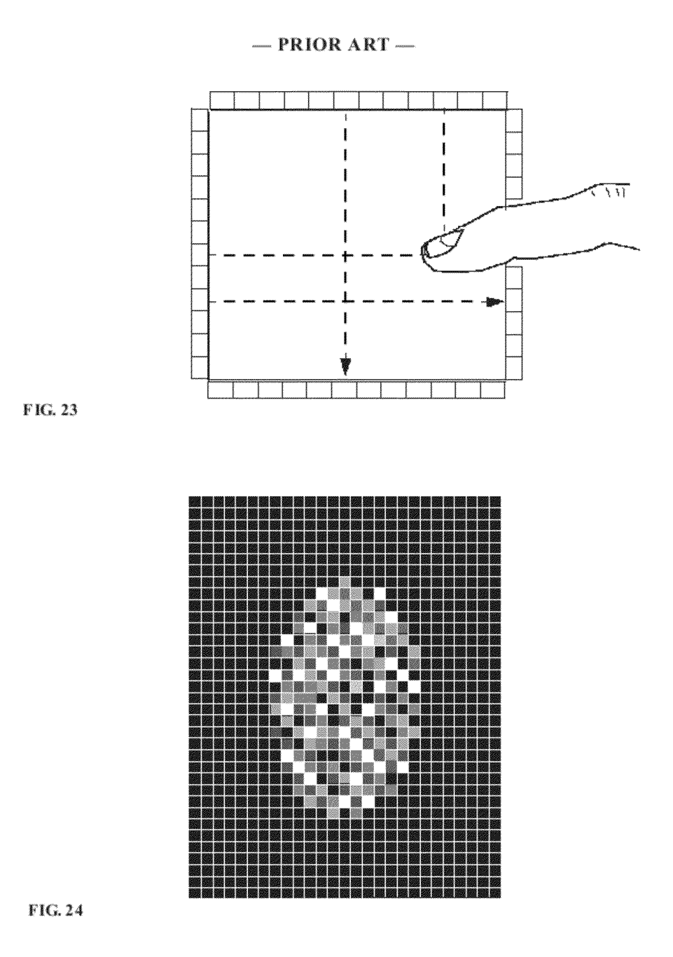

As to further detail of the latter example, a “frame” can refer to a 2-dimensional list, number of rows by number of columns, of tactile measurement value of every pixel in a tactile sensor array at a given instance. The time interval between one frame and the next one depends on the frame rate of the system and the number of frames in a unit time (usually frames per second). However, these features are and are not firmly required. For example, in some embodiments a tactile sensor array can not be structured as a 2-dimensional array but rather as row-aggregate and column-aggregate measurements (for example row sums and columns sums as in the tactile sensor of year 2003-2006 Apple Powerbooks, row and column interference measurement data as can be provided by a surface acoustic wave or optical transmission modulation sensor as discussed later in the context of FIG. 23, etc.). Additionally, the frame rate can be adaptively-variable rather than fixed, or the frame can be segregated into a plurality regions each of which are scanned in parallel or conditionally (as taught in U.S. Pat. No. 6,570,078 and pending U.S. patent application Ser. No. 12/418,605), etc.

FIG. 15a (adapted from U.S. patent application Ser. No. 12/418,605) depicts a graphical representation of a tactile image produced by contact with the bottom surface of the most outward section (between the end of the finger and the most nearby joint) of a human finger on a tactile sensor array. In this tactile array, there are 24 rows and 24 columns; other realizations can have significantly more (hundreds or thousands) of rows and columns. Tactile measurement values of each cell are indicated by the numbers and shading in each cell. Darker cells represent cells with higher tactile measurement values. Similarly, FIG. 15b (also adapted from U.S. patent application Ser. No. 12/418,605) provides a graphical representation of a tactile image produced by contact with multiple human fingers on a tactile sensor array. In other embodiments, there can be a larger or smaller number of pixels for a given images size, resulting in varying resolution. Additionally, there can be larger or smaller area with respect to the image size resulting in a greater or lesser potential measurement area for the region of contact to be located in or move about.

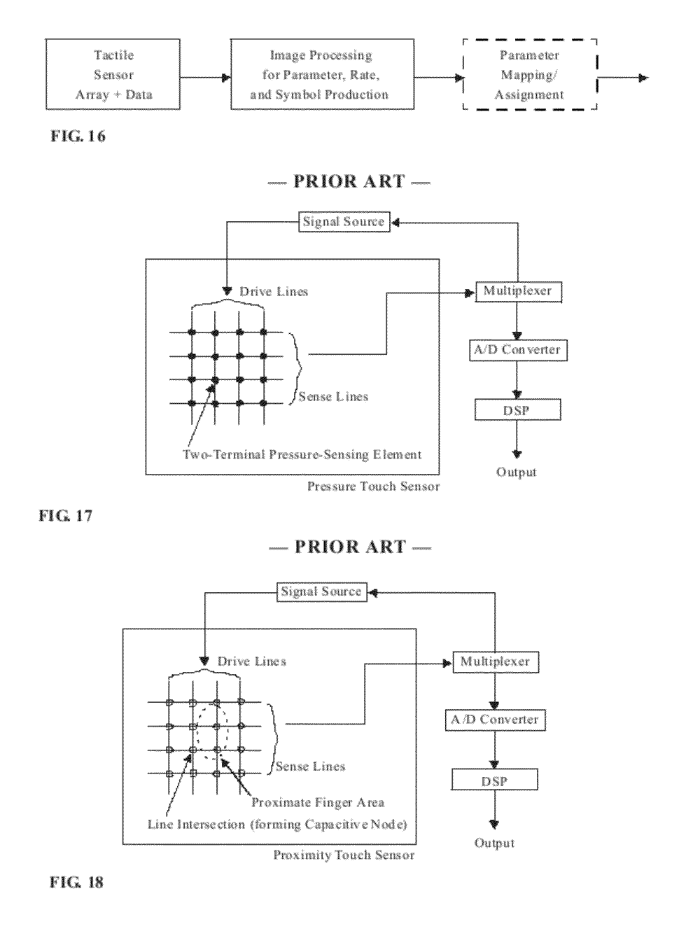

FIG. 16 (adapted from U.S. patent application Ser. No. 12/418,605) depicts a realization wherein a tactile sensor array is provided with real-time or near-real-time data acquisition capabilities. The captured data reflects spatially distributed tactile measurements (such as pressure, proximity, etc.). The tactile sensory array and data acquisition stage provides this real-time or near-real-time tactile measurement data to a specialized image processing arrangement for the production of parameters, rates of change of those parameters, and symbols responsive to aspects of the hand's relationship with the tactile or other type of sensor array. In some applications, these measurements can be used directly. In other situations, the real-time or near-real-time derived parameters can be directed to mathematical mappings (such as scaling, offset, and nonlinear warpings) in real-time or near-real-time into real-time or near-real-time application-specific parameters or other representations useful for applications. In some embodiments, general purpose outputs can be assigned to variables defined or expected by the application.

### Types of Tactile Sensor Arrays

The tactile sensor array employed by HDTP technology can be implemented by a wide variety of means, for example:
Pressure sensor arrays (implemented by for example—although not limited to—one or more of resistive, capacitive, piezo, optical, acoustic, or other sensing elements);
Pressure sensor arrays (implemented by for example—although not limited to—one or more of resistive, capacitive, piezo, optical, acoustic, or other sensing elements);
Proximity sensor arrays (implemented by for example—although not limited to—one or more of capacitive, optical, acoustic, or other sensing elements);
Surface-contact sensor arrays (implemented by for example—although not limited to—one or more of resistive, capacitive, piezo, optical, acoustic, or other sensing elements).

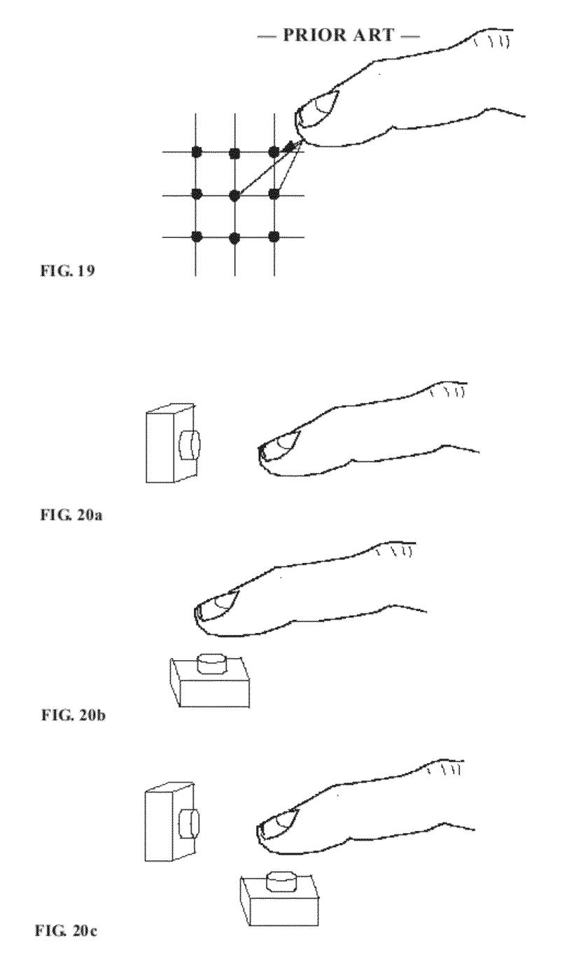

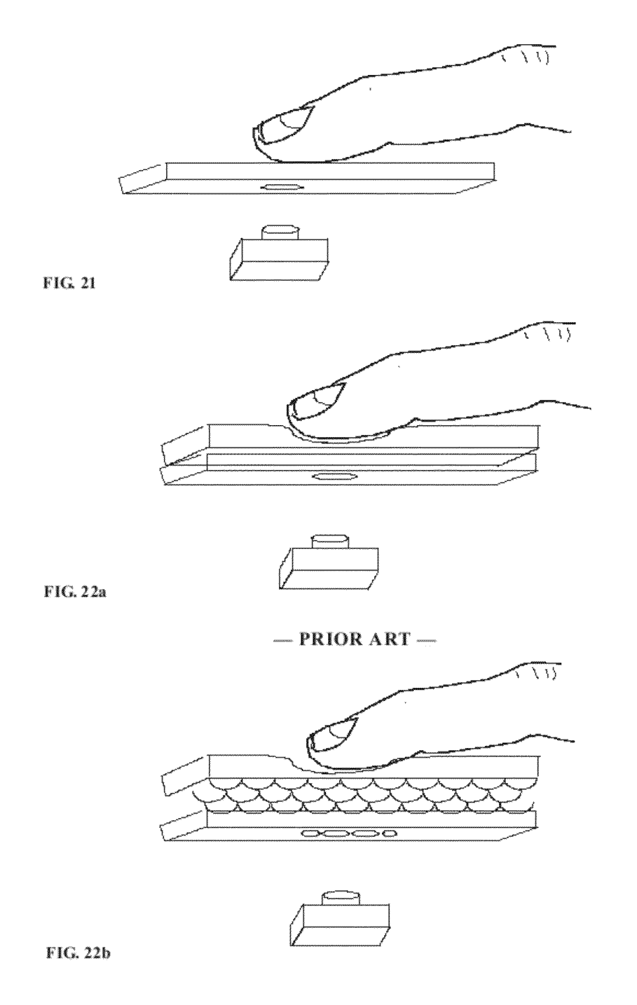

Below a few specific examples of the above are provided by way of illustration; however these are by no means limiting. The examples include:
Pressure sensor arrays comprising arrays of isolated sensors (FIG. 17);
Capacitive proximity sensors (FIG. 18);
Multiplexed LED optical reflective proximity sensors (FIG. 19);
Video camera optical reflective sensing (as taught in U.S. Pat. No. 6,570,078 and U.S. patent application Ser. Nos. 10/683,915 and 11/761,978):
   direct image of hand (FIGS. 20a-20c);
   image of deformation of material (FIG. 21);
Surface contract refraction/absorption (FIG. 22)

An example implementation of a tactile sensor array is a pressure sensor array. Pressure sensor arrays discussed in U.S. Pat. No. 6,570,078 and pending U.S. patent application Ser. No. 11/761,978. FIG. 17 depicts a pressure sensor array arrangement comprising a rectangular array of isolated individual two-terminal pressure sensor elements. Such two-terminal pressure sensor elements typically operate by measuring changes in electrical (resistive, capacitive) or optical properties of an elastic material as the material is compressed. In typical embodiment, each sensor element in the sensor array can be individually accessed via multiplexing arrangement, for example as shown in FIG. 17, although other arrangements are possible and provided for by the invention. Examples of prominent manufacturers and suppliers of pressure sensor arrays include Tekscan, Inc. (307 West First Street., South Boston, Mass., 02127, www.tekscan.com), Pressure Profile Systems (5757 Century Boulevard, Suite 600, Los Angeles, Calif. 90045, www.pressureprofile.com), Sensor Products, Inc. (300 Madison Avenue, Madison, N.J. 07940 USA, www.sensorprod.com), and Xsensor Technology Corporation (Suite 111, 319-2nd Ave SW, Calgary, Alberta T2P 0C5, Canada, www.xsensor.com).

Capacitive proximity sensors can be used in various handheld devices with touch interfaces (see for example, among many, http://electronics.howstuffworks.com/iphone2.htm, http://www.veritasetvisus.com/VVTP-12,%20Walker.pdf). Prominent manufacturers and suppliers of such sensors, both in the form of opaque touchpads and transparent touch screens, include Balda AG (Bergkirchener Str. 228, 32549 Bad Oeynhausen, Del., www.balda.de), Cypress (198 Champion Ct., San Jose, Calif. 95134, www.cypress.com), and Synaptics (2381 Bering Dr., San Jose, Calif. 95131, www.synaptics.com). In such sensors, the region of finger contact is detected by variations in localized capacitance resulting from capacitive proximity effects induced by an overlapping or otherwise nearly-adjacent finger. More specifically, the electrical field at the intersection of orthogonally-aligned conductive buses is influenced by the vertical distance or gap between the surface of the sensor array and the skin surface of the finger. Such capacitive proximity sensor technology is low-cost, reliable, long-life, stable, and can readily be made transparent. FIG. 18 (adapted from http://www.veritasetvisus.com/VVTP-12,%20Walker.pdf with slightly more functional detail added) shows a popularly accepted view of a typical cell phone or PDA capacitive proximity sensor implementation. Capacitive sensor arrays of this type can be highly susceptible to noise and various shielding and noise-suppression electronics and systems techniques can need to be employed for adequate stability, reliability, and performance in various electric field and electromagnetically-noisy environments. In some embodiments of an HDTP, the present invention can use the same spatial resolution as current capacitive proximity touchscreen sensor arrays. In other embodiments of the present invention, a higher spatial resolution is advantageous.

Forrest M. Mims is credited as showing that an light-emitting diode (LED) can be used as a light detector as well as a light emitter. Recently, arrays of light-emitting diodes have been adapted for use as a tactile proximity sensor array (for example, as taught in U.S. Pat. No. 7,598,949 by Han and depicted in the video available at http://cs.nyu.edu/˜jhan/ledtouch/index.html). Such tactile proximity array implementations typically need to be operated in a darkened environment (as seen in the video in the above web link) so as to avoid a number of interference effects from ambient light. In an embodiment provided for by the present invention, each LED in an array of LEDs can be used as a photodetector as well as a light emitter, although a single LED can either transmit or receive information at one time. Each LED in the array can sequentially be selected to be set to be in receiving mode while others adjacent to it are placed in light emitting mode. A particular LED in receiving mode can pick up reflected light from the finger, provided by said neighboring illuminating-mode LEDs. FIG. 19 depicts an implementation. The invention provides for additional systems and methods for not requiring darkness in the user environment in order to operate the LED array as a tactile proximity sensor. In one embodiment, potential interference from ambient light in the surrounding user environment can be limited by using an opaque pliable or elastically deformable surface covering the LED array that is appropriately reflective (directionally, amorphously, etc. as can be advantageous in a particular design) on the side facing the LED array. Such a system and method can be readily implemented in a wide variety of ways as is clear to one skilled in the art. In another embodiment, potential interference from ambient light in the surrounding user environment can be limited by employing amplitude, phase, or pulse width modulated circuitry or software to control the underlying light emission and receiving process. For example, in an implementation the LED array can be configured to emit modulated light modulated at a particular carrier frequency or variational waveform and respond to only modulated light signal components extracted from the received light signals comprising that same carrier frequency or variational waveform. Such a system and method can be readily implemented in a wide variety of ways as is clear to one skilled in the art.

Additionally, as taught in pending U.S. patent application Ser. Nos. 13/180,345 and 61/506,634, a display comprising an LED array (for example, OLED displays) can be adapted to serve as a combined display and tactile sensor array with various substantial implementation advantages highly relevant to consumer electronic devices, including mobile devices such as tablet computers, smartphones, touchscreen display monitors, and laptop computers. Additionally, as taught in pending U.S. patent application Ser. Nos. 13/180,345 and 61/506,634, adapting a display comprising an LED array (for example, OLED displays) to serve as a combined display and tactile sensor array can also provide a high degree of tactile sensor spatial resolution. Accordingly, implementations that adapt a display comprising an LED array (for example, an OLED display) to serve as a combined display and tactile sensor array is of particular special interest for CAD systems leveraging HDTP aspects of the invention. Further aspects of such implementations that are of particular special interest for CAD systems include:
A tablet computer format, for example as suggested in the depiction of FIG. 11g, providing high resolution display and high-resolution sensing hosting an advanced CAD application, configured to lay on a table top, lap of the user, etc.;
A portable tablet computer (for example as suggested in the depiction of FIG. 11g) or laptop computer (for example as suggested in the depiction of FIG. 11d or 11b) with high resolution display and high-resolution sensing hosting an advanced CAD application;
As taught in pending U.S. patent application Ser. Nos. 13/180,345 and 61/506,634, intimately and synergistically integrating touch-gesture user interface algorithm execution and display algorithm execution in a common processor such as a Graphics Processing Unit (GPU), economically using GPU processing cycles, providing opportunities for very high performance of the user interface experience, particularly for the highly synergistic combination of 3D graphics and HDTP technology;
Higher energy efficiency, accordingly permitting prolonged battery life for such a portable tablet computer format hosting an advanced CAD application.

Use of video cameras for gathering control information from the human hand in various ways is discussed in U.S. Pat. No. 6,570,078 and Pending U.S. patent application Ser. No. 10/683,915. Here the camera image array is employed as an HDTP tactile sensor array. Images of the human hand as captured by video cameras can be used as an enhanced multiple-parameter interface responsive to hand positions and gestures, for example as taught in U.S. patent application Ser. No. 10/683,915 Pre-Grant-Publication 2004/0118268 (paragraphs [314], [321]-[332], [411], [653], both stand-alone and in view of [325], as well as [241]-[263]). FIGS. 20a and 20b depict single camera implementations, while FIG. 20c depicts a two camera implementation. As taught in the aforementioned references, a wide range of relative camera sizes and positions with respect to the hand are provided for, considerably generalizing the arrangements shown in FIGS. 20a-20c

In another video camera tactile controller embodiment, a flat or curved transparent or translucent surface or panel can be used as sensor surface. When a finger is placed on the transparent or translucent surface or panel, light applied to the opposite side of the surface or panel reflects light in a distinctly different manner than in other regions where there is no finger or other tactile contact. The image captured by an associated video camera will provide gradient information responsive to the contact and proximity of the finger with respect to the surface of the translucent panel. For example, the parts of the finger that are in contact with the surface will provide the greatest degree of reflection while parts of the finger that curve away from the surface of the sensor provide less reflection of the light. Gradients of the reflected light captured by the video camera can be arranged to produce a gradient image that appears similar to the multilevel quantized image captured by a pressure sensor. By comparing changes in gradient, changes in the position of the finger and pressure applied by the finger can be detected. FIG. 21 depicts an implementation.

FIGS. 22a-22b depict an implementation of an arrangement comprising a video camera capturing the image of a deformable material whose image varies according to applied pressure. In the example of FIG. 22a, the deformable material serving as a touch interface surface can be such that its intrinsic optical properties change in response to deformations, for example by changing color, index of refraction, degree of reflectivity, etc. In another approach, the deformable material can be such that exogenous optic phenomena are modulated n response to the deformation. As an example, the arrangement of FIG. 22b is such that the opposite side of the deformable material serving as a touch interface surface comprises deformable bumps which flatten out against the rigid surface of a transparent or translucent surface or panel. The diameter of the image as seen from the opposite side of the transparent or translucent surface or panel increases as the localized pressure from the region of hand contact increases. Such an approach was created by Professor Richard M. White at U.C. Berkeley in the 1980's.

FIG. 23 depicts an optical or acoustic diffraction or absorption arrangement that can be used for contact or pressure sensing of tactile contact. Such a system can employ, for example light or acoustic waves. In this class of methods and systems, contact with or pressure applied onto the touch surface causes disturbances (diffraction, absorption, reflection, etc.) that can be sensed in various ways. The light or acoustic waves can travel within a medium comprised by or in mechanical communication with the touch surface. A slight variation of this is where surface acoustic waves travel along the surface of, or interface with, a medium comprised by or in mechanical communication with the touch surface.

Compensation for Non-Ideal Behavior of Tactile Sensor Arrays

Individual sensor elements in a tactile sensor array produce measurements that vary sensor-by-sensor when presented with the same stimulus. Inherent statistical averaging of the algorithmic mathematics can damp out much of this, but for small image sizes (for example, as rendered by a small finger or light contact), as well as in cases where there are extremely large variances in sensor element behavior from sensor to sensor, the invention provides for each sensor to be individually calibrated in implementations where that can be advantageous. Sensor-by-sensor measurement value scaling, offset, and nonlinear warpings can be invoked for all or selected sensor elements during data acquisition scans. Similarly, the invention provides for individual noisy or defective sensors can be tagged for omission during data acquisition scans.

FIG. 24 shows a finger image wherein rather than a smooth gradient in pressure or proximity values there is radical variation due to non-uniformities in offset and scaling terms among the sensors.

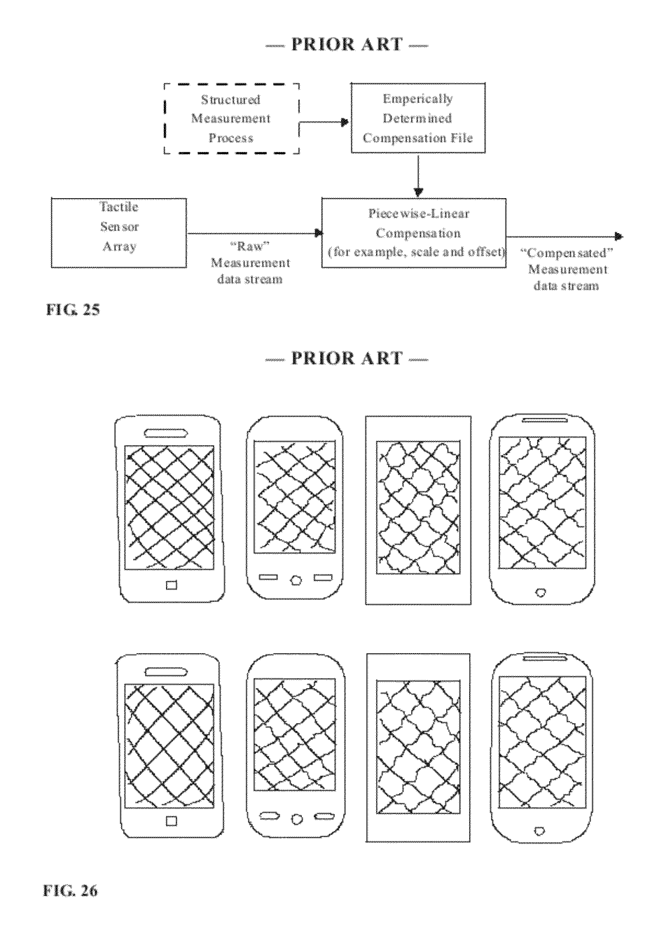

FIG. 25 shows a sensor-by-sensor compensation arrangement for such a situation. A structured measurement process applies a series of known mechanical stimulus values (for example uniform applied pressure, uniform simulated proximity, etc.) to the tactile sensor array and measurements are made for each sensor. Each measurement data point for each sensor is compared to what the sensor should read and a piecewise-linear correction is computed. In an embodiment, the coefficients of a piecewise-linear correction operation for each sensor element are stored in a file. As the raw data stream is acquired from the tactile sensor array, sensor-by-sensor the corresponding piecewise-linear correction coefficients are obtained from the file and used to invoke a piecewise-linear correction operation for each sensor measurement. The value resulting from this time-multiplexed series of piecewise-linear correction operations forms an outgoing “compensated” measurement data stream. Such an arrangement is employed, for example, as part of the aforementioned Tekscan resistive pressure sensor array products.

Additionally, the macroscopic arrangement of sensor elements can introduce nonlinear spatial warping effects. As an example, various manufacturer implementations of capacitive proximity sensor arrays and associated interface electronics are known to comprise often dramatic nonlinear spatial warping effects. FIG. 26 (adapted from http://labs.moto.com/diy-touchscreen-analysis/) depicts the comparative performance of a group of contemporary handheld devices wherein straight lines were entered using the surface of the respective touchscreens. A common drawing program was used on each device, with widely-varying type and degrees of nonlinear spatial warping effects clearly resulting. For simple gestures such as selections, finger-flicks, drags, spreads, etc., such nonlinear spatial warping effects introduce little consequence. For more precision applications, such nonlinear spatial warping effects introduce unacceptable performance. Close study of FIG. 26 shows different types of responses to tactile stimulus in the direct neighborhood of the relatively widely-spaced capacitive sensing nodes versus tactile stimulus in the boundary regions between capacitive sensing nodes. Increasing the number of capacitive sensing nodes per unit area can reduce this, as can adjustments to the geometry of the capacitive sensing node conductors. In many cases improved performance can be obtained by introducing or more carefully implementing interpolation mathematics.

Types of Hand Contact Measurements and Features provided by HDTP Technology

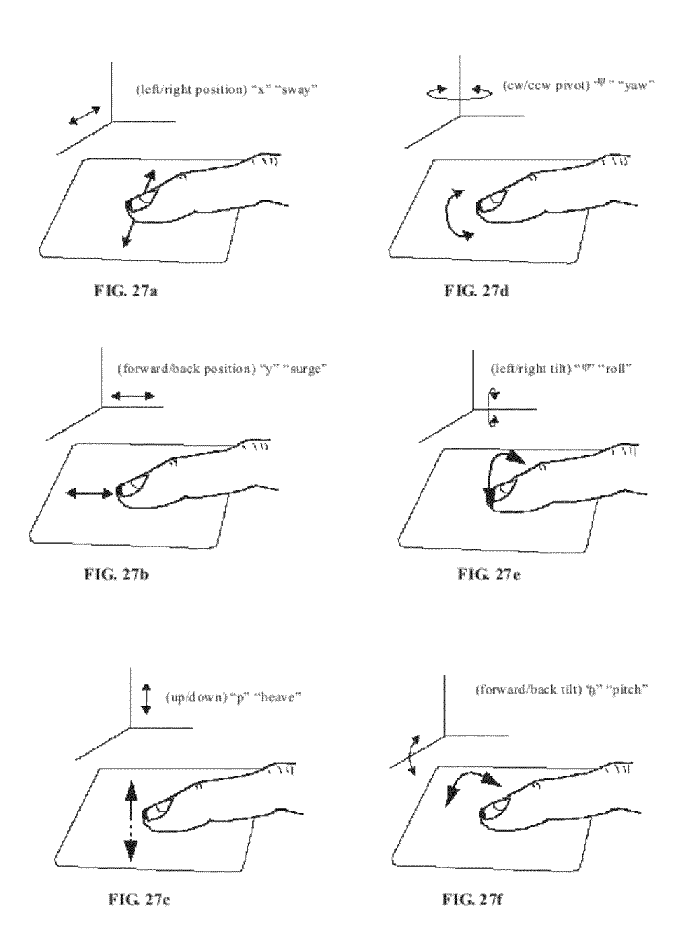

FIGS. 27a-27f (adapted from U.S. patent application Ser. No. 12/418,605 and described in U.S. Pat. No. 6,570,078) illustrate six independently adjustable degrees of freedom of touch from a single finger that can be simultaneously measured by the HDTP technology. The depiction in these figures is from the side of the touchpad. FIGS. 27a-27c show actions of positional change (amounting to applied pressure in the case of FIG. 27c) while FIGS. 27d-27f show actions of angular change. Each of these can be used to control a user interface parameter, allowing the touch of a single fingertip to control up to six simultaneously-adjustable quantities in an interactive user interface.

Each of the six parameters listed above can be obtained from operations on a collection of sums involving the geometric location and tactile measurement value of each tactile measurement sensor. Of the six parameters, the left-right geometric center, forward-back geometric center, and clockwise-counterclockwise yaw rotation can be obtained from binary threshold image data. The average downward pressure, roll, and pitch parameters are in some embodiments beneficially calculated from gradient (multi-level) image data. One remark is that because binary threshold image data is sufficient for the left-right geometric center, forward-back geometric center, and clockwise-counterclockwise yaw rotation parameters, these also can be discerned for flat regions of rigid non-pliable objects, and thus the HDTP technology thus can be adapted to discern these three parameters from flat regions with striations or indentations of rigid non-pliable objects.

These ‘Position Displacement’ parameters FIGS. 27a-27c can be realized by various types of unweighted averages computed across the blob of one or more of each the geometric location and tactile measurement value of each above-threshold measurement in the tactile sensor image. The pivoting rotation can be calculated from a least-squares slope which in turn involves sums taken across the blob of one or more of each the geometric location and the tactile measurement value of each active cell in the image; alternatively a high-performance adapted eigenvector method taught in co-pending U.S. Pat. No. 8,170,346 “High-Performance Closed-Form Single-Scan Calculation of Oblong-Shape Rotation Angles from Binary Images of Arbitrary Size Using Running Sums,” filed Mar. 14, 2009, can be used. The last two angle (“tilt”) parameters, pitch and roll, can be realized by performing calculations on various types of weighted averages as well as a number of other methods.

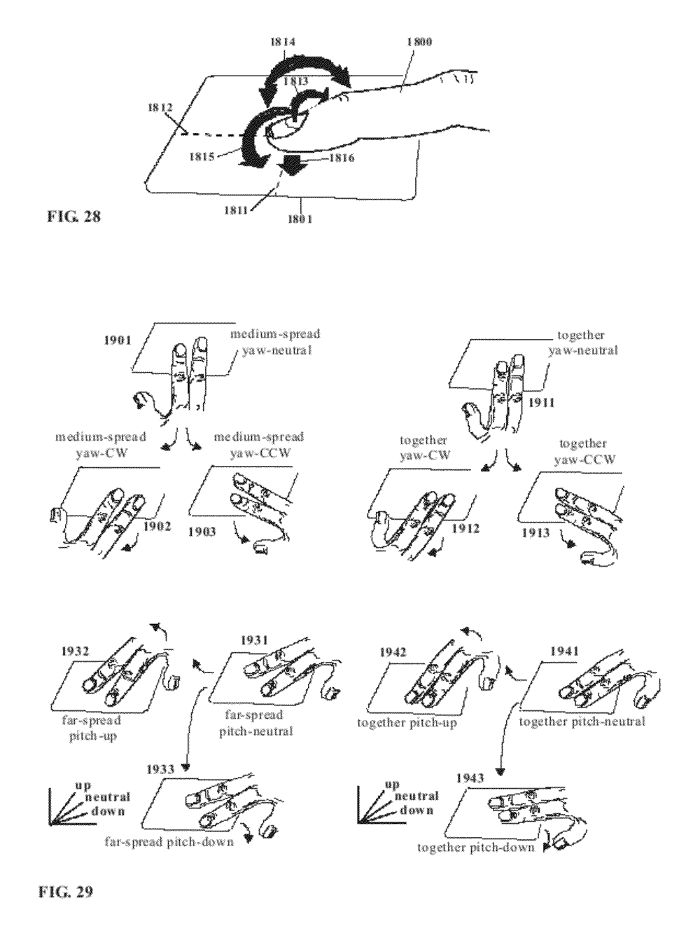

Each of the six parameters portrayed in FIGS. 27a-27f can be measured separately and simultaneously in parallel. FIG. 28 (adapted from U.S. Pat. No. 6,570,078) suggests general ways in which two or more of these independently adjustable degrees of freedom adjusted at once.

The HDTP technology provides for multiple points of contact, these days referred to as “multi-touch.” FIG. 29 (adapted from U.S. patent application Ser. No. 12/418,605 and described in U.S. Pat. No. 6,570,078) demonstrates a few two-finger multi-touch postures or gestures from the hundreds that can be readily recognized by HTDP technology. HTDP technology can also be configured to recognize and measure postures and gestures involving three or more fingers, various parts of the hand, the entire hand, multiple hands, etc. Accordingly, the HDTP technology can be configured to measure areas of contact separately, recognize shapes, fuse measures or pre-measurement data so as to create aggregated measurements, and other operations.

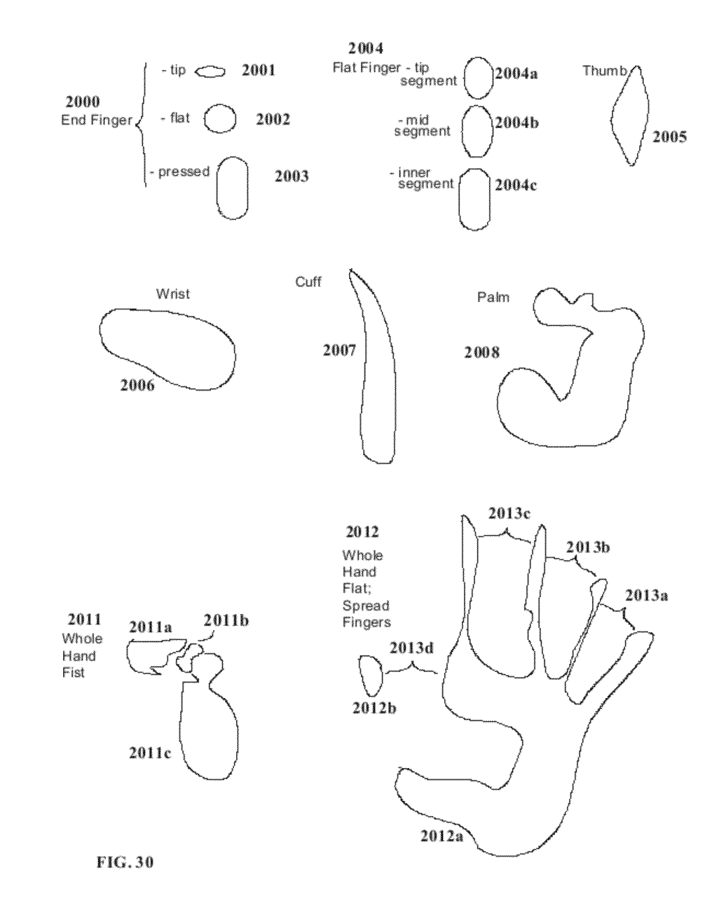

By way of example, FIG. 30 (adapted from U.S. Pat. No. 6,570,078) illustrates the pressure profiles for a number of example hand contacts with a pressure-sensor array. In the case 2000 of a finger's end, pressure on the touch pad pressure-sensor array can be limited to the finger tip, resulting in a spatial pressure distribution profile 2001; this shape does not change much as a function of pressure. Alternatively, the finger can contact the pad with its flat region, resulting in light pressure profiles 2002 which are smaller in size than heavier pressure profiles 2003. In the case 2004 where the entire finger touches the pad, a three-segment pattern (2004a, 2004b, 2004c) will result under many conditions; under light pressure a two segment pattern (2004b or 2004c missing) could result. In all but the lightest pressures the thumb makes a somewhat discernible shape 2005 as do the wrist 2006, edge-of-hand “cuff” 2007, and palm 2008; at light pressures these patterns thin and can also break into disconnected regions. Whole hand patterns such the fist 2011 and flat hand 2012 have more complex shapes. In the case of the fist 2011, a degree of curl can be discerned from the relative geometry and separation of sub-regions (here depicted, as an example, as 2011a, 2011b, and 2011c). In the case of the whole flat hand 2000, there can be two or more sub-regions which can be in fact joined (as within 2012a) or disconnected (as an example, as 2012a and 2012b are); the whole hand also affords individual measurement of separation “angles” among the digits and thumb (2013a, 2013b, 2013c, 2013d) which can easily be varied by the user.

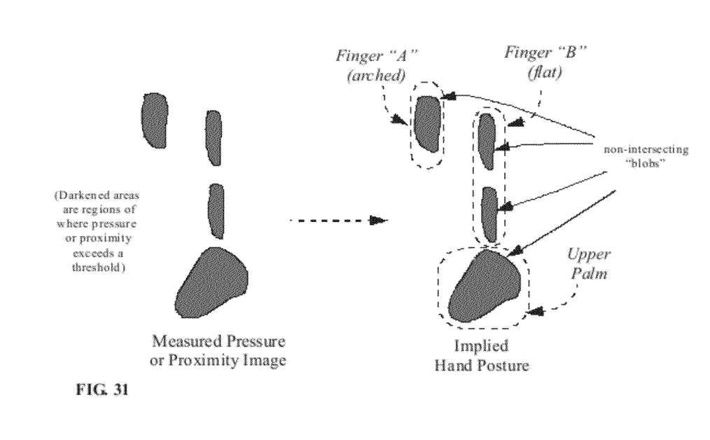

HDTP technology robustly provides feature-rich capability for tactile sensor array contact with two or more fingers, with other parts of the hand, or with other pliable (and for some parameters, non-pliable) objects. In one embodiment, one finger on each of two different hands can be used together to at least double number of parameters that can be provided. Additionally, new parameters particular to specific hand contact configurations and postures can also be obtained. By way of example, FIG. 31 (adapted from U.S. patent application Ser. No. 12/418,605 and described in U.S. Pat. No. 6,570,078) depicts one of a wide range of tactile sensor images that can be measured by using more of the human hand. U.S. Pat. No. 6,570,078 and pending U.S. patent application Ser. No. 11/761,978 provide additional detail on use of other parts of hand. Within the context of the example of FIG. 31:
multiple fingers can be used with the tactile sensor array, with or without contact by other parts of the hand;
The whole hand can be tilted & rotated;
The thumb can be independently rotated in yaw angle with respect to the yaw angle held by other fingers of the hand;
Selected fingers can be independently spread, flatten, arched, or lifted;
The palms and wrist cuff can be used;
Shapes of individual parts of the hand and combinations of them can be recognized.
   Selected combinations of such capabilities can be used to provide an extremely rich pallet of primitive control signals that can be used for a wide variety of purposes and applications.

### Other HDTP Processing, Signal Flows, and Operations

In order to accomplish this range of capabilities, HDTP technologies must be able to parse tactile images and perform operations based on the parsing. In general, contact between the tactile-sensor array and multiple parts of the same hand forfeits some degrees of freedom but introduces others. For example, if the end joints of two fingers are pressed against the sensor array as in FIG. 31, it will be difficult or impossible to induce variations in the image of one of the end joints in six different dimensions while keeping the image of the other end joints fixed. However, there are other parameters that can be varied, such as the angle between two fingers, the difference in coordinates of the finger tips, and the differences in pressure applied by each finger.

In general, compound images can be adapted to provide control over many more parameters than a single contiguous image can. For example, the two-finger postures considered above can readily pro-vide a nine-parameter set relating to the pair of fingers as a separate composite object adjustable within an ergonomically comfortable range. One example nine-parameter set the two-finger postures consider above is:
composite average x position;
inter-finger differential x position;
composite average y position;
inter-finger differential y position;
composite average pressure;
inter-finger differential pressure;
composite roll;
composite pitch;
composite yaw.

As another example, by using the whole hand pressed flat against the sensor array including the palm and wrist, it is readily possible to vary as many as sixteen or more parameters independently of one another. A single hand held in any of a variety of arched or partially-arched postures provides a very wide range of postures that can be recognized and parameters that can be calculated.

When interpreted as a compound image, extracted parameters such as geometric center, average downward pressure, tilt (pitch and roll), and pivot (yaw) can be calculated for the entirety of the asterism or constellation of smaller blobs. Additionally, other parameters associated with the asterism or constellation can be calculated as well, such as the aforementioned angle of separation between the fingers. Other examples include the difference in downward pressure applied by the two fingers, the difference between the left-right (“x”) centers of the two fingertips, and the difference between the two forward-back (“y”) centers of the two fingertips. Other compound image parameters are possible and are provided by HDTP technology.

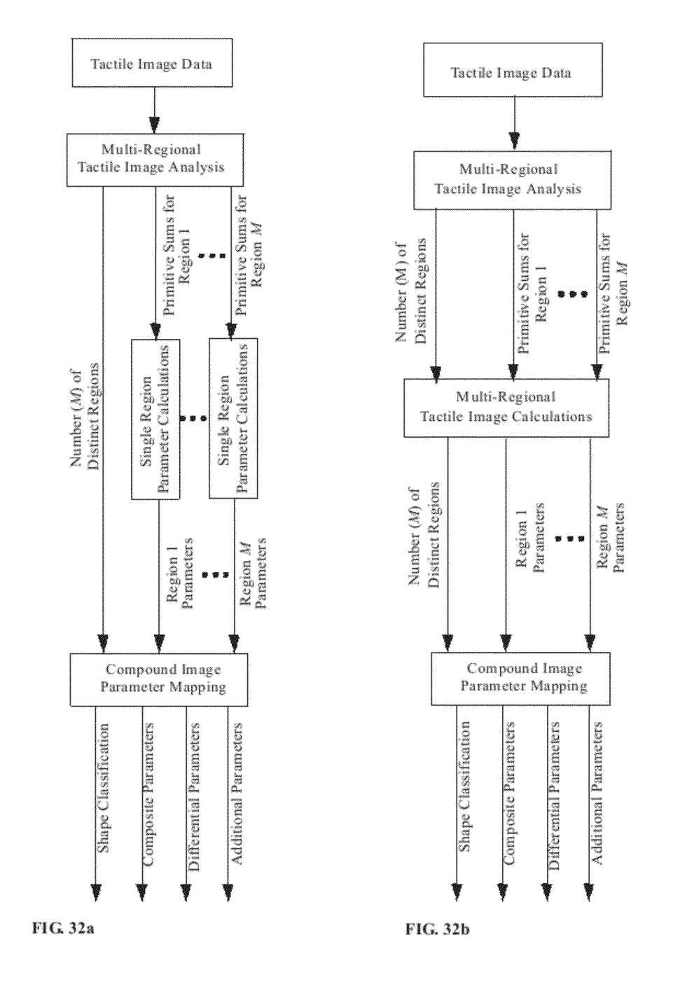

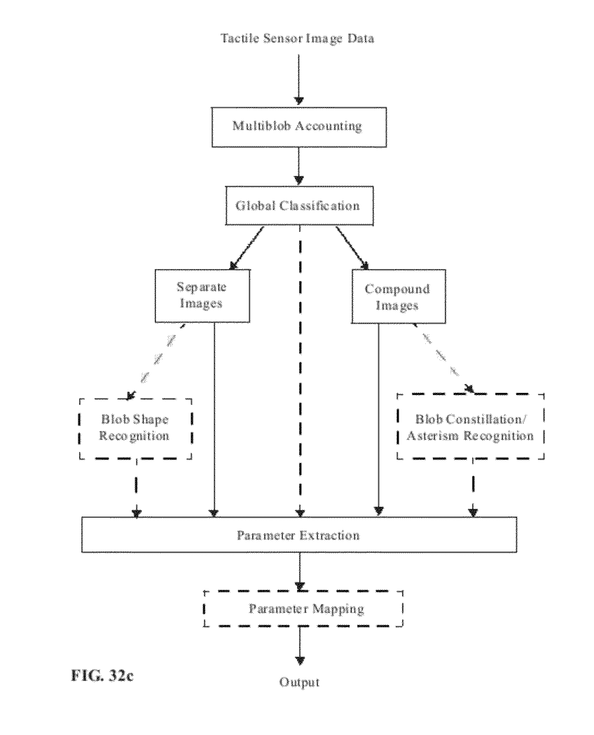

There are number of ways for implementing the handling of compound posture data images. Two contrasting examples are depicted in FIGS. 32a-32b (adapted from U.S. patent application Ser. No. 12/418,605) although many other possibilities exist and are provided for by the invention. In the embodiment of FIG. 32a, tactile image data is examined for the number “M” of isolated blobs (“regions”) and the primitive running sums are calculated for each blob. This can be done, for example, with the algorithms described earlier. Post-scan calculations can then be performed for each blob, each of these producing an extracted parameter set (for example, x position, y position, average pressure, roll, pitch, yaw) uniquely associated with each of the M blobs (“regions”). The total number of blobs and the extracted parameter sets are directed to a compound image parameter mapping function to produce various types of outputs, including:
Shape classification (for example finger tip, first-joint flat finger, two-joint flat finger, three joint-flat finger, thumb, palm, wrist, compound two-finger, compound three-finger, composite 4-finger, whole hand, etc.);
Composite parameters (for example composite x position, composite y position, composite average pressure, composite roll, composite pitch, composite yaw, etc.);
Differential parameters (for example pair-wise inter-finger differential x position, pair-wise inter-finger differential y position, pair-wise inter-finger differential pressure, etc.);
Additional parameters (for example, rates of change with respect to time, detection that multiple finger images involve multiple hands, etc.).

FIG. 32b depicts an alternative embodiment, tactile image data is examined for the number M of isolated blobs (“regions”) and the primitive running sums are calculated for each blob, but this information is directed to a multi-regional tactile image parameter extraction stage. Such a stage can include, for example, compensation for minor or major ergonomic interactions among the various degrees of postures of the hand. The resulting compensation or otherwise produced extracted parameter sets (for example, x position, y position, average pressure, roll, pitch, yaw) uniquely associated with each of the M blobs and total number of blobs are directed to a compound image parameter mapping function to produce various types of outputs as described for the arrangement of FIG. 32a.

Additionally, embodiments of the invention can be set up to recognize one or more of the following possibilities:
Single contact regions (for example a finger tip);
Multiple independent contact regions (for example multiple fingertips of one or more hands);
Fixed-structure (“constellation”) compound regions (for example, the palm, multiple-joint finger contact as with a flat finger, etc.);
Variable-structure (“asterism”) compound regions (for example, the palm, multiple-joint finger contact as with a flat finger, etc.).

Embodiments that recognize two or more of these possibilities can further be able to discern and process combinations of two more of the possibilities.

FIG. 32c (adapted from U.S. patent application Ser. No. 12/418,605) depicts a simple system for handling one, two, or more of the above listed possibilities, individually or in combination. In the general arrangement depicted, tactile sensor image data is analyzed (for example, in the ways described earlier) to identify and isolate image data associated with distinct blobs. The results of this multiple-blob accounting is directed to one or more global classification functions set up to effectively parse the tactile sensor image data into individual separate blob images or individual compound images. Data pertaining to these individual separate blob or compound images are passed on to one or more parallel or serial parameter extraction functions. The one or more parallel or serial parameter extraction functions can also be provided information directly from the global classification function(s). Additionally, data pertaining to these individual separate blob or compound images are passed on to additional image recognition function(s), the output of which can also be provided to one or more parallel or serial parameter extraction function(s). The output(s) of the parameter extraction function(s) can then be either used directly, or first processed further by parameter mapping functions. Clearly other implementations are also possible to one skilled in the art and these are provided for by the invention.

### Refining of the HDTP User Experience

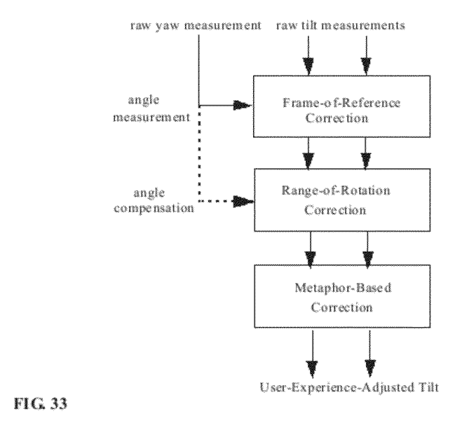

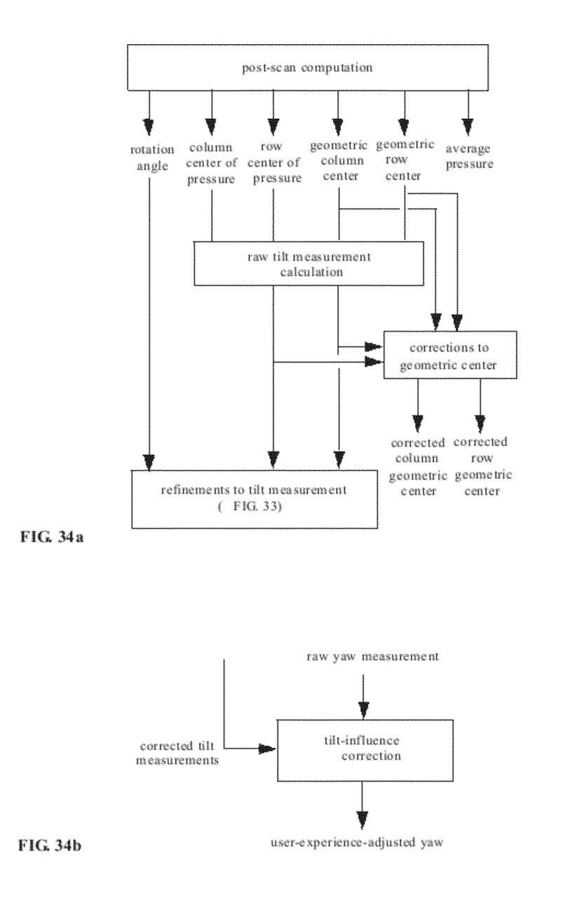

As an example of user-experience correction of calculated parameters, it is noted that placement of hand and wrist at a sufficiently large yaw angle can affect the range of motion of tilting. As the rotation angle increases in magnitude, the range of tilting motion decreases as mobile range of human wrists gets restricted. The invention provides for compensation for the expected tilt range variation as a function of measured yaw rotation angle. An embodiment is depicted in the middle portion of FIG. 33 (adapted from U.S. patent application Ser. No. 12/418,605). As another example of user-experience correction of calculated parameters, the user and application can interpret the tilt measurement in a variety of ways. In one variation for this example, tilting the finger can be interpreted as changing an angle of an object, control dial, etc. in an application. In another variation for this example, tilting the finger can be interpreted by an application as changing the position of an object within a plane, shifting the position of one or more control sliders, etc. Typically each of these interpretations would require the application of at least linear, and typically nonlinear, mathematical transformations so as to obtain a matched user experience for the selected metaphor interpretation of tilt. In one embodiment, these mathematical transformations can be performed as illustrated in the lower portion of FIG. 33. The invention provides for embodiments with no, one, or a plurality of such metaphor interpretation of tilt.

As the finger is tilted to the left or right, the shape of the area of contact becomes narrower and shifts away from the center to the left or right. Similarly as the finger is tilted forward or backward, the shape of the area of contact becomes shorter and shifts away from the center forward or backward. For a better user experience, the invention provides for embodiments to include systems and methods to compensate for these effects (i.e. for shifts in blob size, shape, and center) as part of the tilt measurement portions of the implementation. Additionally, the raw tilt measures can also typically be improved by additional processing. FIG. 34a (adapted from U.S. patent application Ser. No. 12/418,605) depicts an embodiment wherein the raw tilt measurement is used to make corrections to the geometric center measurement under at least conditions of varying the tilt of the finger. Additionally, the invention provides for yaw angle compensation for systems and situations wherein the yaw measurement is sufficiently affected by tilting of the finger. An embodiment of this correction in the data flow is shown in FIG. 34b (adapted from U.S. patent application Ser. No. 12/418,605).

### Additional HDTP Processing, Signal Flows, and Operations

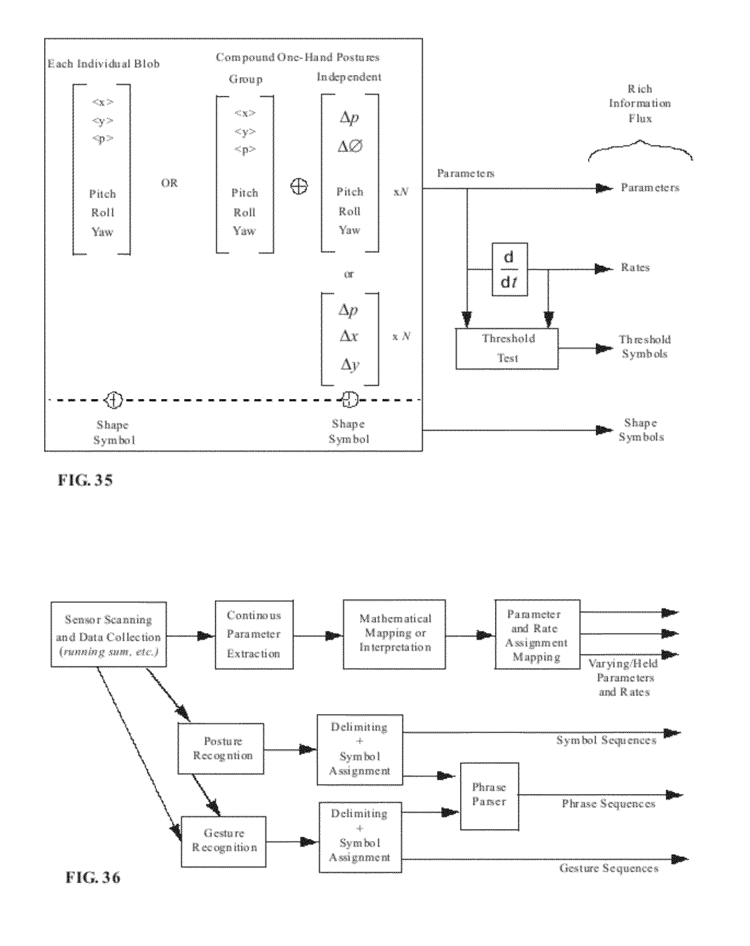

FIG. 35 (adapted from U.S. patent application Ser. No. 12/418,605 and described in U.S. Pat. No. 6,570,078) shows an example of how raw measurements of the six quantities of FIGS. 27a-27f, together with shape recognition for distinguishing contact with various parts of hand and touchpad, can be used to create a rich information flux of parameters, rates, and symbols.

FIG. 36 (adapted from U.S. patent application Ser. No. 12/418,605 and described in U.S. Pat. No. 6,570,078) shows an approach for incorporating posture recognition, gesture recognition, state machines, and parsers to create an even richer human/machine tactile interface system capable of incorporating syntax and grammars.

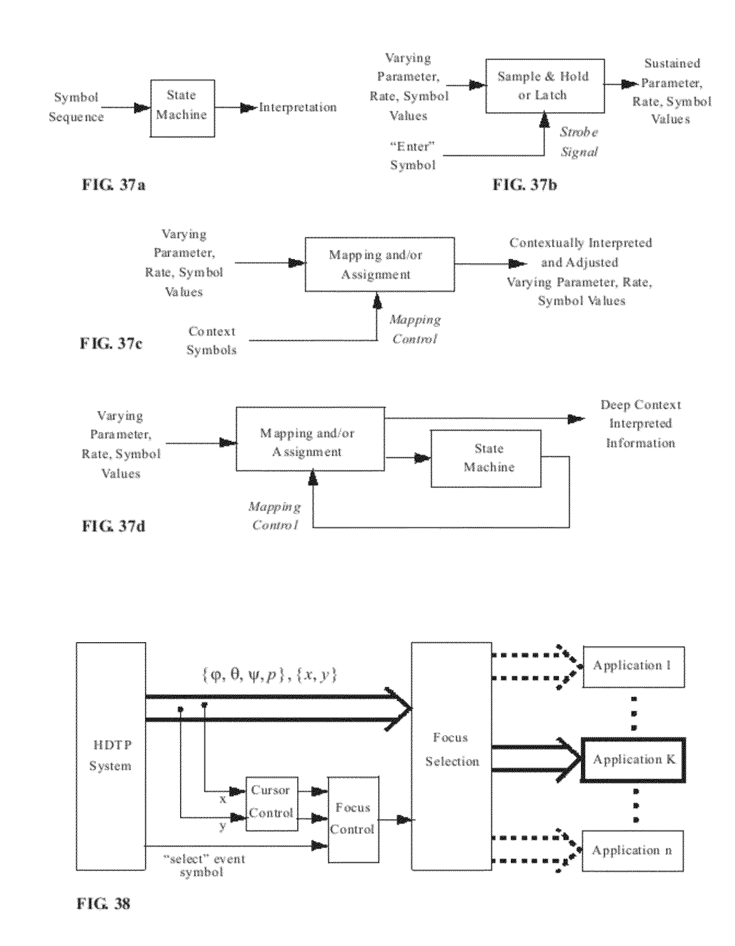

The HDTP affords and provides for yet further capabilities. For example, sequence of symbols can be directed to a state machine, as shown in FIG. 37a (adapted from U.S. patent application Ser. No. 12/418,605 and described in U.S. Pat. No. 6,570,078), to produce other symbols that serve as interpretations of one or more possible symbol sequences. In an embodiment, one or more symbols can be designated the meaning of an “Enter” key, permitting for sampling one or more varying parameter, rate, and symbol values and holding the value(s) until, for example, another “Enter” event, thus producing sustained values as illustrated in FIG. 37b (adapted from U.S. patent application Ser. No. 12/418,605 and described in U.S. Pat. No. 6,570,078). In an embodiment, one or more symbols can be designated as setting a context for interpretation or operation and thus control mapping or assignment operations on parameter, rate, and symbol values as shown in FIG. 37c (adapted from U.S. patent application Ser. No. 12/418,605 and described in U.S. Pat. No. 6,570,078). The operations associated with FIGS. 37a-37c can be combined to provide yet other capabilities. For example, the arrangement of FIG. 36d shows mapping or assignment operations that feed an interpretation state machine which in turn controls mapping or assignment operations. In implementations where context is involved, such as in arrangements such as those depicted in FIGS. 37b-37d, the invention provides for both context-oriented and context-free production of parameter, rate, and symbol values. The parallel production of context-oriented and context-free values can be useful to drive multiple applications simultaneously, for data recording, diagnostics, user feedback, and a wide range of other uses.

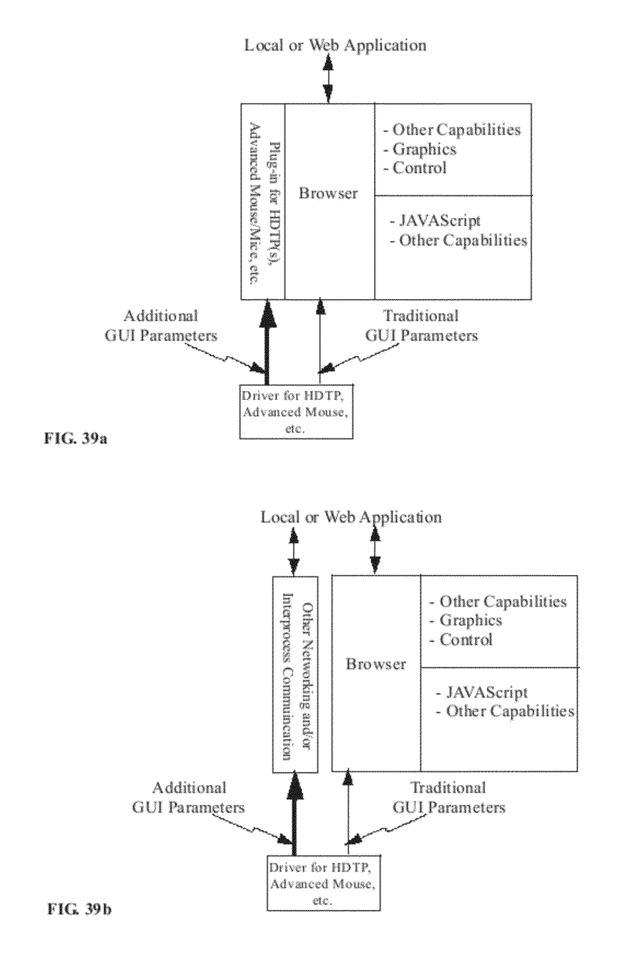

FIG. 38 (adapted from U.S. Pat. No. 169,414 and U.S. patent application Ser. Nos. 12/502,230 and 13/026,097) depicts a user arrangement incorporating one or more HDTP system(s) or subsystem(s) that provide(s) user interface input event and routing of HDTP produced parameter values, rate values, symbols, etc. to a variety of applications. In an embodiment, these parameter values, rate values, symbols, etc. can be produced for example by utilizing one or more of the individual systems, individual methods, and individual signals described above in conjunction with the discussion of FIGS. 35, 36, and 37a-37b. As discussed later, such an approach can be used with other rich multiparameter user interface devices in place of the HDTP. The arrangement of FIG. 37 is taught in U.S. Pat. No. 8,169,414 and pending U.S. patent application Ser. No. 12/502,230 “Control of Computer Window Systems, Computer Applications, and Web Applications via High Dimensional Touchpad User Interface” and FIG. 38 is adapted from FIG. 6e of U.S. Pat. No. 8,169,414 and pending U.S. patent application Ser. No. 12/502,230 for use here. Some aspects of this (in the sense of general workstation control) is anticipated in U.S. Pat. No. 6,570,078 and further aspects of this material are taught in pending U.S. patent application Ser. No. 13/026,097 “Window Manger Input Focus Control for High Dimensional Touchpad (HDTP), Advanced Mice, and Other Multidimensional User Interfaces.”

In an arrangement such as the one of FIG. 38, or in other implementations, at least two parameters are used for navigation of the cursor when the overall interactive user interface system is in a mode recognizing input from cursor control. These can be, for example, the left-right (“x”) parameter and forward/back (“y”) parameter provided by the touchpad. The arrangement of FIG. 38 includes an implementation of this.

Alternatively, these two cursor-control parameters can be provided by another user interface device, for example another touchpad or a separate or attached mouse.

In some situations, control of the cursor location can be implemented by more complex means. One example of this would be the control of location of a 3D cursor wherein a third parameter must be employed to specify the depth coordinate of the cursor location. For these situations, the arrangement of FIG. 38 would be modified to include a third parameter (for use in specifying this depth coordinate) in addition to the left-right (“x”) parameter and forward/back (“y”) parameter described earlier.

Focus control is used to interactively routing user interface signals among applications. In most current systems, there is at least some modality wherein the focus is determined by either the current cursor location or a previous cursor location when a selection event was made. In the user experience, this selection event typically involves the user interface providing an event symbol of some type (for example a mouse click, mouse double-click touchpad tap, touchpad double-tap, etc). The arrangement of FIG. 38 includes an implementation wherein a select event generated by the touchpad system is directed to the focus control element. The focus control element in this arrangement in turn controls a focus selection element that directs all or some of the broader information stream from the HDTP system to the currently selected application. (In FIG. 38, “Application K” has been selected as indicated by the thick-lined box and information-flow arrows.)

In some embodiments, each application that is a candidate for focus selection provides a window displayed at least in part on the screen, or provides a window that can be deiconified from an icon tray or retrieved from beneath other windows that can be obfuscating it. In some embodiments, if the background window is selected, focus selection element that directs all or some of the broader information stream from the HDTP system to the operating system, window system, and features of the background window. In some embodiments, the background window can be in fact regarded as merely one of the applications shown in the right portion of the arrangement of FIG. 38. In other embodiments, the background window can be in fact regarded as being separate from the applications shown in the right portion of the arrangement of FIG. 38. In this case the routing of the broader information stream from the HDTP system to the operating system, window system, and features of the background window is not explicitly shown in FIG. 38.

### Use of the Additional HDTP Parameters by Applications

The types of human-machine geometric interaction between the hand and the HDTP facilitate many useful applications within a visualization environment. A few of these include control of visualization observation viewpoint location, orientation of the visualization, and controlling fixed or selectable ensembles of one or more of viewing parameters, visualization rendering parameters, pre-visualization operations parameters, data selection parameters, simulation control parameters, etc. As one example, the 6D orientation of a finger can be naturally associated with visualization observation viewpoint location and orientation, location and orientation of the visualization graphics, etc. As another example, the 6D orientation of a finger can be naturally associated with a vector field orientation for introducing synthetic measurements in a numerical simulation.

As another example, at least some aspects of the 6D orientation of a finger can be naturally associated with the orientation of a robotically positioned sensor providing actual measurement data. As another example, the 6D orientation of a finger can be naturally associated with an object location and orientation in a numerical simulation. As another example, the large number of interactive parameters can be abstractly associated with viewing parameters, visualization rendering parameters, pre-visualization operations parameters, data selection parameters, numeric simulation control parameters, etc.

In yet another example, the x and y parameters provided by the HDTP can be used for focus selection and the remaining parameters can be used to control parameters within a selected GUI.

In still another example, x and y parameters provided by the HDTP can be regarded as a specifying a position within an underlying base plane and the roll and pitch angles can be regarded as a specifying a position within a superimposed parallel plane. In a first extension of the previous two-plane example, the yaw angle can be regarded as the rotational angle between the base and superimposed planes. In a second extension of the previous two-plane example, the finger pressure can be employed to determine the distance between the base and superimposed planes. In a variation of the previous two-plane example, the base and superimposed plane are not fixed parallel but rather intersect in an angle responsive to the finger yaw angle. In each example, either or both of the two planes can represent an index or indexed data, a position, a pair of parameters, etc. of a viewing aspect, visualization rendering aspect, pre-visualization operations, data selection, numeric simulation control, etc.

A large number of additional approaches are possible as is appreciated by one skilled in the art. These are provided for by the invention.

### Support for Additional Parameters Via Browser Plug-Ins

The additional interactively-controlled parameters provided by the HDTP provide more than the usual number supported by conventional browser systems and browser networking environments. This can be addressed in a number of ways. The following examples of HDTP arrangements for use with browsers and servers are taught in pending U.S. patent application Ser. No. 12/875,119 entitled “Data Visualization Environment with Dataflow Processing, Web, Collaboration, High-Dimensional User Interfaces, Spreadsheet Visualization, and Data Sonification Capabilities.”

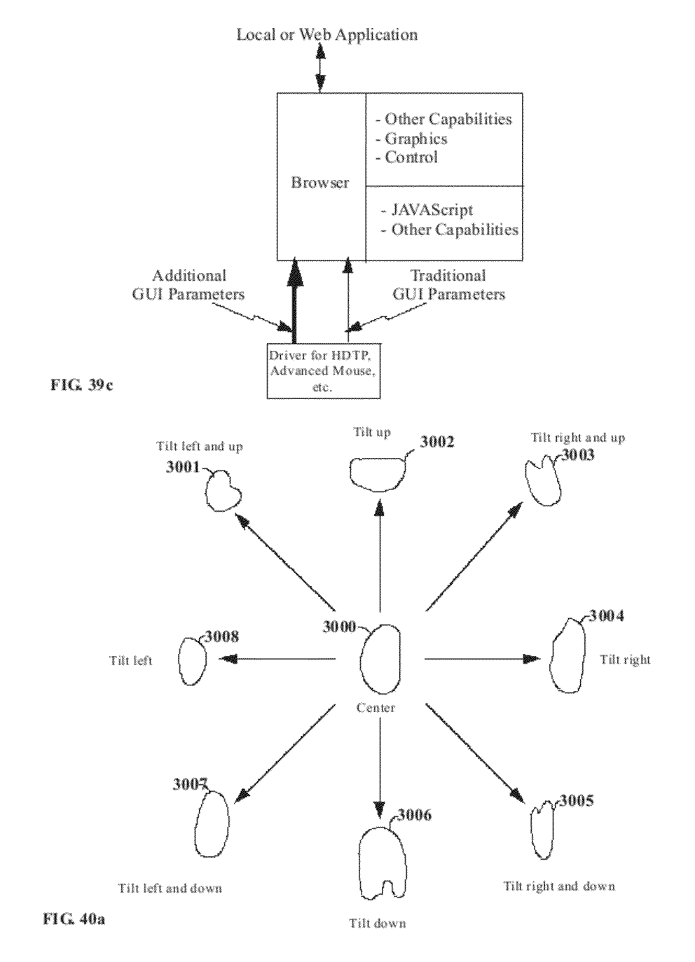

In a first approach, an HDTP interfaces with a browser both in a traditional way and additionally via a browser plug-in. Such an arrangement can be used to capture the additional user interface input parameters and pass these on to an application interfacing to the browser. An example of such an arrangement is depicted in FIG. 39a.

In a second approach, an HDTP interfaces with a browser in a traditional way and directs additional GUI parameters though other network channels. Such an arrangement can be used to capture the additional user interface input parameters and pass these on to an application interfacing to the browser. An example of such an arrangement is depicted in FIG. 39b.

In a third approach, an HDTP interfaces all parameters to the browser directly. Such an arrangement can be used to capture the additional user interface input parameters and pass these on to an application interfacing to the browser. An example of such an arrangement is depicted in FIG. 39c.

The browser can interface with local or web-based applications that drive the visualization and control the data source(s), process the data, etc. The browser can be provided with client-side software such as JAVA Script or other alternatives. The browser can provide also be configured advanced graphics to be rendered within the browser display environment, allowing the browser to be used as a viewer for data visualizations, advanced animations, etc., leveraging the additional multiple parameter capabilities of the HDTP. The browser can interface with local or web-based applications that drive the advanced graphics. In an embodiment, the browser can be provided with Simple Vector Graphics (“SVG”) utilities (natively or via an SVG plug-in) so as to render basic 2D vector and raster graphics. In another embodiment, the browser can be provided with a 3D graphics capability, for example via the Cortona 3D browser plug-in.

### Multiple Parameter Extensions to Traditional Hypermedia Objects

As taught in pending U.S. patent application Ser. No. 13/026,248 entitled “Enhanced Roll-Over, Button, Menu, Slider, and Hyperlink Environments for High Dimensional Touchpad (HTPD), other Advanced Touch User Interfaces, and Advanced Mice,” the HDTP can be used to provide extensions to the traditional and contemporary hyperlink, roll-over, button, menu, and slider functions found in web browsers and hypermedia documents leveraging additional user interface parameter signals provided by an HTPD. Such extensions can include, for example:
In the case of a hyperlink, button, slider and some menu features, directing additional user input into a hypermedia “hotspot” by clicking on it;
In the case of a roll-over and other menu features: directing additional user input into a hypermedia “hotspot” simply from cursor overlay or proximity (i.e., without clicking on it);
   The resulting extensions will be called “Multiparameter Hypermedia Objects” (“MHOs”).

Potential uses of the MHOs and more generally extensions provided for by the invention include:
Using the additional user input to facilitate a rapid and more detailed information gathering experience in a low-barrier sub-session;
Potentially capturing notes from the sub-session for future use;
Potentially allowing the sub-session to retain state (such as last image displayed);
Leaving the hypermedia “hotspot” without clicking out of it.

A number of user interface metaphors can be employed in the invention and its use, including one or more of:
Creating a pop-up visual or other visual change responsive to the rollover or hyperlink activation;
Rotating an object using rotation angle metaphors provided by the APD;
Rotating a user-experience observational viewpoint using rotation angle metaphors provided by the APD, for example, as described in U.S. Pat. No. 8,169,414 and pending U.S. patent application Ser. No. 12/502,230 “Control of Computer Window Systems, Computer Applications, and Web Applications via High Dimensional Touchpad User Interface” by Seung Lim;
Navigating at least one (1-dimensional) menu, (2-dimensional) pallet or hierarchical menu, or (3-dimensional) space.

These extensions, features, and other aspects of the present invention permit far faster browsing, shopping, information gleaning through the enhanced features of these extended functionality roll-over and hyperlink objects.

In addition to MHOs that are additional-parameter extensions of traditional hypermedia objects, new types of MHOs unlike traditional or contemporary hypermedia objects can be implemented leveraging the additional user interface parameter signals and user interface metaphors that can be associated with them. Illustrative examples include:
Visual joystick (can keep position after release, or return to central position after release);
Visual rocker-button (can keep position after release, or return to central position after release);
Visual rotating trackball, cube, or other object (can keep position after release, or return to central position after release);
A small miniature touchpad).

Yet other types of MHOs are possible and provided for by the invention. For example:
The background of the body page can be configured as an MHO;
The background of a frame or isolated section within a body page can be configured as an MHO;
An arbitrarily-shaped region, such as the boundary of an entity on a map, within a photograph, or within a graphic can be configured as an MHO.

In any of these, the invention provides for the MHO to be activated or selected by various means, for example by clicking or tapping when the cursor is displayed within the area, simply having the cursor displayed in the area (i.e., without clicking or tapping, as in rollover), etc. Further, it is anticipated that variations on any of these and as well as other new types of MHOs can similarly be crafted by those skilled in the art and these are provided for by the invention.

### User Training

Since there is a great deal of variation from person to person, it is useful to include a way to train the invention to the particulars of an individual's hand and hand motions. For example, in a computer-based application, a measurement training procedure will prompt a user to move their finger around within a number of different positions while it records the shapes, patterns, or data derived from it for later use specifically for that user.

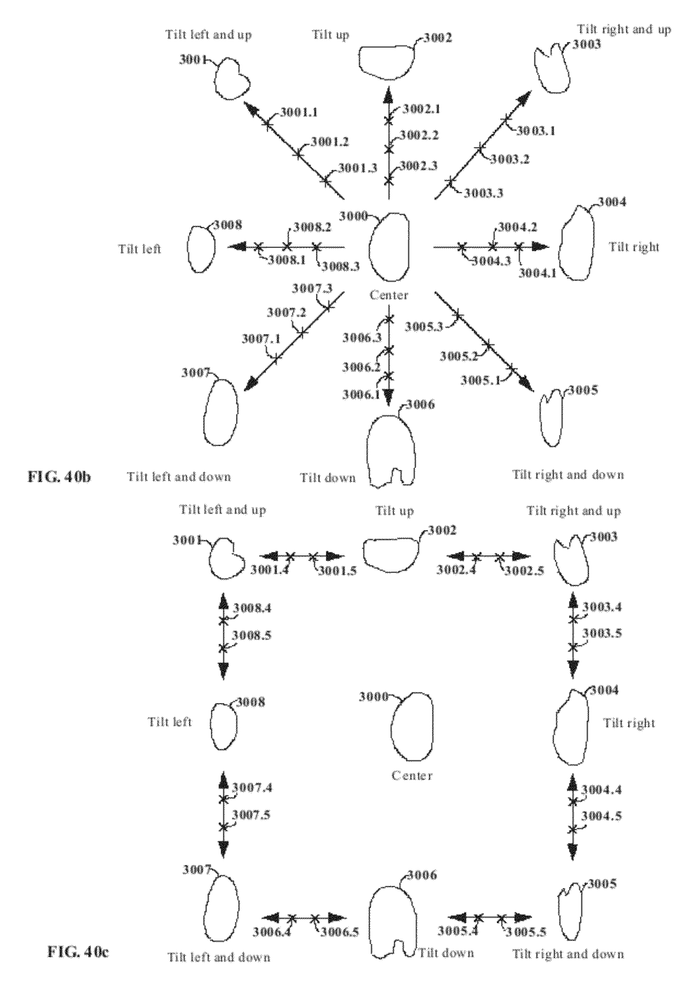

Typically most finger postures make a distinctive pattern. In one embodiment, a user-measurement training procedure could involve having the user prompted to touch the tactile sensor array in a number of different positions, for example as depicted in FIG. 40a (adapted from U.S. patent application Ser. No. 12/418,605). In some embodiments only representative extreme positions are recorded, such as the nine postures 3000-3008. In yet other embodiments, or cases wherein a particular user does not provide sufficient variation in image shape, additional postures can be included in the measurement training procedure, for example as depicted in FIG. 40b (adapted from U.S. patent application Ser. No. 12/418,605). In some embodiments, trajectories of hand motion as hand contact postures are changed can be recorded as part of the measurement training procedure, for example the eight radial trajectories as depicted in FIGS. 40a-40b, the boundary-tracing trajectories of FIG. 40c (adapted from U.S. patent application Ser. No. 12/418,605), as well as others that would be clear to one skilled in the art. All these are provided for by the invention.

The range in motion of the finger that can be measured by the sensor can subsequently be re-corded in at least two ways. It can either be done with a timer, where the computer will prompt user to move his finger from position 3000 to position 3001, and the tactile image imprinted by the finger will be recorded at points 3001.3, 3001.2 and 3001.1. Another way would be for the computer to query user to tilt their finger a portion of the way, for example “Tilt your finger ⅔ of the full range” and record that imprint. Other methods are clear to one skilled in the art and are provided for by the invention.

Additionally, this training procedure allows other types of shapes and hand postures to be trained into the system as well. This capability expands the range of contact possibilities and applications considerably. For example, people with physical handicaps can more readily adapt the system to their particular abilities and needs.

### Data Flow and Parameter Refinement

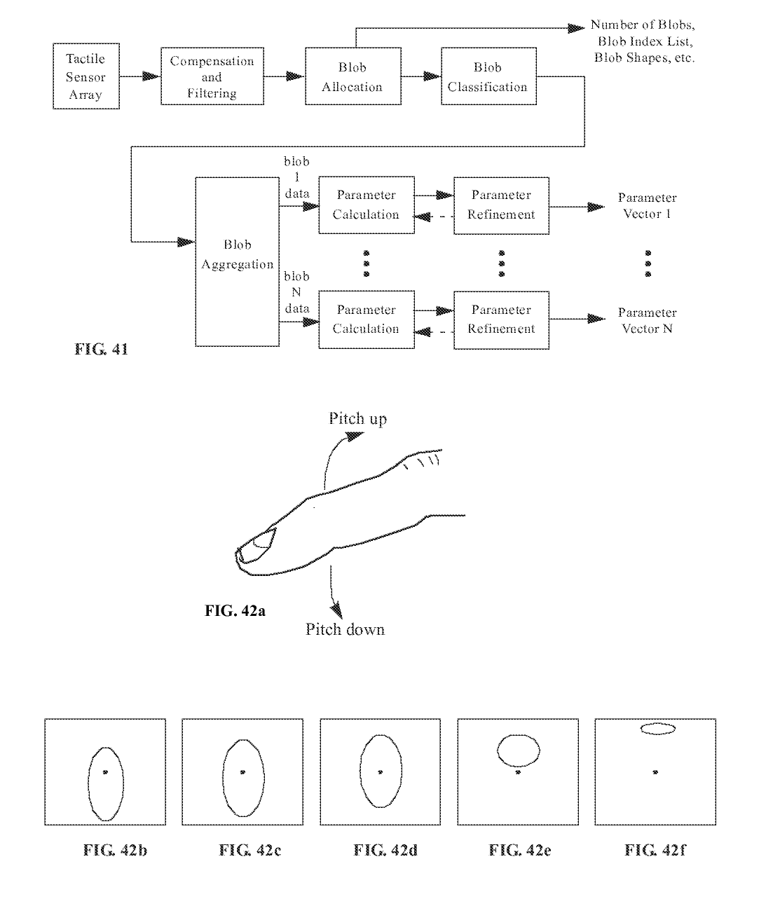

FIG. 41 depicts a HDTP signal flow chain for an HDTP realization that can be used, for example, to implement multi-touch, shape and constellation (compound shape) recognition, and other HDTP features. After processing steps that can for example, comprise one or more of blob allocation, blob classification, and blob aggregation (these not necessarily in the order and arrangement depicted in FIG. 41), the data record for each resulting blob is processed so as to calculate and refine various parameters (these not necessarily in the order and arrangement depicted in FIG. 41).

For example, a blob allocation step can assign a data record for each contiguous blob found in a scan or other processing of the pressure, proximity, or optical image data obtained in a scan, frame, or snapshot of pressure, proximity, or optical data measured by a pressure, proximity, or optical tactile sensor array or other form of sensor. This data can be previously preprocessed (for example, using one or more of compensation, filtering, thresholding, and other operations) as shown in the figure, or can be presented directly from the sensor array or other form of sensor. In some implementations, operations such as compensation, thresholding, and filtering can be implemented as part of such a blob allocation step. In some implementations, the blob allocation step provides one or more of a data record for each blob comprising a plurality of running sum quantities derived from blob measurements, the number of blobs, a list of blob indices, shape information about blobs, the list of sensor element addresses in the blob, actual measurement values for the relevant sensor elements, and other information. A blob classification step can include for example shape information and can also include information regarding individual noncontiguous blobs that can or should be merged (for example, blobs representing separate segments of a finger, blobs representing two or more fingers or parts of the hand that are in at least a particular instance are to be treated as a common blob or otherwise to be associated with one another, blobs representing separate portions of a hand, etc.). A blob aggregation step can include any resultant aggregation operations including, for example, the association or merging of blob records, associated calculations, etc. Ultimately a final collection of blob records are produced and applied to calculation and refinement steps used to produce user interface parameter vectors. The elements of such user interface parameter vectors can comprise values responsive to one or more of forward-back position, left-right position, downward pressure, roll angle, pitch angle, yaw angle, etc from the associated region of hand input and can also comprise other parameters including rates of change of there or other parameters, spread of fingers, pressure differences or proximity differences among fingers, etc. Additionally there can be interactions between refinement stages and calculation stages, reflecting, for example, the kinds of operations described earlier in conjunction with FIGS. 33, 34a, and 34b.

The resulting parameter vectors can be provided to applications, mappings to applications, window systems, operating systems, as well as to further HDTP processing. For example, the resulting parameter vectors can be further processed to obtain symbols, provide additional mappings, etc. In this arrangement, depending on the number of points of contact and how they are interpreted and grouped, one or more shapes and constellations can be identified, counted, and listed, and one or more associated parameter vectors can be produced. The parameter vectors can comprise, for example, one or more of forward-back, left-right, downward pressure, roll, pitch, and yaw associated with a point of contact. In the case of a constellation, for example, other types of data can be in the parameter vector, for example inter-fingertip separation differences, differential pressures, etc.

### Example Measurement Calculations and Calculation Chains

Attention is now directed to particulars of roll and pitch measurements of postures and gestures. FIG. 42a depicts a side view of an example finger and illustrating the variations in the pitch angle. FIGS. 42b-42f depict example tactile image measurements (proximity sensing, pressure sensing, contact sensing, etc.) as a finger in contact with the touch sensor array is positioned at various pitch angles with respect to the surface of the sensor. In these, the small black dot denotes the geometric center corresponding to the finger pitch angle associated with FIG. 42d. As the finger pitch angle is varied, it can be seen that:
the eccentricity of the oval shape changes and in the cases associated with FIGS. 42e-42f the eccentricity change is such that the orientation of major and minor axes of the oval exchange roles;
The position of the oval shape migrates and in the cases of FIGS. 42b-42c and FIGS. 42e-42f have a geometric center shifted from that of FIG. 42d, and in the cases of FIGS. 42e-42f the oval shape migrates enough to no longer even overlap the geometric center of FIG. 42d.

From the user experience viewpoint, however, the user would not feel that a change in the front-back component of the finger's contact with the touch sensor array has changed. This implies the front-back component (“y”) of the geometric center of contact shape as measured by the touch sensor array should be corrected responsive to the measured pitch angle. This suggests a final or near-final measured pitch angle value should be calculated first and used to correct the final value of the measured front-back component (“y”) of the geometric center of contact shape.

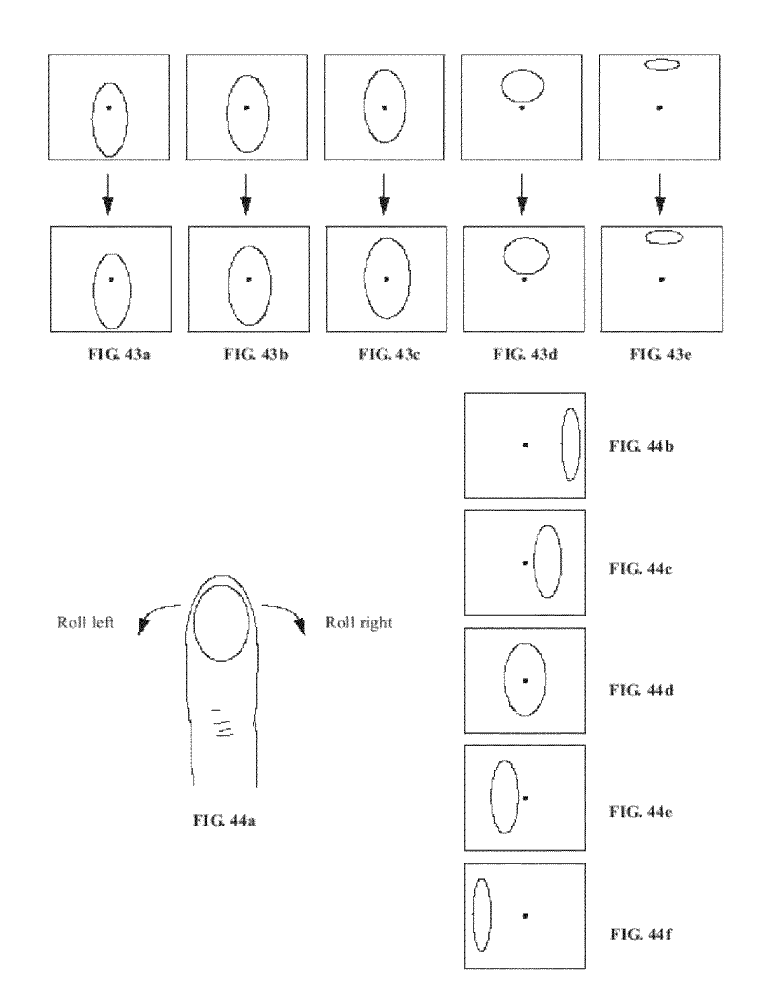

Additionally, FIGS. 43a-43e depict the effect of increased downward pressure on the respective contact shapes of FIGS. 42b-42f. More specifically, the top row of FIGS. 43a-43e are the respective contact shapes of FIGS. 42b-42f, and the bottom row show the effect of increased downward pressure. In each case the oval shape expands in area (via an observable expansion in at least one dimension of the oval) which could thus shift the final value of the measured front-back component (“y”). (It is noted that for the case of a pressure sensor array, the measured pressure values measured by most or all of the sensors in the contact area would also increase accordingly.)

These and previous considerations imply:
the pitch angle as measured by the touch sensor array could be corrected responsive to the measured downward pressure. This suggests a final or near-final measured downward pressure value should be calculated first and used to correct the final value of measured downward pressure (“p”);
the front-back component (“y”) of the geometric center of contact shape as measured by the touch sensor array could be corrected responsive to the measured downward pressure. This suggests a final or near-final measured pitch angle value could be calculated first and used to correct the final value of measured downward pressure (“p”).
   In one approach, correction to the pitch angle responsive to measured downward pressure value can be used to correct for the effect of downward pressure on the front-back component (“y”) of the geometric center of the contact shape.

FIG. 44a depicts a top view of an example finger and illustrating the variations in the roll angle. FIGS. 44b-44f depict example tactile image measurements (proximity sensing, pressure sensing, contact sensing, etc.) as a finger in contact with the touch sensor array is positioned at various roll angles with respect to the surface of the sensor. In these, the small black dot denotes the geometric center corresponding to the finger roll angle associated with FIG. 44d. As the finger roll angle is varied, it can be seen that:
The eccentricity of the oval shape changes;
The position of the oval shape migrates and in the cases of FIGS. 44b-44c and FIGS. 44e-44f have a geometric center shifted from that of FIG. 44d, and in the cases of FIGS. 44e-44f the oval shape migrates enough to no longer even overlap the geometric center of FIG. 44d.
   From the user experience, however, the user would not feel that the left-right component of the finger's contact with the touch sensor array has changed. This implies the left-right component (“x”) of the geometric center of contact shape as measured by the touch sensor array should be corrected responsive to the measured roll angle. This suggests a final or near-final measured roll angle value should be calculated first and used to correct the final value of the measured left-right component (“x”) of the geometric center of contact shape.

As with measurement of the finger pitch angle, increasing downward pressure applied by the finger can also invoke variations in contact shape involved in roll angle measurement, but typically these variations are minor and less significant for roll measurements than they are for pitch measurements. Accordingly, at least to a first level of approximation, effects of increasing the downward pressure can be neglected in calculation of roll angle.

Depending on the method used in calculating the pitch and roll angles, it is typically advantageous to first correct for yaw angle before calculating the pitch and roll angles. One source reason for this is that (dictated by hand and wrist physiology) from the user experience a finger at some non-zero yaw angle with respect to the natural rest-alignment of the finger would impart intended roll and pitch postures or gestures from the vantage point of the yawed finger position. Without a yaw-angle correction somewhere, the roll and pitch postures and movements of the finger would resolve into rotated components. As an extreme example of this, if the finger were yawed at a 90-degree angle with respect to a natural rest-alignment, roll postures and movements would measure as pitch postures and movements while pitch postures and movements would measure as roll postures and movements. As a second example of this, if the finger were yawed at a 45-degree angle, each roll and pitch posture and movement would case both roll and pitch measurement components. Additionally, some methods for calculating the pitch and roll angles (such as curve fitting and polynomial regression methods as taught in pending U.S. patent application Ser. No. 13/038,372) work better if the blob data on which they operate is not rotated by a yaw angle. This suggests that a final or near-final measured yaw angle value should be calculated first and used in a yaw-angle rotation correction to the blob data applied to calculation of roll and pitch angles.

Regarding other calculations, at least to a first level of approximation downward pressure measurement in principle should not be affected by yaw angle. Also at least to a first level of approximation, for geometric center calculations sufficiently corrected for roll and pitch effects in principle should not be affected by yaw angle. (In practice there can be at least minor effects, to be considered and addressed later).

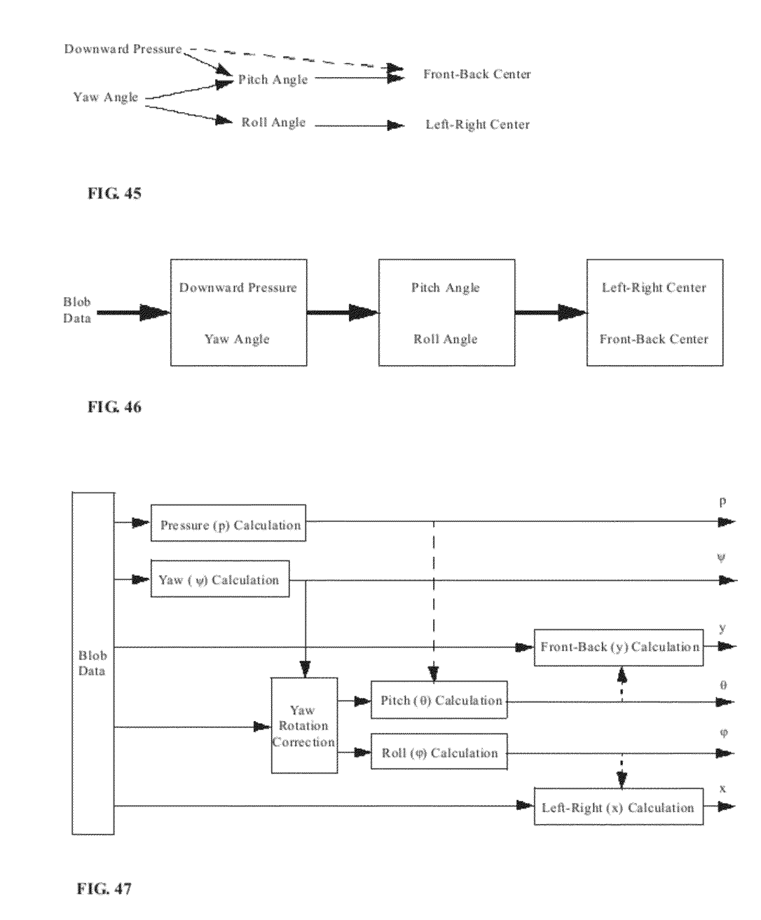

The example working first level of approximation conclusions together suggest a causal chain of calculation such as that depicted in FIG. 45. FIG. 46 depicts a utilization of this causal chain as a sequence flow of calculation blocks. FIG. 46 does not, however, represent a data flow since calculations in subsequent blocks depend on blob data in ways other than as calculated in preceding blocks. More specifically as to this, FIG. 47 depicts an example implementation of a real-time calculation chain for the left-right (“x”), front-back (“y”), downward pressure (“p”), roll (“φ”), pitch (“θ”), and yaw (“ψ”) measurements that can be calculated from blob data such as that produced in the example arrangement of FIG. 41. Examples of methods, systems, and approaches to downward pressure calculations from tactile image data in a multi-touch context are provided in pending U.S. patent application Ser. No. 12/418,605 and U.S. Pat. No. 6,570,078. Examples methods, systems, and approaches to yaw angle calculations from tactile image data are provided in pending U.S. Pat. No. 8,170,346; these can be applied to a multi-touch context via arrangements such as the depicted in FIG. 41. Examples methods, systems, and approaches to roll angle and pitch angle calculations from tactile image data in a multi-touch context are provided in pending U.S. patent application Ser. No. 12/418,605 and 13/038,372 as well as in U.S. Pat. No. 6,570,078 and include yaw correction considerations. Examples methods, systems, and approaches to front-back geometric center and left-right geometric center calculations from tactile image data in a multi-touch context are provided in pending U.S. patent application Ser. No. 12/418,605 and U.S. Pat. No. 6,570,078.

The yaw rotation correction operation depicted in FIG. 47 operates on blob data as a preprocessing step prior to calculations of roll angle and pitch angle calculations from blob data (and more generally from tactile image data). The yaw rotation correction operation can, for example, comprise a rotation matrix or related operation which internally comprises sine and cosine functions as is appreciated by one skilled in the art. Approximations of the full needed range of yaw angle values (for example from nearly −90 degrees through zero to nearly +90 degrees, or in a more restricted system from nearly −45 degrees through zero to nearly +45 degrees) can therefore not be realistically approximated by a linear function. The need range of yaw angles can be adequately approximated by piecewise-affine functions such as those to be described in the next section. In some implementations it will be advantageous to implement the rotation operation with sine and cosine functions in the instruction set or library of a computational processor. In other implementations it will be advantageous to implement the rotation operation with piecewise-affine functions (such as those to be described in the next section) on a computational processor.

FIG. 47 further depicts optional data flow support for correction of pitch angle measurement using downward pressure measurement (as discussed earlier). In one embodiment this correction is not done in the context of FIG. 47 and the dashed signal path is not implemented. In such circumstances either no such correction is provided, or the correction is provided in a later stage. If the correction is implemented, it can be implemented in various ways depending on approximations chosen and other considerations. The various ways include a linear function, a piecewise-linear function, an affine function, a piecewise-affine function, a nonlinear function, or combinations of two or more of these. Linear, piecewise-linear, affine, and piecewise-affine functions will be considered in the next section.

FIG. 47 further depicts optional data flow support for correction of front-back geometric center measurement using pitch angle measurement (as discussed earlier). In one embodiment this correction is not done in the context of FIG. 47 and the dashed signal path is not implemented. In such circumstances either no such correction is provided, or the correction is provided in a later stage. If the correction is implemented, it can be implemented in various ways depending on approximations chosen and other considerations. The various ways include a linear function, a piecewise-linear function, an affine function, a piecewise-affine function, a nonlinear function, or combinations of two or more of these.

FIG. 47 further depicts optional data flow support for correction of left-right geometric center measurement using roll angle measurement (as discussed earlier). In one embodiment this correction is not done in the context of FIG. 47 and the dashed signal path is not implemented. In such circumstances either no such correction is provided, or the correction is provided in a later stage. If the correction is implemented, it can be implemented in various ways depending on approximations chosen and other considerations. The various ways include a linear function, a piecewise-linear function, an affine function, a piecewise-affine function, a nonlinear function, or combinations of two or more of these.

FIG. 47 does not depict optional data flow support for correction of front-back geometric center measurement using downward pressure measurement (as discussed earlier). In one embodiment this correction is not done in the context of FIG. 47 and either no such correction is provided, or the correction is provided in a later stage. In another embodiment this correction is implemented in the example arrangement of FIG. 47, for example through the addition of downward pressure measurement data flow support to the front-back geometric center calculation and additional calculations performed therein. In either case, if the correction is implemented, it can be implemented in various ways depending on approximations chosen and other considerations. The various ways include a linear function, a piecewise-linear function, an affine function, a piecewise-affine function, a nonlinear function, or combinations of two or more of these.

Additionally, FIG. 47 does not depict optional data flow support for the tilt refinements described in conjunction with FIG. 34a, the tilt-influent correction to measured yaw angle described in conjunction with FIG. 34b, the range-of-rotation correction described in conjunction with FIG. 33, the correction of left-right geometric center measurement using downward pressure measurement (as discussed just a bit earlier), the correction of roll angle using downward pressure measurement (as discussed just a bit earlier), or the direct correction of front-back geometric center measurement using downward pressure measurement. There are many further possible corrections and user experience improvements that can be added in similar fashion. In one embodiment any one or more such additional corrections are not performed in the context of FIG. 47 and either no such correction is provided, or such corrections are provided in a later stage after an arrangement such as that depicted in FIG. 47. In another embodiment one or more such corrections are implemented in the example arrangement of FIG. 47, for example through the addition of relevant data flow support to the relevant calculation step and additional calculations performed therein. In either case, any one or more such corrections can be implemented in various ways depending on approximations chosen and other considerations. The various ways include use of a linear function, a piecewise-linear function, an affine function, a piecewise-affine function, a nonlinear function, or combinations of two or more of these.

In one approach, one or more shared environments for linear function, a piecewise-linear function, an affine function, a piecewise-affine function, or combinations of two or more of these can be provided. In an embodiment of such an approach, one or more of these one or more shared environments can be incorporated into the calculation chain depicted in FIG. 47.

In another or related embodiment of such an approach, one or more of these one or more shared environments can be implemented in a processing stage subsequent to the calculation chain depicted in FIG. 47. In these circumstances, the output values from the calculation chain depicted in FIG. 47 can be regarded as “first-order” or “unrefined” output values which, upon further processing by these one or more shared environments produce “second-order” or refined” output values.

In the arrangements described above for implementing piecewise-linear and piecewise-affine transformations, entire matrices or vectors can be retrieved from look-up tables (selected according to the result of conditional tests) or calculated from the result of conditional tests. Alternatively parts of these matrices or vectors can be retrieved from look-up tables (selected according to the result of conditional tests) or calculated from the result of conditional tests. The parts can comprise sub-matrix blocks, sub-vector blocks, and individual components in piecewise-affine matrices and vectors. For example, separate components of linear or affine transformations can be stored in and retrieved from a look-up table comprising a plurality of separate component linear transformations.

### Sequential Selective Tracking of Parameter Subsets

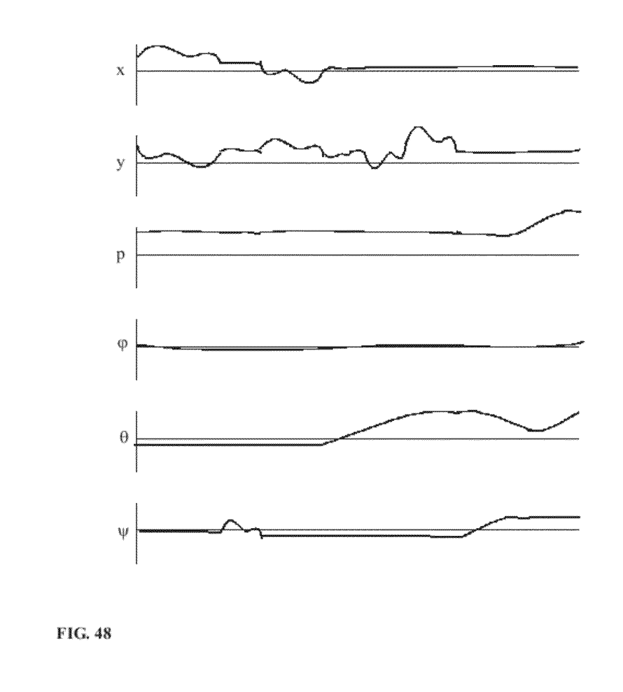

Further as to recognizing symbols and variations of parameters, the HDTP (as well as related tactile user interface systems) can be further structured to suppress the effects of unintended movement, for example as taught in pending U.S. patent application Ser. No. 13/180,512 “Sequential Selective Tracking of Parameter Subsets for High Dimensional Touchpad (HDTP).” For example, FIG. 48 depicts example time-varying values of a parameters vector comprising left-right geometric center (“x”), forward-back geometric center (“y”), average downward pressure (“p”), clockwise-counterclockwise pivoting yaw angular rotation (“ψ”), tilting roll angular rotation (“φ”), and tilting pitch angular rotation (“θ”) parameters calculated in real time from sensor measurement data. These parameters can be aggregated together to form a time-varying parameter vector.

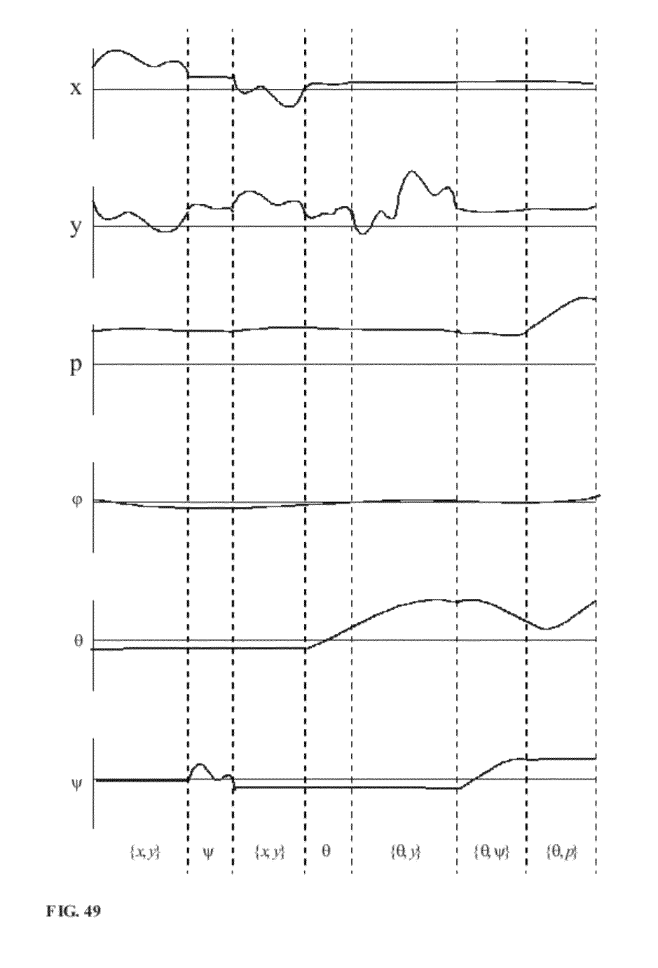

FIG. 49 depicts an example sequential classification of the parameter variations within the time-varying parameter vector according to an estimate of user intent, segmented decomposition, etc. Each such classification would deem a subset of parameters in the time-varying parameter vector as effectively unchanging while other parameters are deemed as changing. Such an approach can provide a number of advantages including:
Suppression of minor unintended variations in parameters the user does not intend to adjust within a particular interval of time;
Suppression of minor unintended variations in parameters the user effectively does not adjust within a particular interval of time;
Utilization of minor unintended variations in some parameters within a particular interval of time to aid in the refinement of parameters that are being adjusted within that interval of time;
Reduction of real-time computational load in real-time processing.

### USB HID Hardware Interface and Device Abstraction

The USB HID device class provides an open interface useful for both traditional computer pointing devices such as the standard computer mouse as well as other user interface devices such as game controllers and the Logitech 3DConnexion SpaceNavigator™. As taught in pending U.S. patent application Ser. No. 13/356,578 “USB HID Device Abstraction for HDTP User Interfaces” a HDTP can be adapted or structured to interface one or more applications executing on a computer or other device through use of the USB HID device class.

In a first example embodiment, a USB HID device abstraction is employed to connect a computer or other device with an HDTP sensor that is connected to the computer via a USB interface. Here the example HDTP signal processing and HDTP gesture processing are implemented on the computer or other device. The HDTP signal processing and HDTP gesture processing implementation can be realized via one or more of CPU software, GPU software, embedded processor software or firmware, and/or a dedicated integrated circuit.

In another example embodiment, a USB HID device abstraction is employed to connect a computer or other device with an HDTP sensor and one or more associated processor(s) which in turn is/are connected to the computer via a USB interface. Here the example HDTP signal processing and HDTP gesture detection are implemented on the one or more processor(s) associated with HDTP sensor. The HDTP signal processing and HDTP gesture processing implementation can be realized via one or more of CPU software, GPU software, embedded processor software or firmware, and/or a dedicated integrated circuit.

In another example embodiment, a USB HID device abstraction is used as a software interface even though no USB port is actually used. The HDTP signal processing and HDTP gesture processing implementation can be realized via one or more of CPU software, GPU software, embedded processor software or firmware, and/or a dedicated integrated circuit.

Yet other approaches are possible and provided for by the invention as taught in U.S. patent application Ser. No. 13/356,578.

### Tactile User Interface Gesture and Symbol Frameworks

Referring to previously considered FIG. 35, the HDTP (as well as related tactile user interface systems) can be structured to produce in real-time at least parameters and symbols for each area of touch or recognized aggregate constellations of areas of touch (as in the multitouch examples discussed in conjunction with previously considered FIG. 29 and FIG. 31, for example processed with arrangements such as the examples shown in previously considered FIGS. 22a and 22b). Further as shown and discussed in the context of FIG. 25, the symbols can include threshold symbols obtained by applying conditional tests to various combinations of parameters and their rates of change. As shown in previously considered FIG. 36, the HDTP (as well as related tactile user interface systems) can be structured to produce sequences of symbols and can provide varying or held (sustained) values of parameters and rates. Previously considered FIG. 37b shows an example of how varying parameter values can be “held” (“sustained”) employing “Sample & Hold” or latch functions. Further, as shown in previously considered FIG. 36, the HDTP (as well as related tactile user interface systems) can be structured so that sequences of symbols can be used to construct phrases and more complex gestures. Previously considered FIGS. 37a, 37c, and 37d show examples of how sequences of symbols or phrases can be interpreted in absolute terms or in context.

It is noted that these general frameworks need not include all of the roll, pitch, yaw and complex multitouch measurements provided by an HDTP, and can be applied to outputs from simpler touch and multi-touch user interfaces.

### Example Symbol Generation

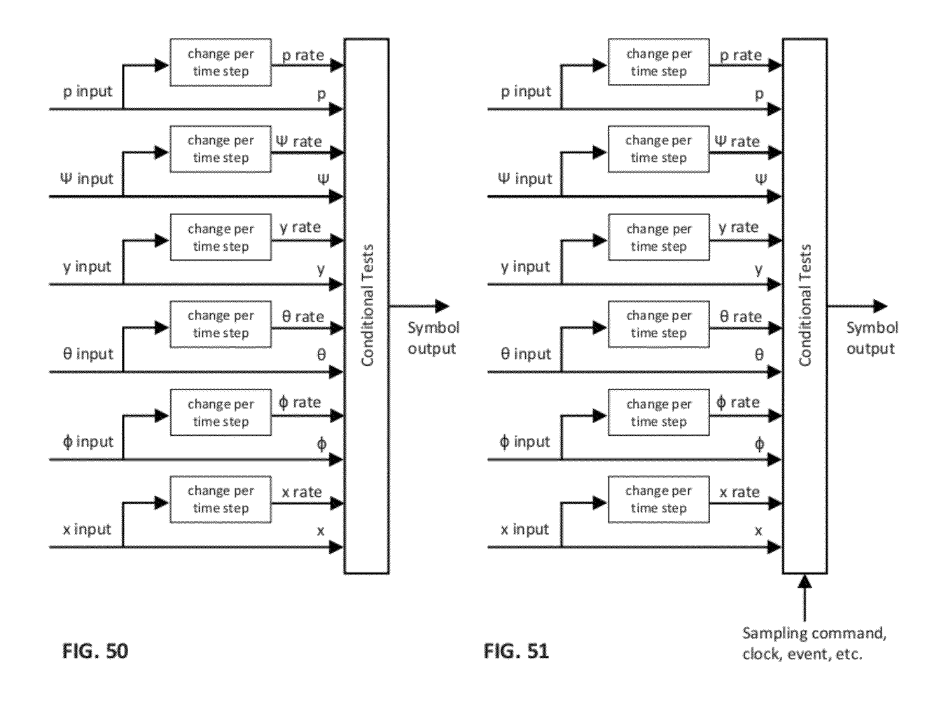

FIG. 50 depicts an example symbol generation arrangement for generating a sequence of symbols from (corrected, refined, raw, adapted, renormalized, etc.) real-time measured parameters values provided by other portions of an HDTP. Such an implementation is in accordance with the general example arrangement considered earlier in conjunction with FIG. 35.

Referring to FIG. 50, one or more (here all are shown) of (corrected, refined, raw, adapted, renormalized, etc.) real-time measured values of HDTP output parameters associated with a blob or constellation of blobs (here these are represented by the set of parameters {x, y, p, φ, θ, ψ} although a greater or lesser number and/or alternate collection of parameters can be used) are differenced, numerically differentiated, etc. with respect to earlier values so as to determine the rate of change (shown here per time step although this could be per unit time, a specified number of time steps, etc.). Both the real-time measured values of HDTP output parameters and one or more rate of change outputs are provided to a plurality of conditional tests. In one implementation or mode of operation, none of these conditions from the plurality of conditional tests overlap. In other implementations or modes of operation, at least two of the conditions from the plurality of conditional tests overlap.

Additionally, the invention provides for conditions that are equivalent to the union, intersection, negation, or more complex logical operations on simpler conditional tests. For example, a conditional test comprising an absolute value of a variable can be implemented as a logical operation of simpler conditional test. Note this is equivalent to allowing a symbol to be associated with the outcome of a plurality of tests, also provided for by the invention in more general terms.

In the example implementation depicted in FIG. 50, each time a condition is met a symbol corresponding to that condition is generated as an output. Note that in principle more than one symbol can be generated at a time.

In some implementations (for example, if none of the conditions overlap) at most one symbol can be generated at any given moment. The symbol can be represented by a parallel or serial digital signal, a parallel or serial analog signal, a number, an ASCII character, a combination of these, or other representation. In some implementations the symbol is generated when the condition is first met. In other implementations, the symbol is maintained as a state throughout the time that the condition is met. Note that it is possible in some implementations for no symbol to be generated (for example in some implementations if no conditions have been met, or in some implementations if conditional test outcomes have not changed since an earlier symbol was generated, etc.).

In other implementations, a symbol can be generated only under the control of a clock or sampling command, clock signal, event signal, or other symbol generation command. FIG. 51 depicts a modification of the example arrangement of FIG. 50 wherein symbol can be generated only under the control of a clock or sampling command, clock signal, event signal, or other symbol generation command.

In some implementations or modes of operation, some symbols are generated by the approach depicted in FIG. 50 while other symbols are generated by the approach depicted in FIG. 51.

It is anticipated that other arrangements for generation of symbols from (corrected, refined, raw, adapted, renormalized, etc.) real-time measured parameters values provided by other portions of an HDTP, and these are provided for by the invention.

The aforedescribed approach will also work with other types of tactile user interface systems. This is anticipated and provided for by the invention.

Additionally, aforedescribed approach will also work with other types of high parameter count user interface systems, for example video interfaces, the aforedescribed advanced mice, etc. This is anticipated and provided for by the invention.

As an example, assume a particular parameter or rate value, denoted here as “q” is tested (as part of a more complex conditional tests, as stand alone conditional tests, etc.) is tested for three conditions:

q<Qₐ CASE 1

Qₐ<q<Q_{b} CASE 2

q>Q_{b} CASE 3

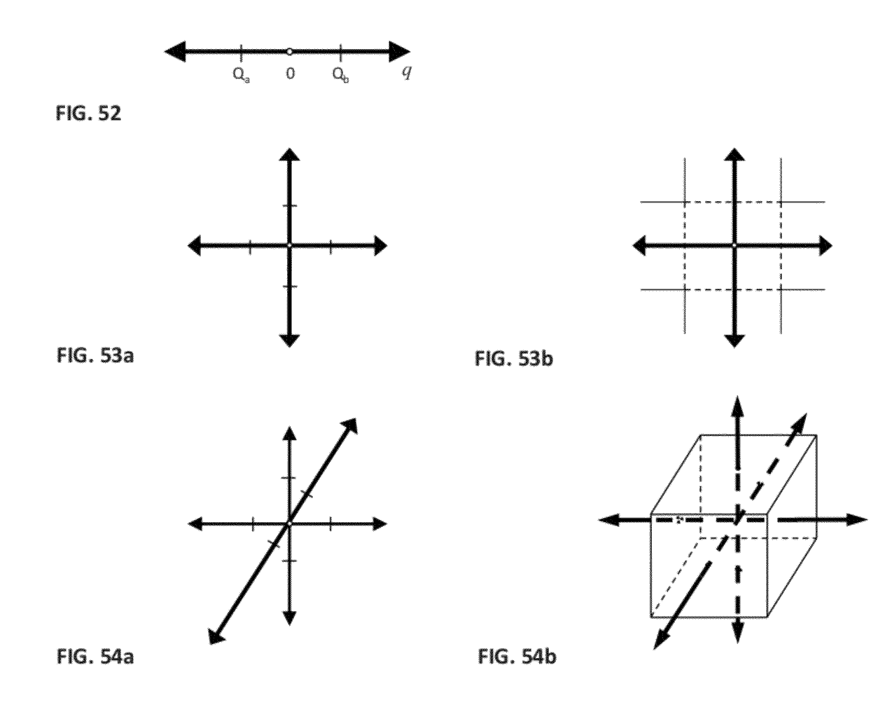

FIG. 52 depicts such a conditional test for a single parameter or rate value q in terms of a mathematical graph, separating the full range of q into three distinct regions. The region divisions are denoted by the short dashed lines. For the sake of illustration Qₐ could be a negative value and Q_{b} could be a positive value, although this does not need to be the case.

Next, consider example sets of conditional test for two values, either one of which can be a parameter value or rate value. As a simple example, each of the two values can be tested for three conditions in a similar fashion as for the single value example considered above. FIG. 53a depicts such a conditional test for a two values (parameter and/or rate) in terms of a mathematical graph, separating the full range of each of the two values into three regions. The region divisions each of the two values are denoted by the short dashed lines, for the sake of illustration one in a negative range for the value and the other in a positive value, although this does not need to be the case. By extending the short dashed lines to longer lengths as shown in FIG. 53b, it can be seen that the region (here a portion of a plane) defined by the full range of the two values is divided into 3×3=9 distinct regions.

Similarly, consider example sets of conditional test for three values, any one of which can be a parameter value or rate value. As a simple example, each of the three values can be tested for three conditions in a similar fashion as for the examples considered above. FIG. 54a depicts such a conditional test for a two values (parameter and/or rate) in terms of a mathematical graph, separating the full range of each of the three values into three regions. The region divisions each of the three values are denoted by the short dashed lines, for the sake of illustration one in a negative range for the value and the other in a positive value, although this does not need to be the case. By extending the short dashed lines to longer lengths as shown in FIG. 54b, it can be seen that the region (here a portion of 3-space) defined by the full range of the three values is divided into 3×3×3=27 distinct regions.

In a similar way, if there are N variables, each of which are tested for lying within M distinct ranges, the number of distinct regions is given by M^{N}. Thus for six parameters (N=6), such as for example the six {x, y, p, φ, θ, ψ}, each of which are tested for lying within distinct ranges (M=3) such as “mid range” and two opposite “far extremes,” the number of distinct regions is given by 3⁶=729.

In principle, each the six rate values could be split into three ranges as well. A practical distinction among rates from a user's viewpoint might be separate recognition of a “zero or slow” and “anything fast” rate (M=2). Such a conditional test could utilize an absolute value function in the conditional test. Note that a two-value test on an absolute value is equivalent to a three range test wherein the two extreme ranges produce the same outcome. Note the number of distinct regions for the set of six rate values (N=6), each separately tested for occupancy in two ranges (“zero or slow” and “anything fast,” so M=2) is 2⁶=64.

For an example implementation combining these two aforedescribed examples, the total number of distinction recognizable regions is 729×64=46,656. In principal a distinct symbol could be assigned to each of these regions, noting that each region is equivalent to a 12-variable conditional test outcome. This provides a very rich environment from which to draw metaphors, omit conditions/regions that are not useful or applicable, impose contextual interpretations, etc.

It is to be understood that the above is merely a chain of examples and not to be in any way considered limiting.

### Tactile User Interface Lexicon and Grammar Frameworks

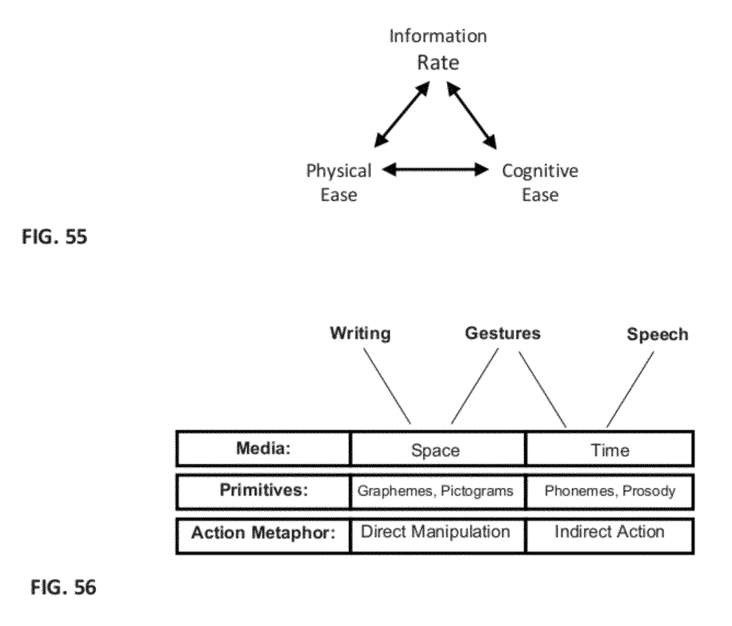

Ultimately the goal of command user interface arrangement is to balance the tensions among maximizing the information rate of communication from the human to the machine, maximizing the cognitive ease in using the user interface arrangement, and maximizing the physical ease using the user interface arrangement. These three goals are not always in strict opposition but typically involve some differences hence resulting in tradeoffs as suggested in FIG. 55.

Gesture Structure, Constituents, Execution, and Machine Acquisition

A tactile gesture is a bit like traditional writing in some ways and differs from writing in other ways. Like traditional writing a tactile gesture involves actions of user-initiated contact with a surface and is rendered over a (potentially reusable) region of physical surface area. The term “execution” will be used to denote the rendering of a tactile gesture by a user via touch actions made on a touch interface surface.

In various implementations the execution of a tactile gesture by a user may (like traditional writing) or may not (unlike writing) be echoed by visible indication (for example a direct mark on the screen). In various implementations the symbol execution of a tactile gesture by a user may comprise spatially isolated areas of execution (in analogy with the drawing of block letters in traditional writing) or may comprise spatially isolated areas of symbol execution (in analogy with the drawing of sequences of cursive or other curve-connected/line-connected letters in traditional writing).

However, unlike traditional writing, a tactile gesture can include provisions to capture temporal aspects of its execution (for example the speed in which it is enacted, the order in which touch motions comprising the gesture are made, etc.). Also unlike traditional writing, the result of a tactile gesture can include a visually-apparent indirect action displayed on a screen responsive to a meaning or metaphor associated with the tactile gesture. In a way, these aspects are a bit like speech or a speech interface to a computer—time is used rather than space for the rendering/execution, and the (visual) response (of a machine) can be one of an associated meaning.

FIG. 56 illustrates these example relationships of traditional writing, gesture, and speech with time, space, direct marks, and indirect action. Of course it is likely possible to construct or envision possible speech and writing systems that defy, extend, or transcend the relationships depicted in FIG. 55, but for the moment with no ill-will or limited-thinking intended these will, at least for now, be regarded as fringe cases with respect to the gesture lexicon and graphics framework presented herein.

### Phoneme, Grapheme, “Gesteme”

Like traditional writing and speech, tactile gestures can be comprised of one or more constituent “atomic” elements. In the formal linguistics of speech, these constituent “atomic” elements are known as phonemes. In the formal linguistics of traditional writing, the constituent “atomic” elements are termed graphemes (see for example http://en.wikipedia.org/wiki/Grapheme).

Accordingly, in this construction the one or more constituent “atomic” elements of gestures will be called “gestemes;” examples include isolated stroke lines, isolated curves, etc. For example, a gesture that is spatially rendered by tracing out an “X” or “+” on a touch surface would (at least most naturally) comprise an action comprising two stroke lines. Gesteme-based gesture structuring, recognition, processing are further treated in co-pending U.S. Patent Application 61/567,626.

In traditional (at least Western) writing, the order in which such strokes are rendered by the user, the time it takes to render each stroke (“gesteme”), and the time between making the two strokes, and anything else that is done in a different spatial area (such as drawing another letter) between making the two strokes are all immaterial as the information is conveyed by the completed “X” or “+” marking left behind after the execution. The HDTP approach to touch-based user interfaces, however, allows for use of:
the time it takes to render each gesteme;
the time between rendering a pair of gestemes;
anything else that is done in a different spatial area (such as the drawing of another symbol) between rendering a pair of gestemes.

Pending U.S. patent application Ser. No. 13/414,705 “General User Interface Gesture Lexicon and Grammar Frameworks for Multi-Touch, High Dimensional Touch Pad (HDTP), Free-Space Camera, and Other User Interfaces” provides an example collection of primitive handwriting segment shapes (adapted from [3]) that could be used as components for representation of cursive-style handwritten English-alphabet letters and illustrates an example set of eighteen primitive handwriting “graphemes” (also adapted from [3]) created from various translations and mirror-symmetry transformations of the example set of four primitive handwriting segment shapes. These are used to create an example decomposition of cursive-style handwritten English-alphabet letters in terms of the example set of eighteen primitive handwriting “graphemes” (further adapted from [3]).

In that example, the simultaneous presence of specific combinations of the eighteen primitive handwriting “graphemes” signifies a specific cursive-style handwritten English-alphabet letter.

Also as taught in pending U.S. patent application Ser. No. 13/414,705, the HDTP (as well as related tactile user interface systems) can be structured to support rich and complex tactile grammars which include a wide range of grammatical linkages and operations and can also recognize variations in gesture prosody.

Gesture Composition from Gestemes

In the construction of the formalism, a gesture may be equated to the role of a word or word group or compound work acting as a word. This approach will be used for the moment, but with the incorporation of additional aspects of gesture rendering the linguistic domain and linguistic function of a gesture can be expanded to include entire multi-element noun phases, verb phrases, etc. (as will be considered in later sections of this document pertaining to grammar).

The HDTP approach to touch-based user interfaces also allows for a single gestemes to be used as a gesture. However, the HDTP approach to touch-based user interfaces more commonly allows for the concatenation of two or more gestemes to be sequentially rendered (within the delimiters of a gesture) to form a gesture.

In some cases, gestemes may be defined in such a way that natural joining is readily possible for all, most, or some combinations of consecutive pairs of gestemes. In some cases, some form of shortening or bridging may be used to introduce economy or provide feasibility in the joining pairs of consecutive gestemes.

Gesteme Sequencing within the Rendering of a Gesture

The HDTP approach to touch-based user interfaces also allows for there to be additional content to be imposed into/onto the individual gestemes used to render even such simple “X” or “+” gestures. For example:
The order in which the user renders the two strokes can be ignored, or could instead be used to convey meaning, function, association, etc.;
The absolute or relative time the user takes to render each stroke can be ignored, or could instead be used to convey a quantity, meaning, function, association, etc.;
The absolute or relative time the user takes between the rendering of each stroke can be ignored, or could instead be used to convey a quantity, meaning, function, association, etc.
An action (for example, a tactile action) taken by the user between the rendering of each stroke can be ignored, or could instead be used to convey a quantity, meaning, function, association, etc.

The temporal aspects involved in each of the above examples brings in the need for an adapted temporal logic aspect to formalisms for tactile user interface lexicon and grammar frameworks should these temporal aspects be incorporated. Depending upon the usage, the temporal logic aspect framework would be used to either distinguish or neglect the rendering order of individual gestemes comprising a gesture.

### Delimiters for Individual Gestures

In the rendering of speech, delimiting between individual words is performed through use of one or more of the following:
Prosody:
   Temporal pause;
   Changes in rhythm;
   Changes in stress;
   Changes in intonation.
Lexigraphics (an individual word is unambiguously recognized, and the recognition event invokes a delineating demarcation between the recognized word and the next word to follow).

In the rendering of traditional writing, delimiting between individual words is performed via gaps (blank spaces roughly the space of a character). The HDTP approach to touch-based user interfaces provides for delimiting between individual temporal tactile gestures via at least these mechanisms:
Time separation between individual tactile gestures;
Distance separation between individual tactile gestures;
For joined strings of individual tactile gestures:
   Temporal pause separation;
   Logographically separation;
   Lexigraphically separation (an individual tactile gesture is unambiguously recognized, and the recognition event invokes a delineating demarcation between the recognized tactile gesture and the next tactile gesture to follow);
Special ending or starting attribute to gestures;
Special delimiting or entry-action gesture(s)—for example lift-off, tap with another finger, etc.

“Intra-Gesture Prosody”

“Intra-Gesture Prosody” within Individual Gestures

Additionally, because of the temporal aspects of gestures and the gestemes they comprise, aspects of gesture rendering over time can be modulated as they often are in speech, and thus gestures also admit a chance for formal linguistic “prosody” to be imposed on gestures for conveyance of additional levels of meaning or representations of a parameter value. Intra-gesture and Inter-gesture prosody are further treated in co-pending U.S. Patent Application 61/567,626.

The HDTP approach to touch-based user interfaces allows for there to be yet other additional content to be imposed in such simple “X” or “+” gestures. For example:
At least one contact angle (yaw, roll, pitch) of the finger(s) used to render each of the strokes of the “X” or “+” gesture;
How many fingers used to render each of the strokes of the “X” or “+” gesture;
Embellishment in individual component element rendering (angle of rendering, initiating curve, terminating curve, intra-rendering curve, rates of rendering aspects, etc.);
Variations in the relative location of individual component element rendering;
What part(s) of the finger or hand used to render each of the strokes of the “X” or “+” gesture;
Changes in one or more of the above over time.

A ‘natural’ potential name for at least some of these could be “intra-gestural prosody.”

Gesture Compositions and Deconstructions with Respect to Primitive Elements in Measured Signal Space

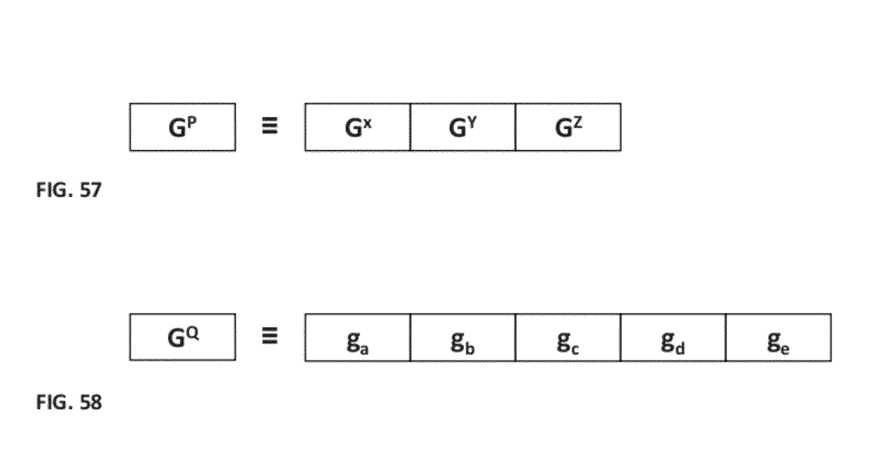

Among the gesture linguistic concepts taught U.S. patent application Ser. No. 12/418,605 is that a sequence of symbols can be directed to a state machine to produce other symbols that serve as interpretations of one or more possible symbol sequences. This provides one embodiment of an approach wherein (higher-level) gestures are constructed from primitive elements, in this case, other (lower-level) gestures. In such an arrangement, a predefined gesture can comprise a specific sequence of plurality of other gestures. For example FIG. 57 depicts an example representation of a predefined gesture comprised by a specific sequence of three other gestures. Similarly, a predefined gesture comprised by a specific sequence of two other gestures, or a predefined gesture comprised by a specific sequence of four or more other gestures.

In an embodiment, a specific predefined gesture is comprised by a particular predefined sequence of gestemes. FIG. 58 depicts an example representation of a predefined gesture comprised by a sequence of five recognized gestemes. Similarly, a predefined gesture comprised by a specific sequence of two, three, or four gestemes, or a predefined gesture comprised by a specific sequence of six or more other gestemes. Additionally, in some arrangements a predefined gesture can be comprised by a single gesteme.

In an embodiment, a recognized gesteme is comprised of a symbol produced by one or more threshold test(s) applied to one or more measured or calculated value(s) responsive to a user interface sensor.

In an embodiment, a recognized gesteme is comprised of a sequence of symbols produced by one or more threshold test(s) applied to one or more measured or calculated value(s) responsive to a user interface sensor.

In an embodiment, a recognized gesteme is comprised of a symbol produced by a state machine, the state machine responsive to a sequence of symbols produced by one or more threshold test(s) applied to one or more measured or calculated value(s) responsive to a user interface sensor.

In an embodiment, a recognized gesteme is determined by the outcome of a vector quantizer applied to one or more measured or calculated value(s) responsive to a user interface sensor.

In an embodiment, a recognized gesteme is determined by the outcome of a matched filter applied to one or more measured or calculated value(s) responsive to a user interface sensor.

Layered and Multiple-Channel Posture-Level Metaphors

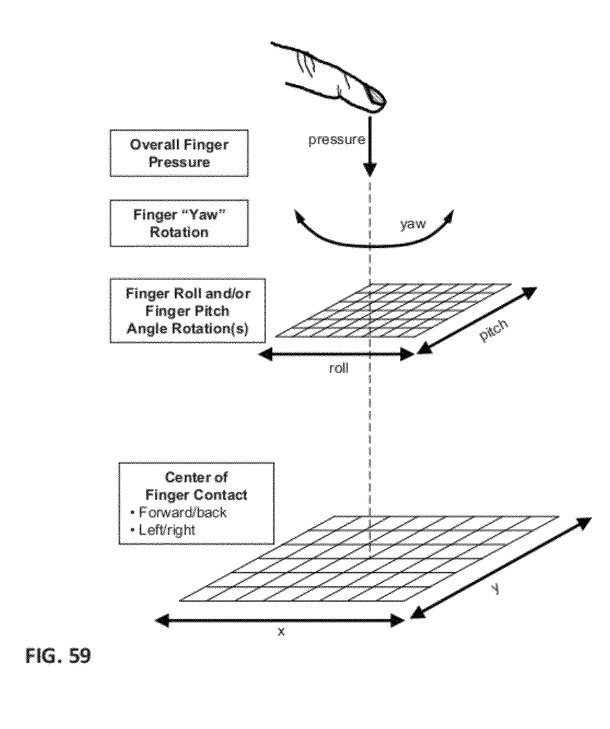

The invention provides for various types of layered and multiple-channel metaphors. Layered metaphors at higher semantic and grammatical levels will be considered later. FIG. 59 depicts a representation of a layered and multiple-channel metaphor wherein the {x,y} location coordinates represent the location of a first point in a first geometric plane, and the {roll,pitch} angle coordinates are viewed as determining a second independently adjusted point on a second geometric plane. In various versions of such metaphors, one or more of the following can be included:
the first and second planes can be viewed as being superimposed (or alternatively, entirely independent)
The yaw angle can be viewed as affecting the angle of rotation of one plane with respect to another (or alternatively, entirely independent)
The pressure exerted or associated displacement can be viewed as affecting the separation distance between the planes (or alternatively, entirely independent).

Fundamentals of Meaning: Morphemes, Lexemes, and Morphology

In traditional linguistics a morpheme is the smallest linguistic unit that has (semantic) meaning. A word or other next-higher-scale linguistic unit may be composed of one or more morphemes compose a word. Two basic categories of morphemes relevant to this project are:
A free morpheme which can function by itself;
A bound morpheme which can function only when combined or associated in some way with a free morpheme (for example the negating prefix “un” in undo and the plural suffix “s”).

The field of morphology addresses the structure of morphemes and other typ is of linguistic units such as words, affixes, parts of speech (verb, noun, etc., more formally referred to as “lexical category”), intonation/stress/rhythm (in part more formally referred to as “prosody”), meaning invoked or implied by enveloping context, etc. Morphological analysis also includes a typology framework classifying languages according to the ways by which morphemes are used.

For example, in the HDTP approach to touch-based user interfaces, a gesture can:
Associate an individual gesteme with an individual morpheme of general or specific use in an application or group of applications;
Associate a group of two or more gestemes comprised by a gesture with an individual morpheme of general or specific use in an application or group of applications;

Further, a gesture can then be
Analytic (employing only free morphemes);
Agglutinative or Fusional (employing bound morphemes);
Polysynthetic (gestures composed of many morphemes.

The invention provides for these and other lexicon constructions to be used in the design and structuring of gestures, gesture meaning structures, morphemes, gesture lexicon, and gesture grammars.

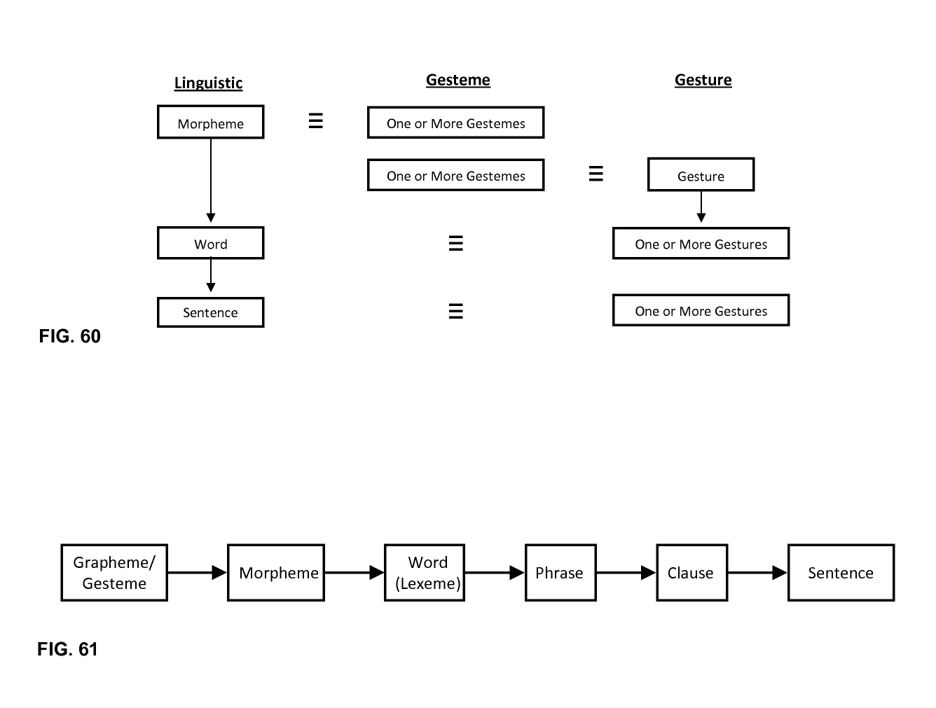

As an example framework for this, FIG. 60 depicts a representation of some correspondences among gestures, gestemes, and the abstract linguistics concepts of morphemes, words, and sentences.

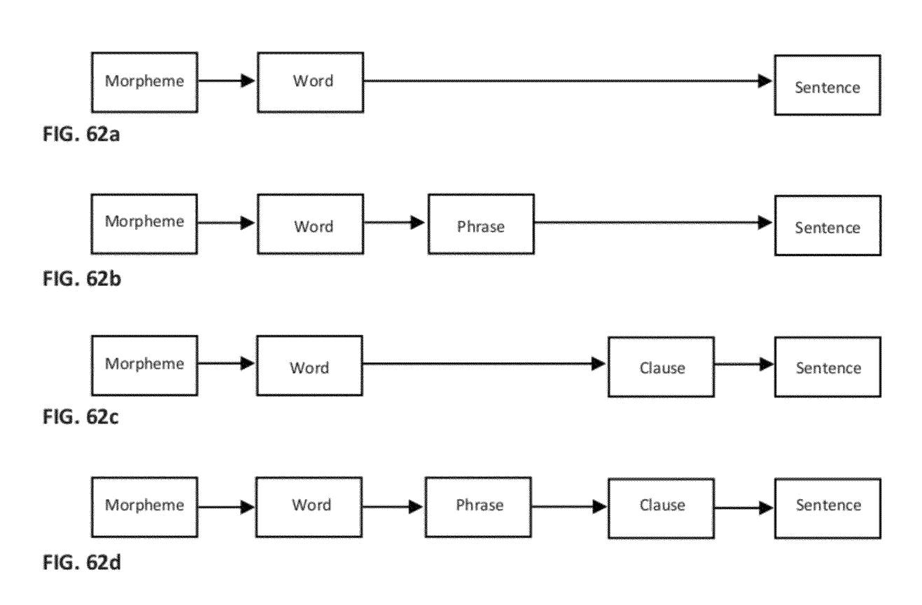

As an additional example framework for this, FIG. 61 and FIG. 62a through FIG. 62d provide finer detail useful in employing additional aspects of traditional linguistics such as noun phrases, verb phrases, and clauses as is useful for grammatical structure, analysis, and semantic interpretation.

Gestural Metaphor, Gestural Onomatopoeia, and Tactile Gesture Logography

The HDTP approach to touch-based user interfaces provides for the structured use of various metaphors in the construction of gestures, strings of gestures, and gestemes. For example, the scope of the metaphor can include:
The entire gesture, string of gestures, or gesteme;
One or more components of a gesture, string of gestures, or gesteme;
One or more aspects of a gesture, string of gestures, or gesteme. Additionally, the directness (or degree) of the metaphor can cover a range such as:
Imitative onomatopoeia;
Close analogy;
Indirect analogy;
Analogy of abstractions;
Total abstraction.

In traditional linguistics, a logogram is a written character which represents a word or morpheme. Typically a very large number of logograms are needed to form a general-purpose written language. A great interval of time is required to learn the very large number of logograms. Both these provide a major disadvantage of the logographic systems over alphabetic systems, but there can be high reading efficiency with logographic writing systems for those who have learned it. The main logographic system in use today is that of Chinese characters. Logographic systems (including written Chinese) include various structural and metaphorical elements to aid in associating meaning with a given written character within the system.

The HDTP approach to touch-based user interfaces includes provisions for the gestural equivalent of logograms and logographic systems.

Appropriate Scope of Gesture Lexicon

The lexicon of a language is comprises its vocabulary. In formal linguistics, lexicon is viewed as a full inventory of the lexemes of the language, where a lexeme is an abstract morphological unit that roughly corresponds to a set of forms taken by a word (for example “run,” “runs,” “ran,” and “running” are separate distinguished forms of the same lexeme).

In creating a tactile gesture lexicon, it is likely that the number of lexeme forms can be forced to be one, or else extremely few. Again, typically even the most diverse, robust, and flexible touch-based user interface will be used for a range of command/inquiry functions that are far more limited in scope, nuance, aesthetics, poetics, and so forth than the language of literature, poetry, persuasive discourse, and the like.

Compound Gestures

Like compound words and word groups that function as a word, the HDTP approach to touch-based user interfaces provides for individual tactile gestures to be merged by various means to create a new gesture. Examples of such various means of merger include:
“Temporally compound” wherein a sequence of two or more tactile gestures is taken as a composite gesture;
“Spatially compound” wherein two or more spatially separated tactile gestures executed at essentially the same time or overlapping in time is taken as a composite gesture;
“Sequential layering” composition (to be discussed);
Geusture forms of portmanteaus wherein two or more gestures or (gesture-defined morphemes) are combined;
Combinations of the two or more instances of one or more of the above.

Additionally, the HDTP approach to touch-based user interfaces provides for the use of a systematic system of shortening a string of two or more gestures, for example as in contractions such as “don't,” “it's,” etc.

These tactile examples are not limiting, and the examples and concepts can be used in other types of user interface systems and other types of gestures.

Sequentially-Layered Execution of Gestures

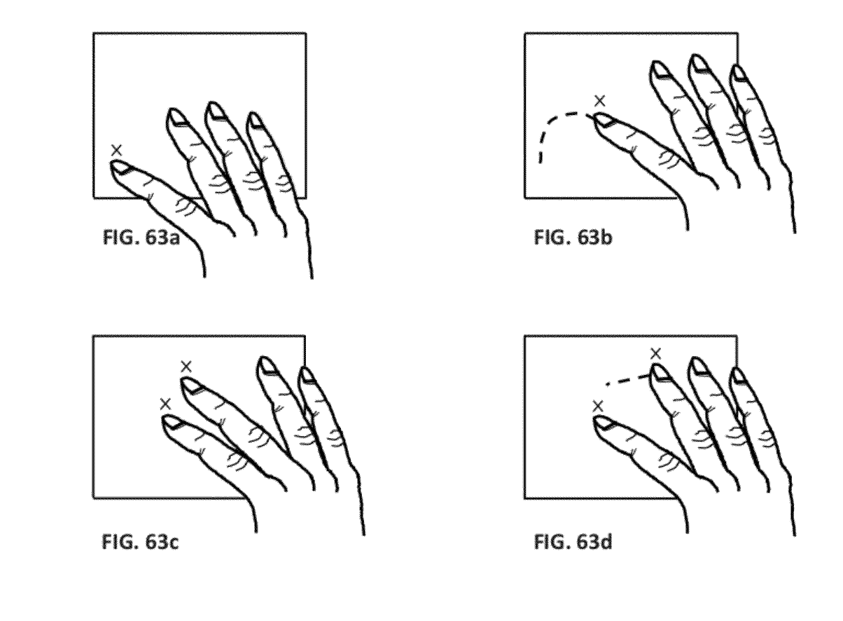

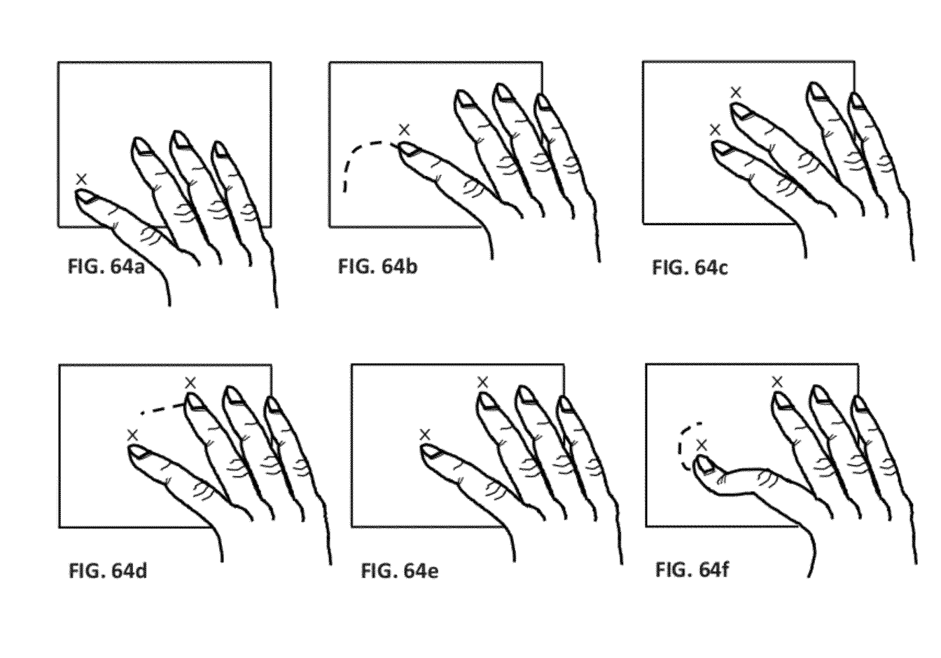

The sequentially-layered execution of tactile gestures can be used to keep a context throughout a sequence of gestures. Some examples sequentially-layered execution of tactile gestures include:
Finger 1 performs one or more gestures and stays in place when completed, then Finger 2 performs one or more gestures, then end;
Finger 1 performs gesture & stays in place when completed, then Finger 2 performs one or more gestures and stays in place when completed, then Finger 1 performs one or more gestures, . . . , then end;
Finger 1 performs gesture & stays in place when completed, then Finger 2 performs one or more gestures and stays in place when completed, then Finger 1 performs one or more gestures and stays in place when completed, then Finger 3 performs one or more gestures, . . . , then end.
Finger 1 performs gesture & stays in place when completed, then Finger 2 performs one or more gestures and stays in place when completed, then Finger 3 performs one or more gestures, . . . , then end.
Rough representative depictions of the first two examples are provided respectively as the series FIG. 63a through FIG. 63d and the series FIG. 64a through FIG. 64f.

These tactile examples are not limiting, and the examples and concepts can be used in other types of user interface systems and other types of gestures.

Phrases, Grammars, and Sentence/Queries

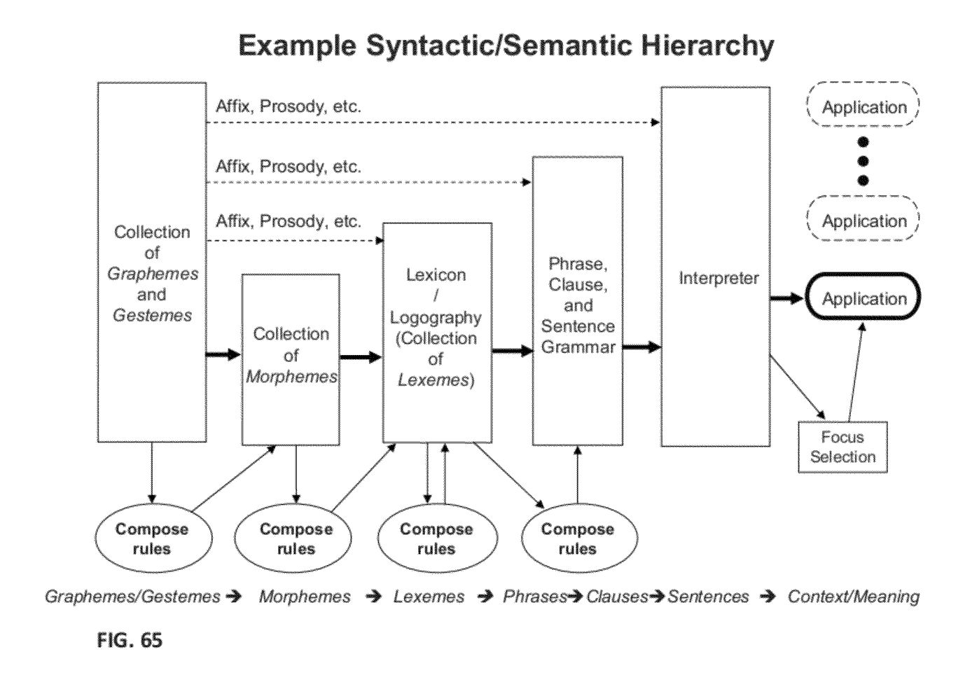

Thus far attention has been largely afforded to the ways individual tactile gestures can be executed, the content and meaning that can be assigned to them, and organizations that can be imposed or used on these. FIG. 65 depicts an example syntactic and/or semantic hierarchy integrating the concepts developed thus far.

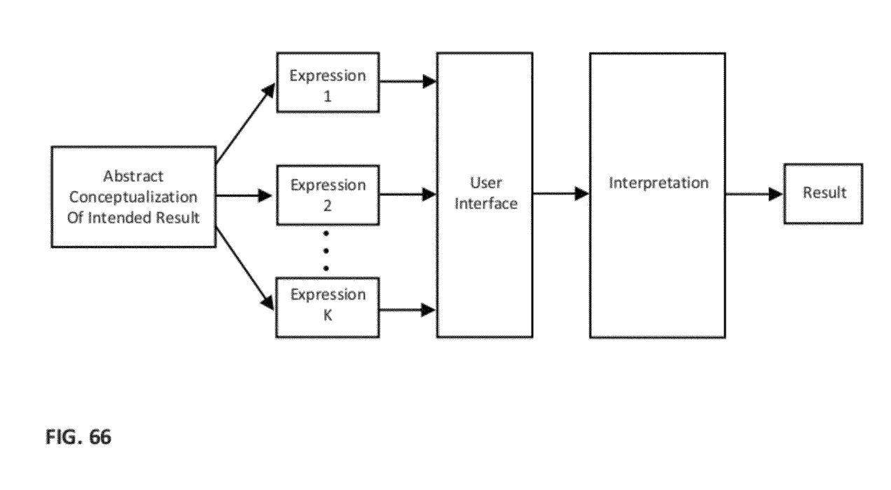

With such a rich structure, it is entirely possible for two or more alternative gesture sequence expressions to convey the same meaning. This is suggested in FIG. 66.

The notion of tactile grammars is taught in U.S. Pat. No. 6,570,078, U.S. patent application Ser. Nos. 11/761,978 and 12/418,605, and U.S. Patent Provisional Application 61/449,923. Various broader and more detailed notions of touch gesture and other gesture linguistics in human user interfaces are taught in U.S. patent application Ser. No. 12/418,605 and U.S. Patent Provisional Application 61/449,923.

Lexical Categories

The invention provides for gestures to be semantically structured as parts of speech (formally termed “lexical categories”) in spoken or written languages. Some example lexical categories relevant to command interface semantics include:
Noun;
Verb;
Adjective;
Adverb;
Infinitive;
Conjunction;
Particle.
The invention provides for gestures to be semantically structured according to and/or including one or more of these lexical categories, as well as others. Additionally, the invention provides for at least some gestures to be semantically structured according to alternative or abstract lexical categories that are not lexical categories of spoken or written languages.

Phrase Categories

The invention provides for such semantically structured gestures to be further structured according to phrase categories. Example phrase categories in spoken or written languages include:
Noun Phrase—noun plus descriptors/modifiers etc that collectively serves as a noun;
Verb Phrase—verb plus descriptors/modifiers etc that collectively serves as a verb;
Additionally, the invention provides for at least some phrase categories that are not lexical categories of spoken or written languages.

List, Phrase, and Sentence/Query Delimiters

For speech, delimiting between consecutive list items, phrases, and sentences/queries are performed through prosody:
Temporal pause;
Changes in rhythm;
Changes in stress;
Changes in intonation.
For traditional writing, punctuation is used for delimiting between consecutive list items, phrases, and sentences/queries:

The HDTP approach to touch-based user interfaces provides for delimiting between individual temporal gestures via at least these mechanisms:
Time separation between two consecutive strings of tactile gestures;
Distance separation between two consecutive strings of individual tactile gestures;
Lexigraphically separation (an tactile gesture string is unambiguously recognized, and the recognition event invokes a delineating demarcation between the recognized tactile gesture string and the next tactile gesture string to follow);
Special ending or starting attribute to strings of tactile gestures;
Special delimiting or entry-action gesture(s)—for example lift-off, tap with another finger, etc.

Mapping Tactile Gestures and Actions on Visual-Rendered Objects into Grammars

The notion of tactile grammars is taught in U.S. Pat. No. 6,570,078, U.S. patent application Ser. Nos. 11/761,978 and 12/418,605, and U.S. Patent Provisional Application 61/449,923.

Various broader and more detailed notions of touch gesture and other gesture linguistics in human user interfaces are taught in U.S. patent application Ser. No. 12/418,605 and U.S. Patent Provisional Application 61/449,923.

Parsing Involving Objects that have been Associated with Gestures

Via touchscreen-locating, cursor-location or visually highlighting, a tactile gesture can be associated with a visual object rendered on a visual display (or what it is a signifier for, i.e., object, action, etc.). This allows for various types of intuitive primitive grammatical constructions. Some examples employing a tactile gesture in forming a subject-verb sentence or inquiry are:
The underlying (touchscreen), pointed-to (cursor), or selected (visually highlighted) visual object can serve as a subject noun and the tactile gesture serve as an operation action verb;
The underlying (touchscreen), pointed-to (cursor), or selected (visually highlighted) visual object can serve as an operation action verb and the tactile gesture serve as a subject noun;

Some examples employing a spatially-localized tactile gesture in forming a subject-verb-object sentence or inquiry are:
If context is employed to have earlier in time by some means selected a subject noun, the underlying (touchscreen), pointed-to (cursor), or selected (visually highlighted) visual object can serve as an object noun and the spatially-localized tactile gesture serve as an operation action verb;
If context is employed to have earlier in time by some means selected a subject noun, the underlying (touchscreen), pointed-to (cursor), or selected (visually highlighted) visual object can serve as an operation action verb and the spatially-localized tactile gesture serve as a object noun;
If context is employed to have earlier in time by some means selected an object noun, the underlying (touchscreen), pointed-to (cursor), or selected (visually highlighted) visual object can serve as an subject noun and the spatially-localized tactile gesture serve as an operation action verb;
If context is employed to have earlier in time by some means selected an object noun, the underlying (touchscreen), pointed-to (cursor), or selected (visually highlighted) visual object can serve as an operation action verb, and the spatially-localized tactile gesture serve as a subject noun;
If context is employed to have earlier in time by some means selected an operation action verb, the underlying (touchscreen), pointed-to (cursor), or selected (visually highlighted) visual object can serve as an subject noun, and the spatially-localized tactile gesture serve as an object noun;
If context is employed to have earlier in time by some means selected an operation action verb, the underlying (touchscreen), pointed-to (cursor), or selected (visually highlighted) visual object can serve as an object noun, and the spatially-localized tactile gesture serve as a subject noun.

Some examples employing a spatially-extended tactile gesture that in some way simultaneously spans two visual objects rendered on a visual display in forming a subject-verb-object sentence or inquiry are:
One underlying (touchscreen), pointed-to (cursor), or selected (visually highlighted) visual object can serve as a subject noun, the other underlying (touchscreen), pointed-to (cursor), or selected (visually highlighted) visual object can serve as an object noun and the spatially-extended tactile gesture serve as an operation action verb;
One underlying (touchscreen), pointed-to (cursor), or selected (visually highlighted) visual object can serve as a subject noun, the other underlying (touchscreen), pointed-to (cursor), or selected (visually highlighted) visual object can serve as an operation action verb, and the spatially-extended tactile gesture serve as an object noun.

These examples demonstrate how context, order, and spatial-extent of gestures can be used to map combinations tactile gestures and visual-rendered objects into grammars; it is thus possible in a similar manner to include more complex phrase and sentence/inquiry constructions, for example using gestures and visual-rendered objects, utilizing context, order, and spatial-extent of gestures in various ways, to include:
Adjectives;
Adverbs;
Infinitives,
Conjunctions and other Particles—for example, “and,” “or,” negations (“no,” “not”), infinitive markers (“to”), identifier articles (“the”), conditionals (“unless,” “otherwise”), ordering (“first”, “second,” “lastly”);
Clauses.

Further, as described (at least twice) earlier, other aspects of tactile gestures (for example “intra-gestural prosody”) can be used as modifiers for the gestures. Again, examples of other aspects of tactile gestures include:
Rate of change of some aspect of a tactile gesture—for example velocity already in WIMP GUI (cursor location) and today's widely accepted multi-touch user interfaces (finger flick affects on scrolling);
Interrupted tactile gesture where action is taken by the user between the rendering of the gestemes comprising the tactile gesture;
Contact angles (yaw, roll, pitch);
Downward pressure;
Additional parameters from multiple finger gestures;
Shape parameters (finger-tip, finger-joint, flat-finger, thumb, etc.).

Examples of how the modifiers could be used as an element in a tactile grammar include:
Adjective;
Adverb;
Identifier.
   In such an arrangement, such forms intra-gestural prosody can be viewed as a bound morpheme.

### Example Simple Grammars for Rapid Operation of Physical Computer Aided Design (CAD) Systems

Attention is now directed to example simple grammars for rapid operation of “physical-model” Computer Aided Design (CAD) systems, for example products such as Catia™, AutoCAD™, SolidWorks™, Alibre Design™, ViaCAD™, Shark™, and others including specialized 3D CAD systems for architecture, plant design, physics modeling, etc.

In such systems, a large number and wide range of operations are used to create even the small component elements of a more complex 3D object. For example:
3D objects of specific primitive shapes are selected and created in a specified 3D area,
Parameters of the shapes of these 3D objects are manipulated,
Color and/or texture is applied to the 3D objects
The 3D objects are positioned (x,y,z) and oriented (roll, pitch, yaw) in 3D space
The 3D objects are merged with other 3D objects to form composite 3D objects,
The composite 3D objects can be repositioned, reoriented, resized, reshaped, copied, replicated in specified locations, etc.

Many of these systems and most of the users who use them perform these operations from mouse or mouse-equivalent user interfaces, usually allowing only two parameters to be manipulated at a time and involving the selection and operation of a large number of palettes, menus, graphical sliders, graphical click buttons, etc. Spatial manipulations of 3D objects involving three spatial coordinates and three spatial angles, when adjusted two at a time, preclude full-range interactive manipulations experiences and can create immense combinatorial barriers to positioning and orienting 3D objects in important design phases. Palette and menu selection and manipulations can take many seconds at minimum, and it can often take a minimum of 20 seconds to 2 minutes for an experienced user to create and finalize the simplest primitive element.

The HDTP is particularly well suited for 3D CAD and drawing work because of both the HDTP's 3D and 6D capabilities as well as its rich symbol and grammar capabilities.

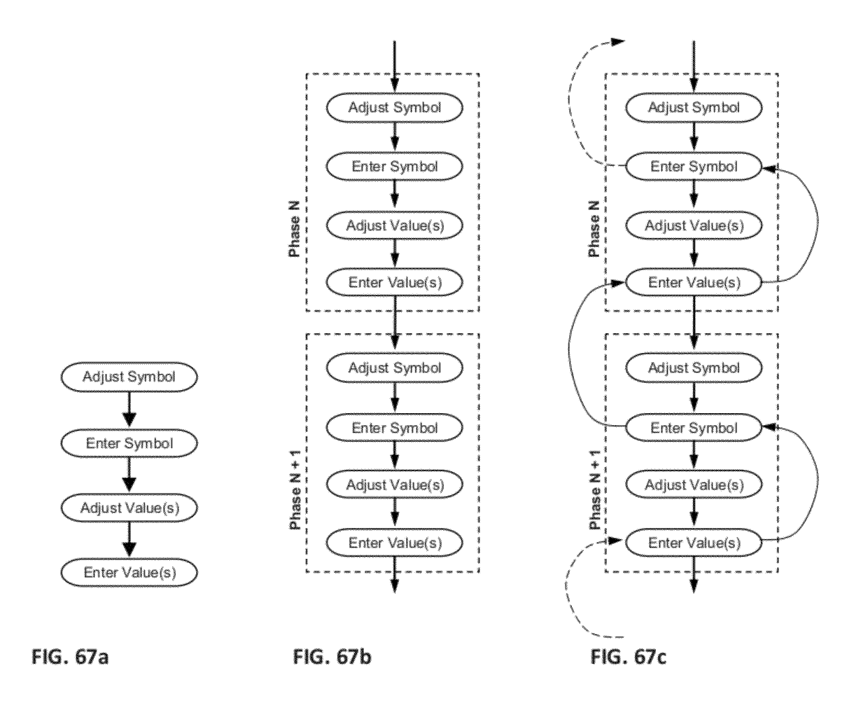

FIG. 67a depicts an example of a very simple grammar that can be used for rapid control of CAD or drawing software. Here a user first adjusts a finger, plurality of fingers, and/or other part(s) of a hand in contact with an HDTP to cause the adjustment of a generated symbol. In an example embodiment, the generated symbol can cause a visual response on a screen. In an embodiment, the visual response can comprise, for example, one or more of:
an action on a displayed object,
motion of a displayed object,
display of text and/or icons,
changes in text and/or icons,
migration of a highlighting or other effect in a menu, palette, or 3D arrays,
display, changes in, or substitutions of one or more menus, pallets, or 3D arrays,
other outcomes.

In an example embodiment, when the user has selected the desired condition, which is equivalent to selection of a particular symbol, the symbol is then entered. In an example embodiment, the lack of appreciable motion (i.e., “zero or slow” rate of change) can serve as an “enter” event for the symbol. In another example embodiment, an action (such as a finger tap) can be made by an additional finger, plurality of fingers, and/or other part(s) of a hand. These examples are merely meant to be illustrative and is no way limiting and many other variations and alternatives are also possible, anticipated, and provided for by the invention.

In an example embodiment, after the user has entered the desired selection (“enter symbol”), the user can then adjust one or more values by adjusting a finger, plurality of fingers, and/or other part(s) of a hand in contact with an HDTP. In an embodiment, the visual response can comprise, for example, one or more of:
an action on a displayed object,
motion of a displayed object,
display of text and/or icons,
changes in text and/or icons,
changes in the state of the object in the CAD or drawing system software,
other outcomes.
   This example is merely meant to be illustrative and is no way limiting and many other variations and alternatives are also possible, anticipated, and provided for by the invention.

In an example embodiment, when the user has selected the desired value, the symbol is then entered. In an example embodiment, the lack of appreciable motion (i.e., “zero or slow” rate of change) can serve as an “enter” event for the value. In another example embodiment, an action (such as a finger tap) can be made by an additional finger, plurality of fingers, and/or other part(s) of a hand. These examples are merely meant to be illustrative and is no way limiting and many other variations and alternatives are also possible, anticipated, and provided for by the invention.

The aforedescribed example sequence and/or other variations can be repeated sequentially, as shown in FIG. 67b.

Additionally, at least one particular symbol can be used as an “undo” or “re-try” operation. An example of this effect is depicted in FIG. 67c.

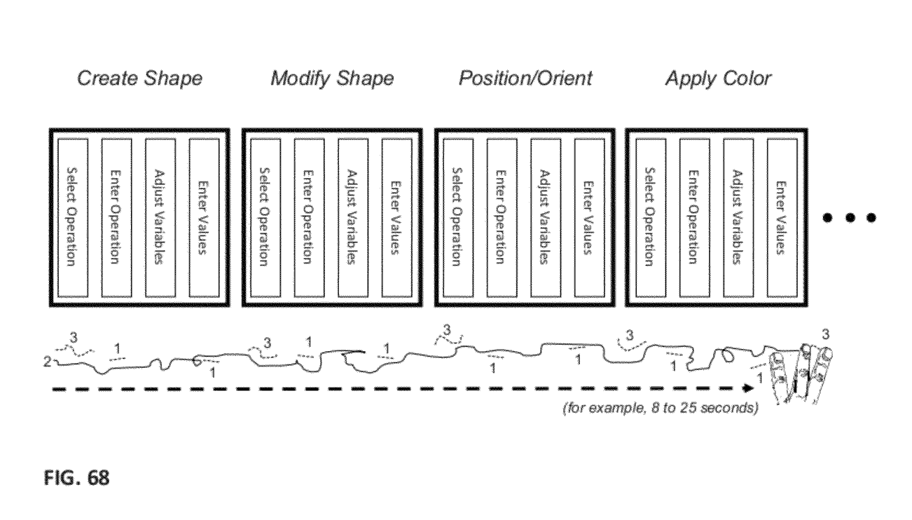

FIG. 68 depicts how the aforedescribed simple grammar can be used to control a CAD or drawing program. In this example, two and/or three fingers (left of the three fingers denoted “1,” middle of the three fingers denoted “2,” right of the three fingers denoted “3”) could be employed, although many other variations are possible and this example is by no means limiting. In one approach, at least finger 2 is used to adjust operations and values, while finger 3 is used to enter the selected symbol or value. Alternatively, the lack of appreciable further motion of at least finger 2 can be used to enter the selected symbol or value. In FIG. 68, both finger 2 and finger 1 are used to adjust operations and values. Alternatively, the roles of the fingers in the aforedescribed examples can be exchanges. Alternatively, additional fingers or other parts of the hand (or two hands) can be used add additions or substitutions. These examples are merely meant to be illustrative and is no way limiting and many other variations and alternatives are also possible, anticipated, and provided for by the invention.

As an example of ease of use, the aforedscribed grammar can be used to create a shape, modify the shape, position and/or (angularly) orient the shape, and apply a color (as depicted in FIG. 68), all for example in as little as a few seconds. In example embodiments of this type, the touch is mostly light and finger motions easy and gentle to execute.

The above example is among the simplest grammar based approaches, but demonstrates the power provided by the present invention and its benefit to the user experience, user efficiency, user effectiveness, user productivity, and user creative exploration and development.

As described earlier, the HDTP and the present invention can support a wide range of grammars, including very sophisticated ones. Far more sophisticated grammars can therefore be applied to at least Computer Aided Design (CAD) or drawing software and systems, as well as other software and systems that can benefit from such capabilities.

### Example Embodiments

In an embodiment, an HDTP provides real-time control information to Computer Aided Design (CAD) or drawing software and systems.

In an embodiment, an HDTP provides real-time control information to Computer Aided Design (CAD) or drawing software and systems through a USB interface via HID protocol.

In an embodiment, an HDTP provides real-time control information to Computer Aided Design (CAD) or drawing software and systems through a HID USB interface abstraction.

In an embodiment, a tactile grammar method for implementing a touch-based user interface for a Computer Aided Design software application is provided.

In an embodiment, a tactile array sensor responsive to touch of at least one finger of a human user provides tactile sensing information that is processed to produce a sequence of symbols and numerical values responsive to the touch of the finger.

In an embodiment, at least one symbol is associated with one or more gesteme, and each gesteme is comprised by at least one touch gesture.

In an embodiment, a sequence of symbols is recognized as a sequence of gestemes, which is in turn recognized as a sequence of touch gestures subject to a grammatical rule producing a meaning that corresponds to a command.

In an embodiment, this command is submitted to a Computer Aided Design software application which executes the command, wherein the grammatical rule provides the human user a framework for associating the meaning with the first and second gesture.

In an embodiment, a method is provided for implementing a touch-based user interface for a Computer Aided Design software application, the method comprising:
Receiving tactile sensing information over time from a tactile array sensor, the tactile array sensor comprising a tactile sensor array, the tactile sensing information responsive to touch of at least one finger of a human user on the tactile array sensor, the touch comprising at least a position of contact of the finger on the tactile array sensor or at least one change in a previous position of contact of the finger on the tactile array sensor;
Processing the received tactile sensing information to produce a sequence of symbols and numerical values responsive to the touch of at least one finger of a human user;
Interpreting at least one symbol as corresponding to a first gesteme, the first gesteme comprised by at least a first touch gesture;
Interpreting at least another symbol as corresponding to a second gesteme, the second gesteme comprised by at least the first touch gesture;
Interpreting the first gesteme followed by the second gesteme as corresponding to first gesture;
Interpreting at least an additional symbol as corresponding to a third gesteme, the third gesteme comprised by at least a second touch gesture;
Interpreting at least a further symbol as corresponding to a fourth gesteme, the fourth gesteme comprised by at least the second touch gesture;
Interpreting the third gesteme followed by the fourth gesteme as corresponding to second gesture;
Applying a grammatical rule to the sequence of the first gesture and second gesture, the grammatical rule producing a meaning;
Interpreting the meaning as corresponding to a user interface command of a Computer Aided Design software application, and
Submitting the user interface command to the Computer Aided Design software application,
Wherein the Computer Aided Design software application executes the user interface command responsive a choice by the human user of the at least first, second, third, and fourth gestemes, and
Wherein the grammatical rule provides the human user a framework for associating the meaning with the at least the first and second gesture.

In an embodiment, subsequent touch actions performed by the user produce additional symbols, and the additional symbols are interpreted as a sequence of additional gestemes, and the sequence of additional gestemes is associated with at least an additional gesture, wherein the additional gesture is subject to an additional grammatical rule producing an additional meaning that corresponds to an additional command, wherein the additional command executed by Computer Aided Design software application, and wherein the grammatical rule provides the human user a framework for associating the meaning with the first and second gesture.

In an embodiment, the command incorporates at least one calculated value, the calculated value obtained from processing the numerical values responsive to the touch of at least one finger of a human user.

In various embodiments, the command corresponds to a selection event, data entry event, cancel event, or undo event.

In an embodiment, the additional command corresponds to a selection event, data entry event, cancel event, or undo event.

In an embodiment, the tactile sensor array comprises an OLED array, and the OLED array serves as a visual display for the Computer Aided Design software application.

In an embodiment, the approaches described can also be used with or adapted to other comparably complex or high-dimensionality applications, (for example data visualization, realistic interactive computer games, advanced GIS systems, etc.).

Many other embodiments are of course possible and are anticipated and provided for by the present invention,

### CLOSING

The terms “certain embodiments,” “an embodiment,” “embodiment,” “embodiments,” “the embodiment,” “the embodiments,” “one or more embodiments,” “some embodiments,” and “one embodiment” mean one or more (but not all) embodiments unless expressly specified otherwise. The terms “including,” “comprising,” “having” and variations thereof mean “including but not limited to,” unless expressly specified otherwise. The enumerated listing of items does not imply that any or all of the items are mutually exclusive, unless expressly specified otherwise. The terms “a,” “an” and “the” mean “one or more,” unless expressly specified otherwise.

While the invention has been described in detail with reference to disclosed embodiments, various modifications within the scope of the invention will be apparent to those of ordinary skill in this technological field. It is to be appreciated that features described with respect to one embodiment typically can be applied to other embodiments.

The invention can be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

Although exemplary embodiments have been provided in detail, various changes, substitutions and alternations could be made thereto without departing from spirit and scope of the disclosed subject matter as defined by the appended claims. Variations described for the embodiments may be realized in any combination desirable for each particular application. Thus particular limitations and embodiment enhancements described herein, which may have particular advantages to a particular application, need not be used for all applications. Also, not all limitations need be implemented in methods, systems, and apparatuses including one or more concepts described with relation to the provided embodiments. Therefore, the invention properly is to be construed with reference to the claims.

### REFERENCES

[1] B. Shneiderman “Direct Manipulation. A Step Beyond Programming Languages” IEEE Transactions on Computers 16 (8), 1983, pp. 57-69.
[2] J. Wachs, M. Kolsch, H. Stern, Y. Edan, “Vision-Based Hand-Gesture Applications,” Communications of the ACM, Vol. 54 No. 3, February 2011, pp. 60-71.
[3] M. Eden, “On the Formalization of Handwriting,” in Structure of Language and its Mathematical Aspects, American Mathematical Society, 1961.

1. A method for implementing a touch-based user interface for a Computer Aided Design software application, the method comprising:
receiving tactile sensing information over time from a tactile array sensor, the tactile array sensor comprising a tactile sensor array, the tactile sensing information responsive to touch of at least one finger of a human user on the tactile array sensor, the touch comprising at least a position of contact of the finger on the tactile array sensor or at least one change in a previous position of contact of the finger on the tactile array sensor;
processing the received tactile sensing information to produce a sequence of symbols and numerical values responsive to the touch of at least one finger of a human user;
interpreting at least one symbol as corresponding to a first gesteme, the first gesteme comprised by at least a first touch gesture;
interpreting at least another symbol as corresponding to a second gesteme, the second gesteme comprised by at least the first touch gesture;
interpreting the first gesteme followed by the second gesteme as corresponding to first gesture;
interpreting at least an additional symbol as corresponding to a third gesteme, the third gesteme comprised by at least a second touch gesture;
interpreting at least a further symbol as corresponding to a fourth gesteme, the fourth gesteme comprised by at least the second touch gesture;
interpreting the third gesteme followed by the fourth gesteme as corresponding to second gesture;
applying a grammatical rule to the sequence of the first gesture and second gesture, the grammatical rule producing a meaning;
interpreting the meaning as corresponding to a user interface command of a Computer Aided Design software application, and
submitting the user interface command to the Computer Aided Design software application,
wherein the Computer Aided Design software application executes the user interface command responsive a choice by the human user of the at least first, second, third, and fourth gestemes, and
wherein the grammatical rule provides the human user a framework for associating the meaning with the at least the first and second gesture.

2. The method of claim 1 wherein subsequent touch actions performed by the user produce additional symbols.

3. The method of claim 2 wherein the additional symbols are interpreted as a sequence of additional gestemes, and the sequence of additional gestemes is associated with at least an additional gesture, wherein the additional gesture is subject to an additional grammatical rule producing an additional meaning that corresponds to an additional command, wherein the additional command executed by Computer Aided Design software application, and wherein the grammatical rule provides the human user a framework for associating the meaning with the first and second gesture.

4. The method of claim 1 wherein the command corresponds to a selection event.

5. The method of claim 1 wherein the command incorporates at least one calculated value, the calculated value obtained from processing the numerical values responsive to the touch of at least one finger of a human user.

6. The method of claim 5 wherein the command corresponds to a data entry event.

7. The method of claim 1 wherein the additional command corresponds to a data entry event.

8. The method of claim 1 wherein the additional command corresponds to an undo event.

9. The method of claim 1 wherein the tactile sensor array comprises an LED array.

10. The method of claim 9 wherein the tactile sensor array comprises an Organic Light Emitting Diode (OLED) array, and the OLED array serves as a visual display for the Computer Aided Design software application.
